(19) United States
(12) Patent Application Publication
(10) Pub. No.: US 2025/0377488 A1
(43) Pub. Date: Dec. 11, 2025

(54) METHODS AND SYSTEMS FOR COLLIMATED HOLLOW-CORE BEAM GENERATION

(71) Applicant: Atom Computing Inc., Berkeley, CA (US)

(72) Inventors: Hyosub KIM, Boulder, CO (US); Mickey MCDONALD, Longmont, CO (US)

(21) Appl. No.: 18/978,501

(22) Filed: Dec. 12, 2024

Related U.S. Application Data
(60) Provisional application No. 63/609,129, filed on Dec. 12, 2023.

(51) Int. Cl. G02B 5/00

(52) U.S. Cl. CPC G02B 5/001

(57) ABSTRACT

Systems, methods, computer-readable media, and techniques using a diffractive-refractive axicon pair, may include: (A) a diffractive axicon; and (B) a refractive axicon in optical communication with the diffractive axicon, wherein the diffractive axicon is configured to direct a light beam towards the refractive axicon, and wherein the refractive axicon is configured to accept the light beam and output a substantially annular beam of light from the light beam.

### CROSS-REFERENCE

This application claims the benefit of U.S. Provisional Application No. 63/609,129, filed Dec. 12, 2023, which is incorporated herein by reference in its entirety.

### BACKGROUND

Quantum computers typically make use of quantum-mechanical phenomena, such as superposition and entanglement, to perform operations on data. Quantum computers may be different from digital electronic computers based on transistors. For instance, whereas digital computers require data to be encoded into binary digits (bits), each of which is always in one of two definite states (0 or 1), quantum computation uses quantum bits (qubits), which can be in superpositions of states.

In neutral-atom quantum computers or simulation devices, qubits may be encoded in optically trapped atoms. The qubit can be represented by a linear superposition of its two orthonormal basis states. The two orthonormal basis states are usually denoted as |0)=[10] (the “zero state”) and |1)=[01](the “one state”). The two orthonormal basis states, {|0), 1)}, together called the computational basis, span the two-dimensional linear vector (Hilbert) space of the qubit. The basis states can also be combined to form product basis states, e.g., |00), |01), |10), |11), each called a quantum register. Generally, n qubits are represented by a superposition state vector in 2ⁿ dimensional Hilbert space.

Two axicons made of transmissive glasses with an identical conical shape may be used in series to convert an incoming collimated gaussian beam to a collimated cylindrical (or hollow-core or annular) beam through the refraction of the beam.

### SUMMARY

Systems, methods, computer-readable media, and techniques disclosed herein may provide a pair of axicons to generate an annular light beam useful in quantum computing (e.g., for forming magneto-optical trap beams (MOTs)). The pair of axicons may be configured to generate the annular light beam while avoiding the central apex effect that occurs with refractive axicons. For example, by using a first axicon configured to avoid aberrations due to the central apex effect, such that after light passes through the first axicon, and then the second axicon, the light is shaped into an annular beam having a dark central region, without a central peak. In one example, the first axicon may be a diffractive axicon. In another example, the first axicon may be a reflective axicon with a hole missing from the middle of the first axicon. Not only may the systems, the methods, the computer-readable media, and the techniques disclosed herein help reduce (e.g., eliminate) a central peak from an annular beam formed by a pair of axicons, but, advantageously, the systems, the methods, the computer-readable media, and the techniques disclosed herein may improve the speed of formation of annular beams (e.g., MOT beams).

In one aspect, a system comprising a diffractive-refractive axicon pair comprises: a diffractive axicon; and a refractive axicon in optical communication with the diffractive axicon, wherein the diffractive axicon is configured to direct a light beam towards the refractive axicon, and wherein the refractive axicon is configured to accept the light beam and output a substantially annular beam of light from the light beam. In some embodiments, the diffractive axicon and the refractive axicon are aligned substantially normal to an optical axis. In some embodiments, the substantially annular beam is substantially collimated. In some embodiments, the substantially annular beam comprises a divergence with a half angle of less than about 5 degrees. In some embodiments, the divergence is less than about 1.5 degrees. In some embodiments, the substantially annular beam comprises a substantially dark central region. In some embodiments, an extinction ratio from the substantially dark central region of the substantially annular beam to a light region of the substantially annular beam is about 1 to 100. In some embodiments, the substantially annular beam comprises a transmission through the refractive axicon and the diffractive axicon of at least about 80%. In some embodiments, the transmission is at least about 95%. In some embodiments, a diffraction efficiency of the diffractive axicon is at least about 80%. In some embodiments, the system further comprises: a light source configured to provide the light beam, wherein the light beam is substantially collimated and is substantially Gaussian. In some embodiments, the system further comprises: a beam combiner, wherein the substantially annular beam and a second beam are combined at the beam combiner. In some embodiments, the diffractive axicon is a reflective optical element. In some embodiments, the diffractive axicon is a transmissive optical element.

In another aspect, a system comprises: a plurality of spatially distinct optical traps; at least one light source; a diffractive axicon in optical communication with the at least one light source; and a refractive axicon in optical communication with the diffractive axicon and the plurality of spatially distinct optical traps; and wherein, during use, (i) the at least one light source delivers a first light to the diffractive axicon, wherein the diffractive axicon directs the first light towards the refractive axicon that subsequently outputs a substantially annular beam towards the plurality of spatially distinct optical traps, and (ii) the at least one light source delivers a second light through an annulus of the substantially annular beam towards the plurality of spatially distinct optical traps. In some embodiments, the refractive axicon and the diffractive axicon are configured to form the substantially annular beam from a light beam directed to the diffractive axicon and subsequently directed to the refractive axicon. In some embodiments, the diffractive axicon and the refractive axicon are aligned substantially normal to an optical axis. In some embodiments, the substantially annular beam is substantially collimated. In some embodiments, the substantially annular beam has a divergence with a half angle of less than about 5 degrees. In some embodiments, the divergence is less than about 1.5 degrees. In some embodiments, the substantially annular beam comprises a substantially dark central region. In some embodiments, an extinction ratio from the substantially dark central region of the substantially annular beam to a light region of the substantially annular beam is from about 1 to 100. In some embodiments, the substantially annular beam has a transmission through the refractive axicon and the diffractive axicon of at least about 80%. In some embodiments, the transmission is at least about 95%. In some embodiments, a diffraction efficiency of the diffractive axicon is at least about 80%. In some embodiments, the first light, the second light or both are substantially collimated and substantially Gaussian. In some embodiments, the system further comprises, a beam combiner, wherein the substantially annular beam and the second light are combined at the beam combiner. In some embodiments, the diffractive axicon is a reflective optical element. In some embodiments, the diffractive axicon is a transmissive optical element.

In another aspect, a system comprises: a first axicon; and a second axicon in optical communication with the first axicon, wherein the first axicon is configured to accept light from a light source and output the light with a beam profile having a substantially dark central region, and wherein the second axicon is configured to accept the light from the first axicon and output a substantially annular beam. In some embodiments, the first axicon is a transmissive, diffractive axicon. In some embodiments, the first axicon is a reflective axicon. In some embodiments, the reflective axicon is a reflective, diffractive axicon. In some embodiments, the reflective axicon comprises a non-transmitting portion substantially centered in the reflective axicon. In some embodiments, the first axicon and the second axicon are aligned substantially normal to an optical axis. In some embodiments, the substantially annular beam is substantially collimated. In some embodiments, the substantially annular beam comprises a divergence with a half angle of less than about 5 degrees. In some embodiments, the divergence is less than about 1.5 degrees. In some embodiments, the substantially annular beam comprises a substantially dark central region. In some embodiments, an extinction ratio from the substantially dark central region of the substantially annular beam to a light region of the substantially annular beam is about 1 to 100. In some embodiments, the beam profile with the substantially dark central region comprises an extinction ratio from the substantially dark central region to a light region of the light beam is about 1 to 100. In some embodiments, the substantially annular beam comprises a transmission through the first axicon and the second axicon of at least about 80%. In some embodiments, the transmission is at least about 95%. In some embodiments, the system further comprises: the light source configured to provide the light, wherein the light beam is substantially collimated and is substantially Gaussian. In some embodiments, the system further comprises: a beam combiner, wherein the substantially annular beam and a second light are combined at the beam combiner.

In another aspect, a method comprises: (a) directing light towards a first axicon, wherein the light exits the first axicon with a beam profile having a substantially dark central region; and (b) subsequent to (a), directing the light to a second axicon, wherein the light exits the second axicon to form a substantially annular beam. In some embodiments, the second axicon comprises a refractive axicon. In some embodiments, the second axicon comprises a diffractive axicon. In some embodiments, the second axicon comprises a reflective axicon. In some embodiments, the first axicon is a transmissive, diffractive axicon. In some embodiments, the first axicon is a reflective axicon. In some embodiments, the reflective axicon is a reflective, diffractive axicon. In some embodiments, the reflective axicon comprises a non-transmitting portion substantially centered in the reflective axicon. In some embodiments, the first axicon and the second axicon are aligned substantially normal to an optical axis. In some embodiments, the substantially annular beam is substantially collimated. In some embodiments, the substantially annular beam comprises a divergence with a half angle of less than about 5 degrees. In some embodiments, the divergence is less than about 1.5 degrees. In some embodiments, the substantially annular beam comprises a substantially dark central region. In some embodiments, an extinction ratio from the substantially dark central region of the substantially annular beam to a light region of the substantially annular beam is about 1 to 100. In some embodiments, the light with a beam profile having a substantially dark central region comprises an extinction ratio from the substantially dark central region to a light region of the light is about 1 to 100. In some embodiments, the substantially annular beam comprises a transmission through the first axicon and the second axicon of at least about 80%. In some embodiments, the transmission is at least about 95%. In some embodiments, the method further comprises: combining the substantially annular beam and a second light with a beam combiner. In some embodiments, the method further comprises: directing the substantially annular beam and the second light toward a plurality of spatially distinct optical traps; and cooling a plurality of atoms within the plurality of spatially distinct optical trap with the substantially annular beam and the second light.

Another aspect of the present disclosure provides a system comprising one or more computer processors and computer memory coupled thereto. The computer memory comprises machine executable code that, upon execution by the one or more computer processors, implements any of the methods above or elsewhere herein.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present invention may be obtained by reference to the following detailed description that sets forth illustrative embodiments, in which the principles of the invention are utilized, and the accompanying drawings (also “Figure” and “FIG.” herein), of which:

FIG. 1 shows a computer control system that is programmed or otherwise configured to implement methods provided herein:

FIG. 2 shows an example of a system for performing a non-classical computation:

FIG. 3A shows an example of an optical trapping unit;

FIG. 3B shows an example of a plurality of optical trapping sites,

FIG. 3C shows an example of an optical trapping unit that is partially filled with atoms;

FIG. 3D shows an example of an optical trapping unit that is completely filled with atoms;

FIG. 4 shows an example of an electromagnetic delivery unit;

FIG. 5 shows an example of a state preparation unit:

FIG. 6 shows a flowchart for an example of a first method for performing a non-classical computation;

FIG. 7 shows a flowchart for an example of a second method for performing a non-classical computation:

FIG. 8 shows a flowchart for an example of a third method for performing a non-classical computation:

FIG. 9 shows an example of an energy level structure for single-qubit and multi-qubit operations in strontium-87:

FIGS. 10A and 10B show an example of a wave-front curvature imparted onto the incoming beam that goes through the apex of a refractive axicon;

FIG. 11A shows an example of ripples in the annulus of the beam formed from a refractive axicon pair;

FIG. 11B shows an example of an annular beam shape without ripples;

FIG. 12 shows an example of a diffractive-refractive axicon pair for generating an annular beam;

FIG. 13 shows an example of an implementation of a diffractive-refractive axicon pair applied to two-color laser cooling;

FIG. 14 shows an example of a three-dimensional magneto-optical trap configuration where the combined beam is coming from the implementation of FIG. 13;

FIG. 15 shows an example of an implementation of a reflective-refractive axicon pair for generating an annular beam;

FIG. 16A shows an example numerical simulation of a refractive to refractive axicon pair:

FIG. 16B shows an example numerical simulation of a refractive to diffractive axicon pair with the apex of the refractive axicon blocked;

FIG. 16C shows an example numerical simulation of a refractive to diffractive axicon pair;

FIG. 16D shows an example numerical simulation of a diffractive to refractive axicon pair;

FIG. 16E shows an example numerical simulation of a reflective to refractive axicon pair, and

FIG. 17 shows an example method for transforming a light beam.

### DETAILED DESCRIPTION

While various embodiments of the invention have been shown and described herein, it will be obvious to those skilled in the art that such embodiments are provided by way of example only. Numerous variations, changes, and substitutions may occur to those skilled in the art without departing from the invention. It should be understood that various alternatives to the embodiments of the invention described herein may be employed.

In some cases, axicons may be used to transform a conventional laser beam into an annular beam or a “Bessel” beam based on the geometric characteristics of the axicon. For example, when a substantially collimated light beam (e.g., a laser beam) is incident on an axicon, the substantially collimated light beam may be refracted to create a cone of light. In the diffraction-limited far field, this cone transforms into an annular beam, characterized by a long, high-intensity focal line and a minimal central core. In some cases, annular beams may be resilient to perturbations. For example, even if an object partially blocks an annular beam, the annular beam may be able to reconstruct itself after the obstacle (e.g., albeit with diminished intensity). Axicons may be used in applications including optical trapping and manipulation, where axicons help in creating more precise, efficient, and intricate performance, such as in manipulating atoms using light.

Notably, axicons may be refractive, diffractive, reflective, transmissive, axicon-lens combinations (lensacons), meta-axicons. 2D photonic crystals, etc. Refractive axicons may be characterized by a conical design. Diffractive axicons, however, may have a rectangular profile. Reflective axicons may have a reflective surface that follows the “inverse” shape of a cone. Lensacons may be formed by combining one or more axicons with one or more lenses. Meta-axicons may be made up of an array of one or more subwavelength optical antennas, and may possess favorable properties such as aberration correction, active tunability, and semi-transparency. 2D photonic crystal structures may also be used as a waveguide, and may be used to construct photonic integrated circuits to produce axicon effects (on-chip axicons).

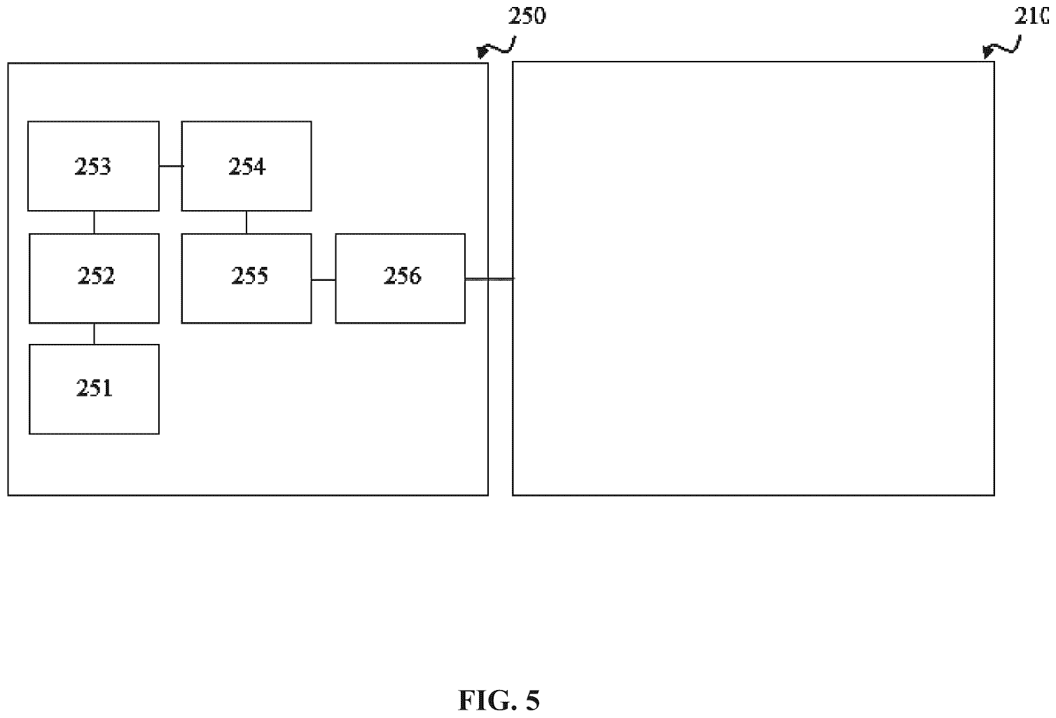

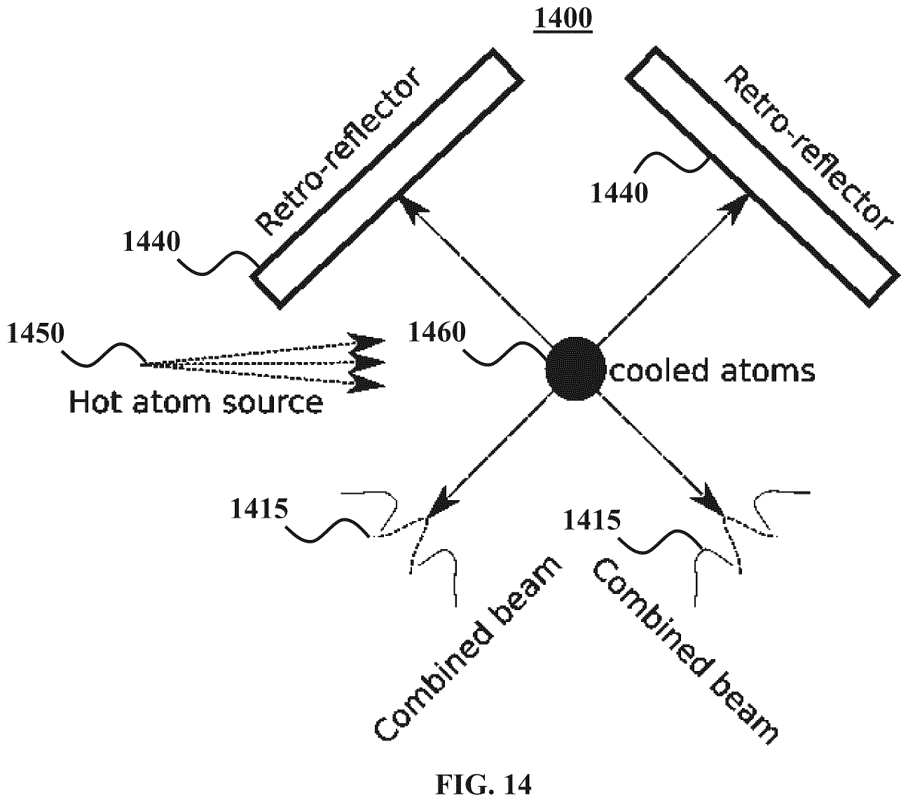

The systems, the methods, the computer-readable media, and the techniques disclosed herein may leverage axicons in quantum computing. For example, in quantum computing, axicons may be extended to precisely manipulate individual qubits. Further, optical traps produced using annular beams may be applied to trap qubits. The characteristic long working distance of an annular beam may be beneficial in quantum computing setups that use precise manipulation over a large area. Still further, laser beam shaping (which axicons may be a part of) may be a useful aspect of quantum information experiments, such as in quantum communication and quantum cryptography. Still further, axicons may be used to create beams used in magneto-optical traps (MOTs), which use laser cooling and a spatially-varying magnetic fields to create traps that can produce samples of cold, neutral atoms. For example, axicons according to the systems, the methods, the computer-readable media, and the techniques disclosed herein may be used with MOTs such as the example diagram 1400 of a three-dimensional MOT of FIG. 14 or the MOT 252 of FIG. 5.

This disclosure hereby incorporates by reference, in their entireties, for all purposes. European Patent Publication No. 06271 A2; U.S. Pat. Nos. 7,102,118; 11,143,748; Y. Song, D. Milam, and W. T. Hill, Long, narrow all-light atom guide, Optics Letters, Vol. 24, Issue 24, pp. 1805-1807 (1999); Jeongwon Lee, Jae Hoon Lee, Jiho Noh, and Jongchul Mun, Core-Shell Magneto-Optical Trap for Alkaline-Earth-Metal-Like Atoms, arXiv:1412.2854 [physics.atom-ph], available at https://arxiv.org/abs/1412.2854; and Oto Brzobohaty. Tomas Cizmar, and Pavel Zemanek, High quality quasi-Bessel beam generated by round-tip axicon, Optics Express, 12688, 2008.

### Examples of the Apex Effect

In some cases, the plurality of axicons may comprise at least one axicon of transmissive glass. The axicon may be of a conical shape and may be used (e.g., in series with one or more other axicons) to convert an incoming collimated gaussian beam to a collimated cylindrical (or hollow-core or annular) beam through the refraction of the beam. The technique has a variety of applications such as: a laser scanner (see, e.g., European Patent Publication No. 0627643A2), a radiation unit (see, e.g., U.S. Pat. No. 7,102,118), a telescope (see, e.g., U.S. Pat. No. 11,143,748), a cold atom guide (see, e.g., Y. Song, D. Milam, and W. T. Hill, Long, narrow all-light atom guide, Optics Letters, Vol. 24, Issue 24, pp. 1805-1807 (1999)), and laser cooling (see, e.g., Jeongwon Lee, Jae Hoon Lee, Jiho Noh, and Jongchul Mun, Core-Shell Magneto-Optical Trapfor Alkaline-Earth-Metal-Like Atoms, arXiv:1412.2854 [physics.atom-ph], available at https://arxiv.org/abs/1412.2854).

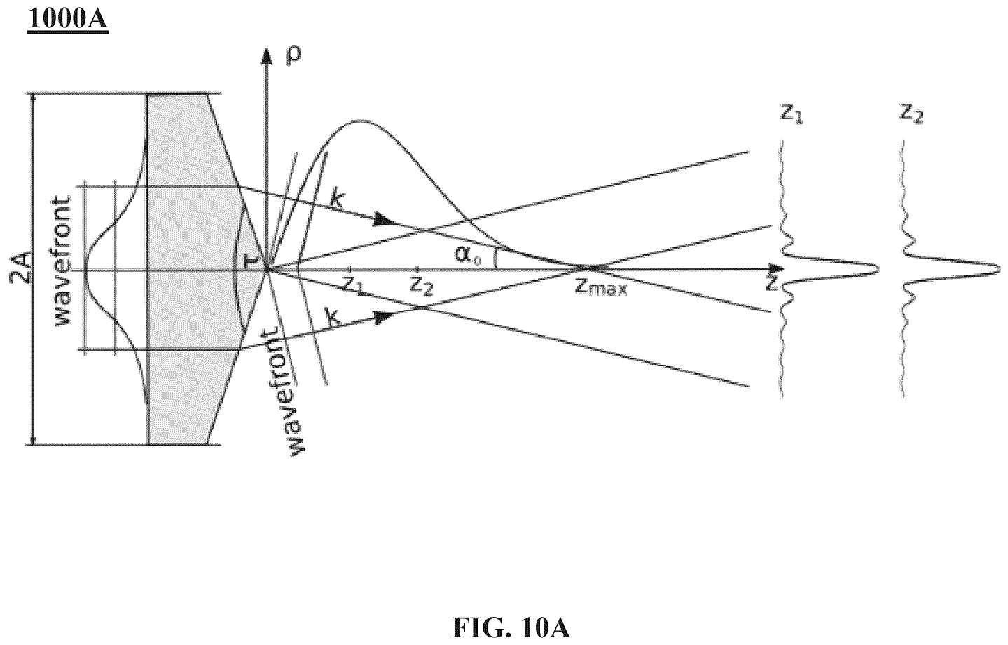

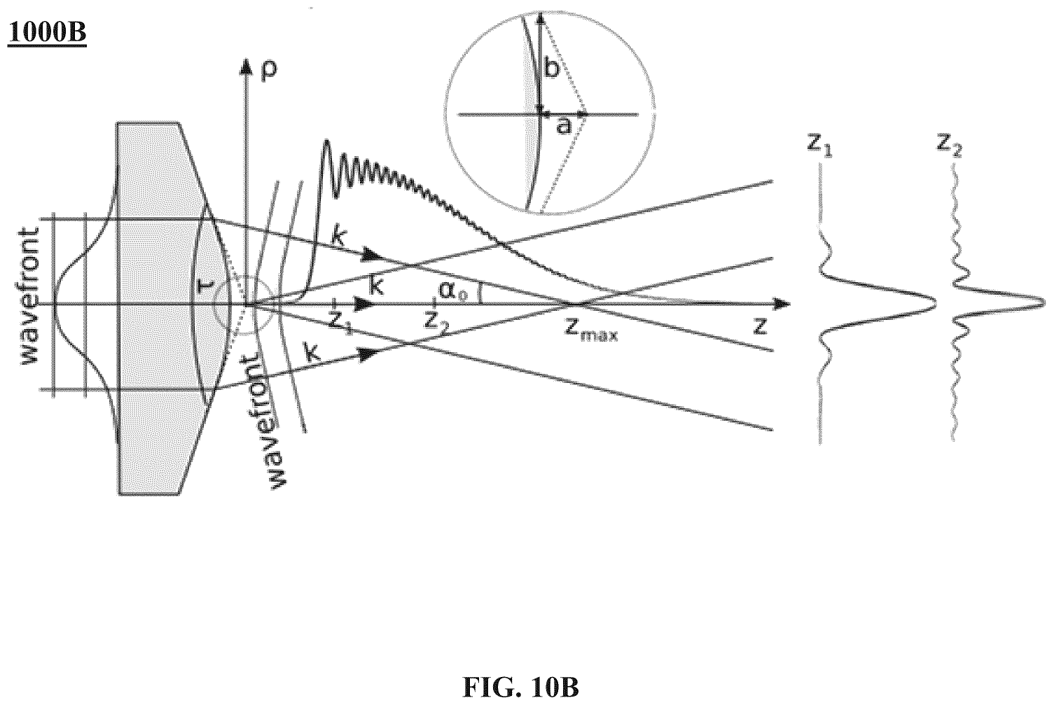

FIGS. 10A and 10B illustrate examples of refractive axicons with a conical shape. Specifically, FIGS. 10A and 10B show diagrams 1000A and 1000B of wave-front curvature imparted onto the incoming beam that goes through the apex of a refractive axicon.

As illustrated in the diagram 1000A, the conical shape of the axicon may come to a tip at the apex of the axicon. However, upon closer inspection, such as at the diagram 1000B, showing a magnified view focusing on the apex, the tip may be rounded, due to, for example, the practical limits of manufacturing capabilities with material cutting and polishing. Indeed, no tip of an axicon may ever be truly infinitesimally small or pointed. In some cases, the sharpness (or roundness) of the apex of a refractive axicon may be on the order of 10 micrometers in diameter, which imposes a drawback for the application of refractive axicon pairs.

In some cases, the apex of a refractive axicon may be about 0.1 micrometers to about 1,000 micrometers. In some cases, the apex of a refractive axicon may be about 0.1 micrometers to about 0.5 micrometers, about 0.1 micrometers to about 1 micrometer, about 0.1 micrometers to about 5 micrometers, about 0.1 micrometers to about 10 micrometers, about 0.1 micrometers to about 50 micrometers, about 0.1 micrometers to about 100 micrometers, about 0.1 micrometers to about 500 micrometers, about 0.1 micrometers to about 1,000 micrometers, about 0.5 micrometers to about 1 micrometer, about 0.5 micrometers to about 5 micrometers, about 0.5 micrometers to about 10 micrometers, about 0.5 micrometers to about 50 micrometers, about 0.5 micrometers to about 100 micrometers, about 0.5 micrometers to about 500 micrometers, about 0.5 micrometers to about 1,000 micrometers, about 1 micrometer to about 5 micrometers, about 1 micrometer to about 10 micrometers, about 1 micrometer to about 50 micrometers, about 1 micrometer to about 100 micrometers, about 1 micrometer to about 500 micrometers, about 1 micrometer to about 1,000 micrometers, about 5 micrometers to about 10 micrometers, about 5 micrometers to about 50 micrometers, about 5 micrometers to about 100 micrometers, about 5 micrometers to about 500 micrometers, about 5 micrometers to about 1,000 micrometers, about 10 micrometers to about 50 micrometers, about 10 micrometers to about 100 micrometers, about 10 micrometers to about 500 micrometers, about 10 micrometers to about 1,000 micrometers, about 50 micrometers to about 100 micrometers, about 50 micrometers to about 500 micrometers, about 50 micrometers to about 1,000 micrometers, about 100 micrometers to about 500 micrometers, about 100 micrometers to about 1,000 micrometers, or about 500 micrometers to about 1,000 micrometers. In some cases, the apex of a refractive axicon may be about 0.1 micrometers, about 0.5 micrometers, about 1 micrometer, about 5 micrometers, about 10 micrometers, about 50 micrometers, about 100 micrometers, about 500 micrometers, or about 1,000 micrometers. In some cases, the apex of a refractive axicon may be at least about 0.1 micrometers, about 0.5 micrometers, about 1 micrometer, about 5 micrometers, about 10 micrometers, about 50 micrometers, about 100 micrometers, or about 500 micrometers. In some cases, the apex of a refractive axicon may be at most about 0.5 micrometers, about 1 micrometer, about 5 micrometers, about 10 micrometers, about 50 micrometers, about 100 micrometers, about 500 micrometers, or about 1,000 micrometers.

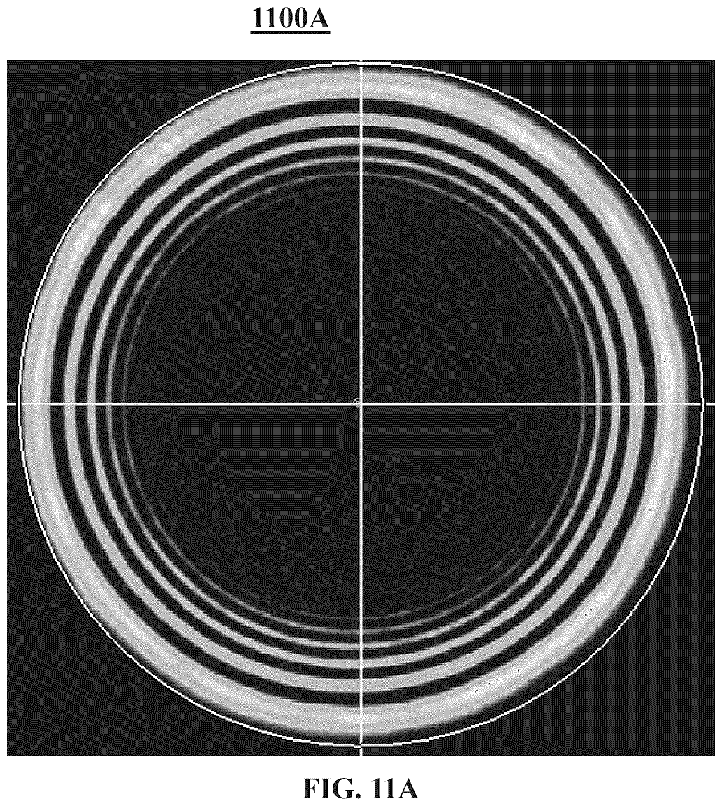

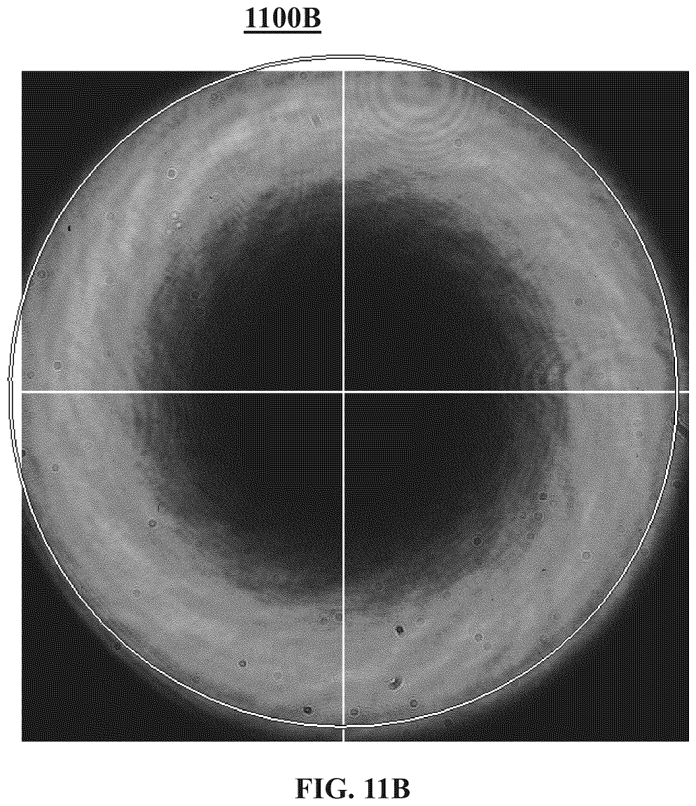

The round-tip apex of an axicon may imprint a wave-front curvature onto an incoming light beam that passes through the apex as shown in the diagrams 1000A and 1000B. This effect is described in Oto Brzobohaty, Tomas Cizmar, and Pavel Zemanek, High quality quasi-Bessel beam generated by round-tip axicon, Optics Express, 12688 (2008); which is incorporated by reference in its entirety. This wave-front curvature causes the light beam to form ripples in the annulus (as depicted in FIG. 11A) and a bright spot at the center of the annular beam, known as the “apex effect.”

Specifically, the diagram 1000B, providing a magnified view of the apex of the axicon, shows how the rounding of the apex causes a central peak due to the apex effect. As illustrated, with the apex effect, distortion may occur near the apex of a refractive axicon due to inherent curvature of this area. The apex effect may decrease the resolution and increase the intensity ripples of the ring in the annular beam produced by the axicon. The size of the central peak and the ring may depend on the apex sharpness of the refractive axicon. For example, the shaper the apex tip, the smaller the central peak and the more homogeneous the intensity of the annular beam.

FIG. 11A shows a depiction 1100A of ripples in the annulus of the beam formed from a refractive axicon pair. For example, the depiction 1100A may correspond to refractive axicons that may be the same as or similar to those shown in the diagrams 1000A or 1000B. For example, the ripples in the annulus and the bright spot at the center of the annular beam may correspond to Z₁ and Z₂ shown in the diagrams 1000A or 1000B.

The depiction 1100A of an annular beam shape with ripples and a bright central spot can be contrasted with FIG. 11B, which shows a depiction 1100B of an annular beam shape without ripples. In contrast, rather than ripples, the depiction 1100B shows a beam shape that is largely smooth and a center that is dark. In some cases, to be considered as achieving a dark center, in some cases, an annular beam may have a center point with an intensity that is lower than at least 90% of the intensity of other points in the overall annular beam. To be considered as achieving a dark center, in some cases, an annular beam may have a center point with an intensity that is lower than at least 95% of the intensity of other points in the overall annular beam. To be considered as achieving a dark center, in some cases, an annular beam may have a center point with an intensity that is lower than at least 99% of other points in the intensity of the overall annular beam. To be considered as achieving a dark center, in some cases, an annular beam may have a center point with an intensity that is lower than at least 99.9% of the intensity of other points in the overall annular beam. To be considered as achieving a dark center, in some cases, an annular beam may have a center point with an intensity that is lower than at least 99.99% of other points in the intensity of the overall annular beam.

### Example Axicon Configurations

In some cases, the systems, the methods, the computer-readable media, and the techniques disclosed herein may use a plurality of axicons (e.g., a pair of two axicons). In some cases, the plurality of axicons are configured to generate annular light beams. In one example, the plurality of axicons may comprise two axicons (or a “pair” of axicons). However, in other examples, the plurality of axicons may comprise more than two axicons (e.g., three axicons, four axicons, five axicons, six axicons, seven axicons, eight axicons, nine axicons, ten axicons, etc.).

In some cases, the systems, the methods, the computer-readable media, and the techniques disclosed herein may provide a pair of axicons with a first axicon and a second axicon, where the first axicon and the second axicon are positioned along an optical axis with the second axicon subsequent along the optical axis to the first axicon.

### Diffractive Axicon Configurations

As disclosed herein, in a pair of axicons with a first axicon and a second axicon, the first axicon and the second axicon may be positioned along an optical axis with the second axicon subsequent along the optical axis to the first axicon.

In some cases, the first axicon may be a diffractive axicon. Advantageously, the diffractive axicon may be manufactured by nano-scale fabrication, with a rigorous computational design of the holography, which can realize sub-wavelength scale apex curvature. Through having a sub-wavelength scale apex curvature, the diffractive axicon may be effectively infinitely sharp from the perspective of an incident laser beam. In some cases, there may be a tradeoff with loss of power due to imperfect diffraction efficiency, which may result in a loss in total incident power.

In some cases, the diffractive axicon may have a transmission efficiency of about 75% to about 100%. In some cases, the diffractive axicon may have a transmission efficiency of about 75% to about 80%, about 75% to about 85%, about 75% to about 90%, about 75% to about 95%, about 75% to about 100%, about 80% to about 85%, about 80% to about 90%, about 80% to about 95%, about 80% to about 100%, about 85% to about 90%, about 85% to about 95%, about 85% to about 100%, about 90% to about 95%, about 90% to about 100%, or about 95% to about 100%. In some cases, the diffractive axicon may have a transmission efficiency of about 75%, about 80%, about 85%, about 90%, about 95%, or about 100%. In some cases, the diffractive axicon may have a transmission efficiency of at least about 75%, about 80%, about 85%, about 90%, or about 95%. In some cases, the diffractive axicon may have a transmission efficiency of at most about 80%, about 85%, about 90%, about 95%, or about 100%. In some cases, the diffractive axicon may have an overall efficiency of about 75% to about 100%. In some cases, the diffractive axicon may have an overall efficiency of about 75% to about 80%, about 75% to about 85%, about 75% to about 90%, about 75% to about 95%, about 75% to about 100%, about 80% to about 85%, about 80% to about 90%, about 80% to about 95%, about 80% to about 100%, about 85% to about 90%, about 85% to about 95%, about 85% to about 100%, about 90% to about 95%, about 90% to about 100%, or about 95% to about 100%. In some cases, the diffractive axicon may have an overall efficiency of about 75%, about 80%, about 85%, about 90%, about 95%, or about 100%. In some cases, the diffractive axicon may have an overall efficiency of at least about 75%, about 80%, about 85%, about 90%, or about 95%. In some cases, the diffractive axicon may have an overall efficiency of at most about 80%, about 85%, about 90%, about 95%, or about 100%.

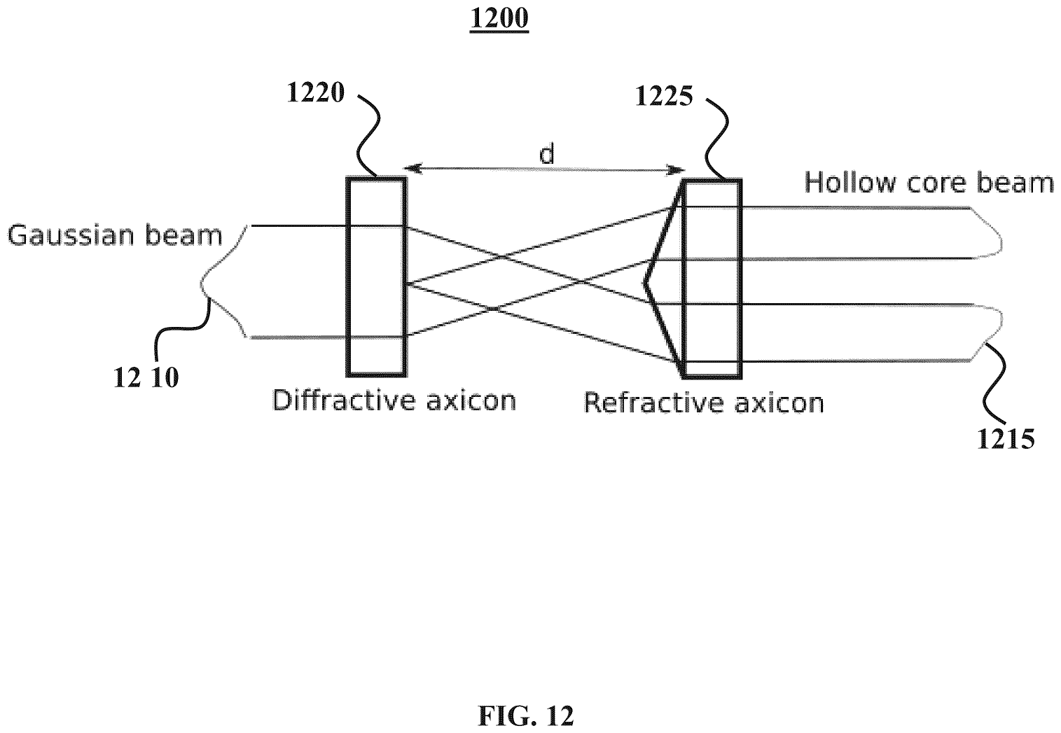

FIG. 12 shows a diagram 1200 of a diffractive-refractive axicon pair. The diagram 1200 shows a beam 1210, which is incident on a diffractive axicon 1220. The diagram 1200 shows the diffractive axicon 1220 diverts the beam 1210 onto a refractive axicon 1225. The refractive axicon 1225 then forms a diverging hollow core beam with a dark center and clean lobes. The diagram 1200 shows the refractive axicon 1225, which is placed at distance, d, away from the diffractive axicon 1220. The refractive axicon 1225 collimates into a diverging hollow core beam 1215.

As illustrated in the diagram 1200, the beam 1210 may be a Gaussian beam (or an approximation of a Gaussian beam). Although illustrated as a Gaussian beam (e.g., a Gaussian beam, a Hermite-Gaussian beam, an Ince-Gaussian beam, a higher-order Gaussian beam, a Laguerre-Gaussian beam, a Bessel-Gaussian beam, a flat-top Gaussian beam, a Super-Gaussian beam, a Mathieu-Gaussian beam, a Hyper-Gaussian beam, a Cosine-Gaussian beam, an Elliptical Gaussian beam, a fractional Gaussian beam, quasi-Gaussian beam, etc.), the beam 1210 may be, in practice, a different type of beam, such as a substantially uniform, substantially flat-top, top-hat. Lorentz, vortex, Bessel type, or quasi-Bessel type beam.

In some cases, the beam 1210 may have a wavelength of about 350 nanometers (nm) to about 750 nm. In some cases, the beam 1210 may have a wavelength of about 350 nm to about 400 nm, about 350 nm to about 450 nm, about 350 nm to about 500 nm, about 350 nm to about 550 nm, about 350 nm to about 600 nm, about 350 nm to about 650 nm, about 350 nm to about 700 nm, about 350 nm to about 750 nm, about 400 nm to about 450 nm, about 400 nm to about 500 nm, about 400 nm to about 550 nm, about 400 nm to about 600 nm, about 400 nm to about 650 nm, about 400 nm to about 700 nm, about 400 nm to about 750 nm, about 450 nm to about 500 nm, about 450 nm to about 550 nm, about 450 nm to about 600 nm, about 450 nm to about 650 nm, about 450 nm to about 700 nm, about 450 nm to about 750 nm, about 500 nm to about 550 nm, about 500 nm to about 600 nm, about 500 nm to about 650 nm, about 500 nm to about 700 nm, about 500 nm to about 750 nm, about 550 nm to about 600 nm, about 550 nm to about 650 nm, about 550 nm to about 700 nm, about 550 nm to about 750 nm, about 600 nm to about 650 nm, about 600 nm to about 700 nm, about 600 nm to about 750 nm, about 650 nm to about 700 nm, about 650 nm to about 750 nm, or about 700 nm to about 750 nm. In some cases, the beam 1210 may have a wavelength of about 350 nm, about 400 nm, about 450 nm, about 500 nm, about 550 nm, about 600 nm, about 650 nm, about 700 nm, or about 750 nm. In some cases, the beam 1210 may have a wavelength of at least about 350 nm, about 400 nm, about 450 nm, about 500 nm, about 550 nm, about 600 nm, about 650 nm, or about 700 nm. In some cases, the beam 1210 may have a wavelength of at most about 400 nm, about 450 nm, about 500 nm, about 550 nm, about 600 nm, about 650 nm, about 700 nm, or about 750 nm.

In some cases, the diffractive axicon 1220 may be positioned to be incident to some of or substantially all of the beam 1210. In some cases, the diffractive axicon 1220 may be cone-shaped or with a conical surface. However, in other cases, the diffractive axicon 1220 be non-cone shaped. For example, the diffractive axicon 1220 may have a substantially rectangular side profile (e.g., having a cylindrical body with a flat or rectangular lens). Unlike other types of axicons, diffractive axicons may not use a conical shape for their function; instead functioning through the use of microscopic diffractive patterns etched on their surface. The structure of a diffractive axicon may be characterized by diffractive elements etched onto the surface (e.g., substantially concentric rings). These diffractive elements may bend or diffract incoming light beams. For example, the spacing, size, and shape of the diffractive elements may manipulate the phase of an incoming wavefront so that the diffractive elements create constructive interference to form a diverging ring-shaped light beam when exiting the axicon.

Advantageously, as the diffractive axicon 1220 may be non-cone shaped (e.g., cylindrically-shaped), the diffractive axicon 1220 may not possess an apex and may therefore not face the challenge of the “apex effect,” experienced by a conical refractive axicon.

In some cases, the diffractive axicon 1220 may comprise optical materials including one or more of: glass (e.g., fused silica, borosilicate, crown glass, etc.), crystal (e.g., sapphire, quartz, zinc selenide, etc.), plastic (e.g., optically clear plastics), silicon, germanium, diamond, etc.

In some cases, the diffractive elements of the diffractive axicon 1220 may have a spacing of about 300 nm to about 1,500. In some cases, the diffractive elements of the diffractive axicon 1220 may have a spacing of about 300 nm to about 400 nm, about 300 nm to about 500 nm, about 300 nm to about 600 nm, about 300 nm to about 700 nm, about 300 nm to about 800 nm, about 300 nm to about 900 nm, about 300 nm to about 1,000 nm, about 300 nm to about 1,500, about 400 nm to about 500 nm, about 400 nm to about 600 nm, about 400 nm to about 700 nm, about 400 nm to about 800 nm, about 400 nm to about 900 nm, about 400 nm to about 1,000 nm, about 400 nm to about 1,500, about 500 nm to about 600 nm, about 500 nm to about 700 nm, about 500 nm to about 800 nm, about 500 nm to about 900 nm, about 500 nm to about 1,000 nm, about 500 nm to about 1,500, about 600 nm to about 700 nm, about 600 nm to about 80r nm, about 600 nm to about 900 nm, about 600 nm to about 1,000 nm, about 600 nm to about 1,500, about 700 nm to about 800 nm, about 700 nm to about 900 nm, about 700 nm to about 1,000 nm, about 700 nm to about 1,500, about 800 nm to about 900 nm, about 800 nm to about 1,000 nm, about 800 nm to about 1,500, about 900 nm to about 1,000 nm, about 900 nm to about 1,500, or about 1,000 nm to about 1,500. In some cases, the diffractive elements of the diffractive axicon 1220 may have a spacing of about 300 nm, about 400 nm, about 500 nm, about 600 nm, about 700 nm, about 800 nm, about 900 nm, about 1,000 nm, or about 1,500. In some cases, the diffractive elements of the diffractive axicon 1220 may have a spacing of at least about 300 nm, about 400 nm, about 500 nm, about 600) nm, about 700 nm, about 800 nm, about 900 nm, or about 1,000 nm. In some cases, the diffractive elements of the diffractive axicon 1220 may have a spacing of at most about 400 nm, about 500 nm, about 600 nm, about 700 nm, about 800 nm, about 900 nm, about 1,000 nm, or about 1,500.

In some cases, the diffractive axicon 1220 may comprise one or more of the following characteristics that may be the same as or similar to the diffractive axicons of Table 1 or Table 2.

TABLE 1
One example of parameters of an example diffractive axicon.

| Clear | | Design | | | |
|---|---|---|---|---|---|
| Aperture | | Wavelength | Diameter | | Thickness |
| (mm) | Coating | (nm) | (mm) | Substrate | (mm) |
| 22.9 | Laser V-Coat | 1064 | 25.40 + | Fused Silica | 3.00 ± 0.1 |
| | (1064 nm) | | 0.05/−0.15 | (Corning 7980) | |

| | Minimum | | Zero Order, | | |
|---|---|---|---|---|---|
| Input | Beam | Overall | Relative to the | | |
| Beam | Diameter | Efficiency | Incident Beam | Ring Angle | Axicon |
| Mode | (mm) | (%) | (%) | P2P (°) | Type |
| Single- | 0.27 | 92 | <1 | 1.35 | Positive |
| Mode or | | | | | |
| Multi- | | | | | |
| Mode | | | | | |

TABLE 2
Another example of parameters of another example diffractive axicon.

| Clear | | Design | | | |
|---|---|---|---|---|---|
| Aperture | | Wavelength | Diameter | | Thickness |
| (mm) | Coating | (nm) | (mm) | Substrate | (mm) |
| 20.0 | AR/AR | 399 | 25.40 + | Fused Silica | 3.00 ± 0.1 |
| | COATING | | 0.05/−0.15 | (Coming 7980) | |

| | Minimum | | Zero Order, | | |
|---|---|---|---|---|---|
| Input | Beam | Overall | Relative to the | | |
| Beam | Diameter | Efficiency | Incident Beam | Ring Angle | Axicon |
| Mode | (mm) | (%) | (%) | P2P (°) | Type |
| Single- | 0.07 | 87 | <0.5 | 1.88 | Positive |
| Mode or | | | | | |
| Multi- | | | | | |
| Mode | | | | | |

Notably, the diffractive axicon of Table 2 has a transmission efficiency close to 100% and an overall diffraction efficiency of about 87%. Further, the zero order relative to the incident beam is about <0.5%, which corresponds to the extinction ratio between dark/bright parts of the collimated annular beam.

In some cases, distance, d, may be tunable to change the hollow core size of the diverging hollow core beam that is incident on the refractive axicon 1225. For example, increasing the distance, d, from the distance illustrated in the diagram 1200 may increase the diameter of the hollow core of the diverging hollow core beam. In some cases, the distance, d, may be about 0.37 meters. In some cases, the distance, d, may be about 0.01 m to about 10 m. In some cases, the distance, d, may be about 0.01 m to about 0.05 in, about 0.01 m to about 0.1 m, about 0.01 m to about 0.5 m, about 0.01 m to about 1 m, about 0.01 m to about 5 m, about 0.01 m to about 10 m, about 0.05 m to about 0.1 1 m, about 0.05 m to about 0.5 m, about 0.05 m to about 1 m, about 0.05 m to about 5 m, about 0.05 in to about 10 in, about 0.1 m to about 0.5 in, about 0.1 m to about 1 in, about 0.1 n to about 5 in, about 0.1 m to about 10 m, about 0.5 m to about 1 m, about 0.5 m to about 5 m, about 0.5 m to about 10 m, about 1 in to about 5 m, about 1 m to about 10 in, or about 5 in to about 10 n. In some cases, the distance, d, may be about 0.01 m, about 0.05 m, about 0.1 in, about 0.5 in. about 1 in, about 5 in, or about 10 m. In some cases, the distance, d, may be at least about 0.01 in, about 0.05 in, about 0.1 in, about 0.5 in, about 1 in, or about 5 in.

In some cases, the distance, d, may be at most about 0.05 in. about 0.1 m, about 0.5 n, about 1 in, about 5 m, or about 10 n. In practice, the distance, d, may be scaled in tandem with the scale and optical properties of the optical devices being used.

In some cases, the optical setup of FIGS. 10A, 10B, and 12-15 may be configured as photonic integrated circuits on a 2D photonic crystal. These photonic crystals may be made of monocrystalline Silicon (Si), polycrystalline Silicon (Si), Silicon Photonics (SiPh), Silica, Silicon Nitride (SiN), Indium Phosphate (InP), Lithium Niobate (LiNbO₃), Gallium Arsenide (GaAs), Germanium (Ge), Copper Indium Gallium Selenide (CIGS), a wide class of Perovskites, metal chalcogenides, organometallics, or any material in which a 2D waveguide may be formed.

In some cases, the distance, d, may be determined by the scale of the photonic integrated circuit. For example, in some cases, the distance, d, may be about 0.1 i nm to about 100 nm. In some cases, the distance, d, may be about 0.1 nm to about 0.5 nm, about 0.1 nm to about 1 nm, about 0.1 nm to about 2 nm, about 0.1 nm to about 3 nm, about 0.1 nm to about 4 nm, about 0.1 nm to about 5 nm, about 0.1 nm to about 10 nm, about 0.1 nm to about 20 nm, about 0.1 nm to about 50 nm, about 0.1 nm to about 100 nm, about 0.5 nm to about 1 nm, about 0.5 nm to about 2 nm, about 0.5 nm to about 3 nm, about 0.5 nm to about 4 nm, about 0.5 nm to about 5 nm, about 0.5 nm to about 10 nm, about 0.5 nm to about 20 nm, about 0.5 nm to about 50 nm, about 0.5 nm to about 100 nm, about 1 nm to about 2 nm, about 1 nm to about 3 nm, about 1 nm to about 4 nm, about 1 nm to about 5 nm, about 1 nm to about 10 nm, about 1 nm to about 20 nm, about 1 nm to about 50 nm, about 1 nm to about 100 nm, about 2 nm to about 3 nm, about 2 nm to about 4 nm, about 2 nm to about 5 nm, about 2 nm to about 10 nm, about 2 nm to about 20 nm, about 2 nm to about 50 nm, about 2 nm to about 100 nm, about 3 nm to about 4 nm, about 3 nm to about 5 nm, about 3 nm to about 10 nm, about 3 nm to about 20 nm, about 3 nm to about 50 nm, about 3 nm to about 100 nm, about 4 nm to about 5 nm, about 4 nm to about 10 nm, about 4 nm to about 20 nm, about 4 nm to about 50 nm, about 4 nm to about 100 nm, about 5 nm to about 10 nm, about 5 nm to about 20 nm, about 5 nm to about 50 nm, about 5 nm to about 100 nm, about 10 nm to about 20 nm, about 10 nm to about 50 nm, about 10 nm to about 100 nm, about 20 nm to about 50 nm, about 20 nm to about 100 nm, or about 50 nm to about 100 nm. In some cases, the distance, d, may be about 0.1 nm, about 0.5 nm, about 1 nm, about 2 nm, about 3 nm, about 4 nm, about 5 nm, about 10 nm, about 20 nm, about 50 nm, or about 100 rnm. In some cases, the distance, d, may be about at least about 0.1 nm, about 0.5 nm, about 1 nm, about 2 nm, about 3 nm, about 4 nm, about 5 nm, about 10 nm, about 20 nm, or about 50 nm. In some cases, the distance, d, may be about at most about 0.5 nm, about 1 nm, about 2 nm, about 3 nm, about 4 nm, about 5 nm, about 10 nm, about 20 nm, about 50 nm, or about 100 rnm. In practice, the distance, d, may be scaled in tandem with the scale and optical properties of the optical devices being used.

In some cases, the diverging hollow core beam is incident on the refractive axicon 1225. The refractive axicon 1225 may be the same as or similar to the refractive axicons disclosed herein with respect to FIGS. 10A-11B. For example (and as illustrated in the diagram 1200), the refractive axicon 1225 may have a conical shape. The refractive axicon may comprise optical materials including one or more of: glass (e.g., fused silica, borosilicate, crown glass, etc.), crystal (e.g., sapphire, quartz, zinc selenide, etc.), plastic (e.g., optically clear plastics), silicon, germanium, diamond, etc.

In some cases, the refractive axicon 1225 may comprise one or more of the following characteristics that may be the same as or similar to one or more of the refractive axicons of Table 3. For example, the refractive axicon 1225 may be the same as or similar to the Thorlabs AX252-A axicon.

TABLE 3
Listing of refractive axicon parameters with deflection
angles calculated for light of about 532 nm.

| Thorlabs | | Physical | Deflection | Center Thickness | |
|---|---|---|---|---|---|
| Item No. | Diameter | Angle (α) | Angle (β)^{a} | (t_{c}) | |
| AX1205-A | Ø ½″ | 0.5° | 0.2° | 5.1 | mm |
| AX121-A | (Ø 12.7 mm) | 1.0° | 0.5° | 5.1 | mm |
| AX122-A | | 2.0° | 0.9° | 5.2 | mm |
| AX125-A | | 5.0° | 2.3° | 5.6 | mm |
| AX1210-A | | 10.0° | 4.7° | 6.1 | mm |
| AX1220-A | | 20.0° | 10.0° | 7.3 | mm |
| AX1240-A | | 40.0° | 29.9° | 10.3 | mm |
| AX2505-A | Ø 1″ | 0.5° | 0.2° | 5.1 | mm |
| AX251-A | (Ø 25.4 mm) | 1.0° | 0.5° | 5.2 | mm |
| AX252-A | | 2.0° | 0.9° | 5.4 | mm |
| AX255-A | | 5.0° | 2.3° | 6.1 | mm |
| AX2510-A | | 10.0° | 4.7° | 7.2 | mm |
| AX2520-A | | 20.0° | 10.0° | 9.6 | mm |
| AX2540-A | | 40.0° | 29.9° | 15.7 | mm |

As disclosed herein, the refractive axicon 1225 may be one of two primary conical shapes: cone-shaped or pyramid-shaped. In cases with the refractive axicon 1225 being cone-shaped, the refractive axicon 1225 may have a substantially conical surface and a substantially flat surface. The apex angle of the cone determines the ring diameter of the annular beam produced. The conical shape allows these axicons to turn a collimated Gaussian beam into an annular beam. In cases with the refractive axicon 1225 being pyramid-shaped (also known as axicon prisms), the refractive axicon 1225 may have a substantially conical tip that may resemble a pyramid or a prism. The pyramid-shaped axicon may include a base and multiple flat sides (e.g., three sides, four sides, five sides, six sides, etc.) that come to a point.

In some cases, the dimensions and angles of the refractive axicon 1225 (e.g., whether cone-shaped or pyramid-shaped) will determine properties of the light refracted through the refractive axicon 1225, such as the diameter of the annular light, the thickness of the annular beam's core, the depth of the focus field, etc. Different designs may be used depending on the optical application. For example, one factor in design of the refractive axicon 1225 may be the precision of the angles and surfaces, as even small errors may affect the quality of the output beam.

In some cases, the refractive axicon 1225 may be used in the diagram 1200 as the second axicon to save on power loss. Due to the first axicon being the diffractive axicon 1220, the apex of the refractive axicon 1225 is substantially not illuminated by the diverging hollow core beam. Therefore, in using the refractive axicon 1225 as the second axicon in the diagram 1200, the apex effect typically resulting from use of refractive axicons becomes a non-issue.

Advantageously, because refractive optical elements may have a greater efficiency than diffractive optical elements, using the refractive axicon 1225 as the second axicon of the diagram 1200, helps to improve efficiency over using a diffractive axicon for both the first axicon and the second axicon. In some cases, diffractive optical elements may be generally intended for use within a specified wavelength range. Accordingly, pairing a diffractive axicon with a refractive axicon may use particular design considerations to achieve a collimated beam with reduced central contamination.

In some cases, the refractive axicon 1225 may have a transmission efficiency of about 90% to about 100%. In some cases, the refractive axicon 1225 may have a transmission efficiency of about 90% to about 92%, about 90% to about 94%, about 90% to about 96%, about 90% to about 98%, about 90% to about 99%, about 90% to about 99.9%, about 90% to about 99.99%, about 90% to about 100%, about 92% to about 94%, about 92% to about 96%, about 92% to about 98%, about 92% to about 99%, about 92% to about 99.9%, about 92% to about 99.99%, about 92% to about 100%, about 94% to about 96%, about 94% to about 98%, about 94% to about 99%, about 94% to about 99.9%, about 94% to about 99.99%, about 94% to about 100%, about 96% to about 98%, about 96% to about 99%, about 96% to about 99.9%, about 96% to about 99.99%, about 96% to about 100%, about 98% to about 99%, about 98% to about 99.9%, about 98% to about 99.99%, about 98% to about 100%, about 99% to about 99.9%, about 99% to about 99.99%, about 99% to about 100%, about 99.9% to about 99.99%, about 99.9% to about 100%, or about 99.99% to about 100%. In some cases, the refractive axicon 1225 may have a transmission efficiency of about 90%, about 92%, about 94%, about 96%, about 98%, about 99%, about 99.9%, about 99.99%, or about 100%. In some cases, the refractive axicon 1225 may have a transmission efficiency of at least about 90%, about 92%, about 94%, about 96%, about 98%, about 99%, about 99.9%, or about 99.99%. In some cases, the refractive axicon 1225 may have a transmission efficiency of at most about 92%, about 94%, about 96%, about 98%, about 99%, about 99.9%, about 99.99%, or about 1⁰⁰⁰%. 1761 As illustrated, the hollow core beam 1215 may be output from the refractive axicon 1225.

In some cases, the hollow core beam 1215 may be substantially collimated. In some cases, the hollow core beam 1215 may have a divergence with a half angle of about 0.1° to about 15°. In some cases, the hollow core beam 1215 may have a divergence with a half angle of about 0.1° to about 0.5°, about 0.1° to about 1°, about 0.1° to about 1.5°, about 0.1° to about 2°, about 0.1° to about 3°, about 0.1° to about 4°, about 0.1° to about 5°, about 0.1° to about 7°, about 0.1° to about 10°, about 0.1° to about 15°, about 0.5° to about 1°, about 0.5° to about 1.5°, about 0.5° to about 2°, about 0.5° to about 3°, about 0.5° to about 4°, about 0.5° to about 5°, about 0.5° to about 7°, about 0.5° to about 10°, about 0.5° to about 15°, about 1° to about 1.5°, about 1°l ° to about 2°, about 1° to about 3°, about 1° to about 4°, about 1° to about 5°, about 1°l ° to about 7°, about 1° to about 10°, about 1° to about 15°, about 1.5° to about 2°, about 1.5° to about 3°, about 1.5° to about 4°, about 1.5° to about 5°, about 1.5° to about 7°, about 1.5° to about 10°, about 1.5° to about 15°, about 2° to about 3°, about 2° to about 4°, about 2° to about 5°, about 2° to about 7°, about 2° to about 10°, about 2° to about 15°, about 3° to about 4°, about 3° to about 5°, about 3° to about 7°, about 3° to about 10°, about 3° to about 15°, about 4° to about 5°, about 4° to about 7°, about 4° to about 10°, about 4° to about 15°, about 5° to about 7°, about 5° to about 10°, about 5° to about 15°, about 7° to about 10°, about 7° to about 15°, or about 10° to about 15⁰. In some cases, the hollow core beam 1215 may have a divergence with a half angle of about 0.1°, about 0.5°, about 1°, about 1.5⁰, about 2°, about 3°, about 4°, about 5°, about 7°, about 10°, or about 15⁰. In some cases, the hollow core beam 1215 may have a divergence with a half angle of at least about 0.1°, about 0.5°, about 1°, about 1.5°, about 2°, about 3°, about 4°, about 5°, about 7°, or about 10°. In some cases, the hollow core beam 1215 may have a divergence with a half angle of at most about 0.5°, about 1°, about 1.5⁰ about 2°, about 3°, about 4°, about 5°, about 7°, about 10°, or about 15°.

In some cases, the hollow core beam 1215 may have a dark region with a radius of about 5% of the total radius of the hollow core beam 1215 to about 75% of the total radius of the hollow core beam 1215. In some cases, the hollow core beam 1215 may have a dark region with a radius of about 5% of the total radius of the hollow core beam 1215 to about 10% of the total radius of the hollow core beam 1215, about 5% of the total radius of the hollow core beam 1215 to about 25% of the total radius of the hollow core beam 1215, about 5% of the total radius of the hollow core beam 1215 to about 50% of the total radius of the hollow core beam 1215, about 5% of the total radius of the hollow core beam 1215 to about 75% of the total radius of the hollow core beam 1215, about 10% of the total radius of the hollow core beam 1215 to about 25% of the total radius of the hollow core beam 1215, about 10% of the total radius of the hollow core beam 1215 to about 50% of the total radius of the hollow core beam 1215, about 10% of the total radius of the hollow core beam 1215 to about 75% of the total radius of the hollow core beam 1215, about 25% of the total radius of the hollow core beam 1215 to about 50% of the total radius of the hollow core beam 1215, about 25% of the total radius of the hollow core beam 1215 to about 75% of the total radius of the hollow core beam 1215, or about 50% of the total radius of the hollow core beam 1215 to about 75% of the total radius of the hollow core beam 1215. In some cases, the hollow core beam 1215 may have a dark region with a radius of about 5% of the total radius of the hollow core beam 1215, about 10% of the total radius of the hollow core beam 1215, about 25% of the total radius of the hollow core beam 1215, about 50% of the total radius of the hollow core beam 1215, or about 75% of the total radius of the hollow core beam 1215. In some cases, the hollow core beam 1215 may have a dark region with a radius of at least about 5% of the total radius of the hollow core beam 1215, about 10% of the total radius of the hollow core beam 1215, about 25% of the total radius of the hollow core beam 1215, or about 50% of the total radius of the hollow core beam 1215. In some cases, the hollow core beam 1215 may have a dark region with a radius of at most about 10% of the total radius of the hollow core beam 1215, about 25% of the total radius of the hollow core beam 1215, about 50% of the total radius of the hollow core beam 1215, or about 75% of the total radius of the hollow core beam 1215.

### Applications to Laser Cooling

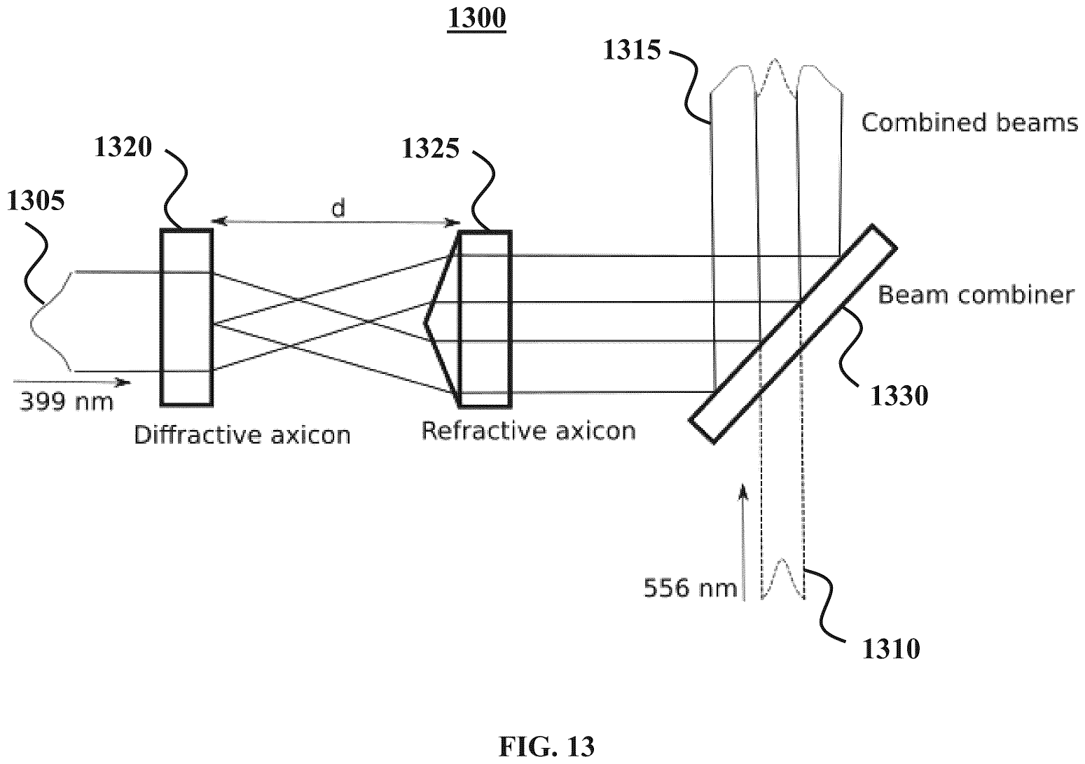

In some cases, the systems, the methods, the computer-readable media, and the techniques disclosed herein may be applied to laser cooling. In some cases, a bright spot formation at the center of the annulus beam (due to the apex effect) may be detrimental to the application of laser cooling, such as two-color core-shell MOT (see, e.g., Jeongwon Lee, Jae Hoon Lee, Jiho Noh, and Jongchul Mun, Core-Shell Magneto-Optical Trap for Alkalne-Earth-Metal-Like Atoms, arXiv:1412.2854 [physics.atom-ph], available at https://arxiv.org/abs/1412.2854, which is incorporated by reference in its entirety). The diffractive-refractive axicon pair can help reduce (e.g., eliminate) rid of the leakage intensity at the center. FIG. 13 shows an example of a diagram 1300 of a diffractive-refractive axicon pair of the present disclosure applied to two-color laser cooling.

In some cases, laser cooling of atoms may utilize photon momentum transfers mediated through electronic level transition of the atoms. For example, Ytterbium atoms utilize two transitions, one for ¹S₀-¹P₁ at 399 nm wavelength and ¹S₀-³P₁ at 556 nm wavelength. The former is a broad transition of linewidth 28 MHz, and the latter is a narrow transition of linewidth 180 kHz. In some cases, the broader the transition linewidth, the higher the cooling power, but the higher the final temperature as well. For the initial fast and efficient capture of hot atoms out of an oven, the broad transition may be useful, whereas for the final cooling of the atoms toward a few micro-Kelvin, the narrow transition may be useful. One way of utilizing both transitions is to spatially overlap two Gaussian beams of the different wavelengths and control each beam power sequentially in order to firstly cool atoms by the broad transition, followed by the narrow transition that takes over pre-cooled atoms to further cool down to a few micro-Kelvin so that the two different cooling regime sequentially happens in the same spatial location. For example, the approach of the diagram 1300 in cooling atoms may be applied to cooling the hot atom source 1450 of FIG. 14 to obtain the cooled atoms 1460 via the combined beams 1415 and the retro-reflectors 1440.

In contrast, by using the diffractive-refractive axicon pair, the broad transition and the narrow transition can be spatially separated, allowing both cooling operations to happen simultaneously. In detail, hot atoms out of the oven may be captured through a 399 nm hollow-core beam, collecting pre-cooled atoms into the center of the core. Subsequently, the atoms may be further cooled down at the center through a 556 nm Gaussian beam. In some cases, both cooling stages simultaneously occur, resulting in much faster loading rate.

The diagram 1300 of FIG. 13 shows a beam 1305, which transmits through a diffractive axicon 1320 and a refractive axicon 1325, forming a hollow-core beam having a tunable core size, and reflected off of a beam combiner 1330. The diagram 1300 further shows a beam 1310, which transmits through the beam combiner 1330, spatially overlapping with the hollow-core beam from the beam 1305, co-propagating thereafter in a co-propagating beam 1315. In some cases, the co-propagating beam 1315 addresses a plurality of atoms (e.g., in an array of spatially distinct optical trapping sites). For example, the co-propagating beam 1315 may be used to cool the plurality of atoms.

In some cases, the beam 1305 may be the same as or similar to the beam 1205 of the diagram 1200. For example, the beam 1305 may be a Gaussian beam. Further, for example, the beam 1305 may be of a wavelength of about 399 nm. Similarly, the beam 1310 may be the same as or similar to the beam 1205 of the diagram 1200. For example, the beam 1310 may be a Gaussian beam. Further, for example, the beam 1310 may be of a wavelength of about 556 nm. In some cases, the beam 1305 may be of a different wavelength than the beam 1310. However, in other cases, the beam 1305 may be of a substantially same wavelength as the beam 1310.

In some cases, the beam 1305 may be wider than the beam 1310. For example, the beam 1310 may have a width scaled to be substantially the same as the width of the tunable core size of the hollow-core beam output from the refractive axicon 1325. In other cases, the beam 1305 may be of a similar width to the beam 1310. In still other cases, the beam 1305 may be less wide than the beam 1310.

In some cases, the diffractive axicon 1320 may be the same as or similar to the diffractive axicon 1220. In some cases, the refractive axicon 1325 may be the same as or similar to the refractive axicon 1225.

In some cases, the beam combiner 1330 may be configured to combine two or more light beams. The beam combiner 1330 (also known as a dichroic mirror) may be an optical device used to combine two or more light beams into a combined beam. The beam combiner 1330 may comprise one or more reflective elements (e.g., mirrors) and one or more refractive elements (e.g., lenses, prisms, etc.) to combine the two or more light beams. In some cases, the beam combiner may be a lensacon (e.g., one or more axicons combined with one or more lenses). In some cases the beam combiner may be an on-chip 2D photonic crystal.

The layout or organization of the elements of the beam combiner 1330 may be designed to overlap the two or more light beams in a way that they are co-linear and appear to come from a single source, such as via using mirrors to direct the beams into a prism, which then combines the beams into one, or aligning the beams so they pass through a series of lenses that focus the light into a single point. The optical elements of the beam combiner 1330 may comprise one or more of: glass (e.g., fused silica, borosilicate, crown glass, etc.), crystal (e.g., sapphire, quartz, zinc selenide, etc.), plastic (e.g., optically clear plastics), silicon, germanium, diamond, etc. In some cases, the materials of the beam combiner 1330 may be selected to minimize light loss due to absorption and reflection. In some cases, the surfaces of these elements of the beam combiner 1330 may be coated with a thin layer of metal (e.g., aluminum or silver) or dielectric material to enhance reflective properties. In some cases, the beam combiner 1330 may have a rectangular shape, a square shape, a circular shape, etc., depending, for example, on the design and application.

In some cases, the beam combiner 1330 outputs the co-propagating beam 1315. The co-propagating beam 1315 may comprise a central region of light with a wavelength substantially the same as the wavelength of the beam 1310. The co-propagating beam 1315 may comprise an outer region of light with a wavelength substantially the same as the wavelength of the beam 1305. In some cases, there may be substantially no gap between the center region of the co-propagating beam 1315 and the outer region of the co-propagating beam 1315. In other cases, there may be a gap (an annular gap) between the center region of the co-propagating beam 1315 and the outer region of the co-propagating beam 1315. In other cases, there may be some overlap between the light of the center region of the co-propagating beam 1315 and the light of the outer region of the co-propagating beam 1315, creating a region (e.g., a small, annular region) of overlapping wavelengths of light.

### Magneto-Optical Trap Configuration

FIG. 14 shows an example diagram 1400 of a three-dimensional magneto-optical trap (MOT) configuration where two combined beams 1415 are used. The MOT of the diagram 1400 may be the same as or similar to the MOT 252 of FIG. 5. In some cases, the two combined beam 1415 may be generated using an implementation that is the same as or similar to the diagram 1300 of FIG. 13. In some cases, a hot atom source 1450 may provide one or more atoms to be cooled via the combined beams 1415 and retro-reflectors 1440, thereby helping to form cooled atoms 1460. Polarization optics, magnetic field gradient, and a third combined beam that is perpendicular to the page may be omitted for clarity.

In some cases, the two combined beams 1415 may be substantially identical to each other (and, e.g., also to the third combined beam that is perpendicular to the page). In other cases, the two combined beams 1415 may be different from one another (e.g., in wavelength, in intensity, in shape, etc.).

In some cases, the hot atom source 1450 may provide the one or more atoms to the cooled atoms 1460. The hot atom source may comprise a thermal unit. For example, the thermal unit may comprise an oven configured to heat the one or more atoms prior to the one or more atoms being cooled by the combined beams 1415 and the retro-reflectors 1440.

In some cases, the retro-reflectors 1440 may be configured to direct the combined beams 1415 to cool the one or more atoms from the hot atom source 1450. In some cases, the retro-reflectors 1440 may comprise a reflective surface. However, in other cases, other optical tools, such as refractors, diffractors, etc. may be used to direct the combined beams 1415 to cool the one or more atoms from the hot atom source 1450.

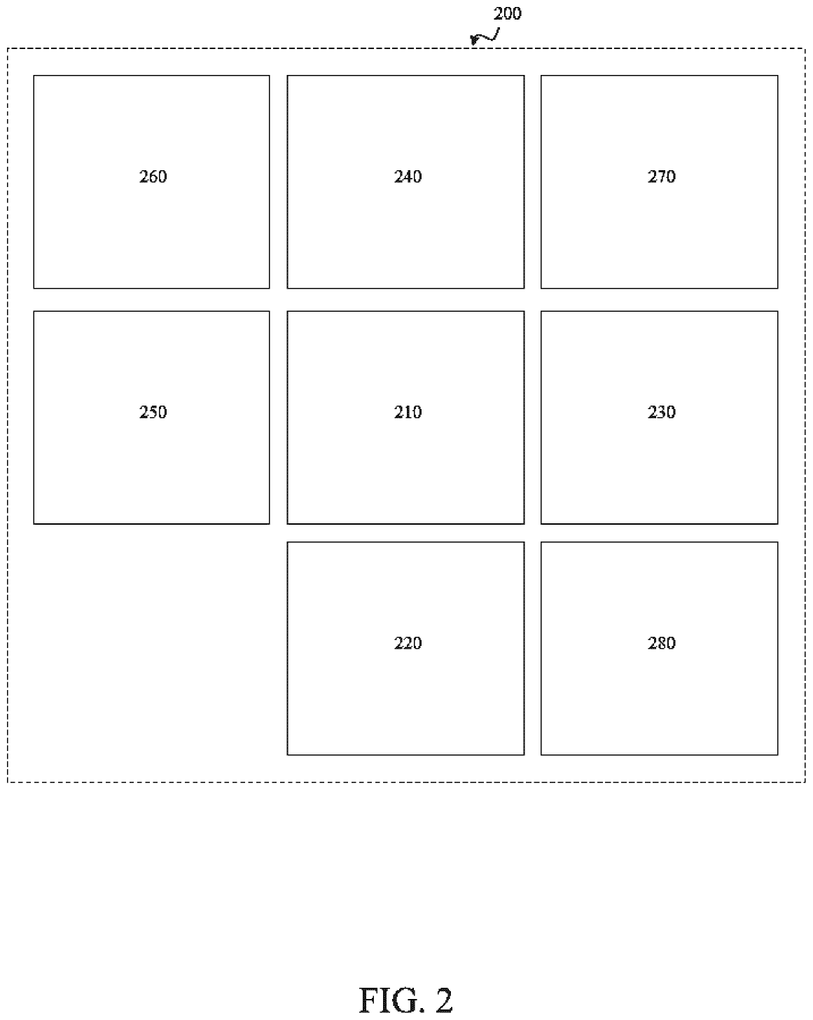

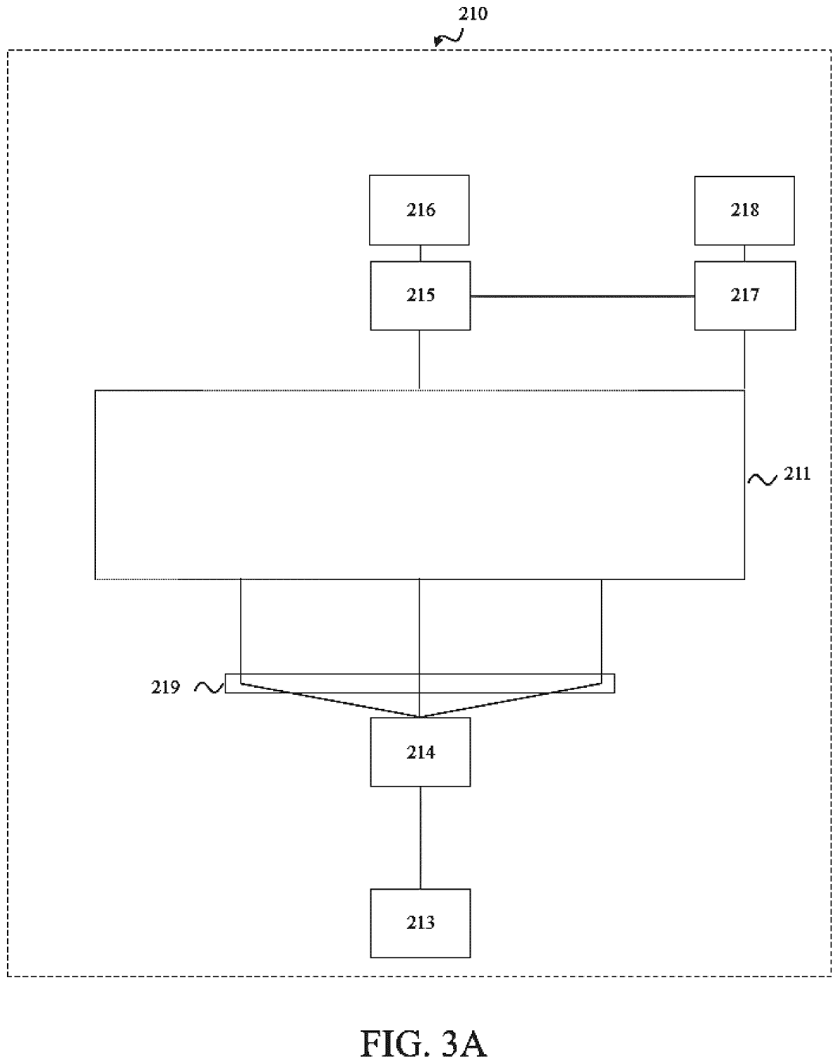

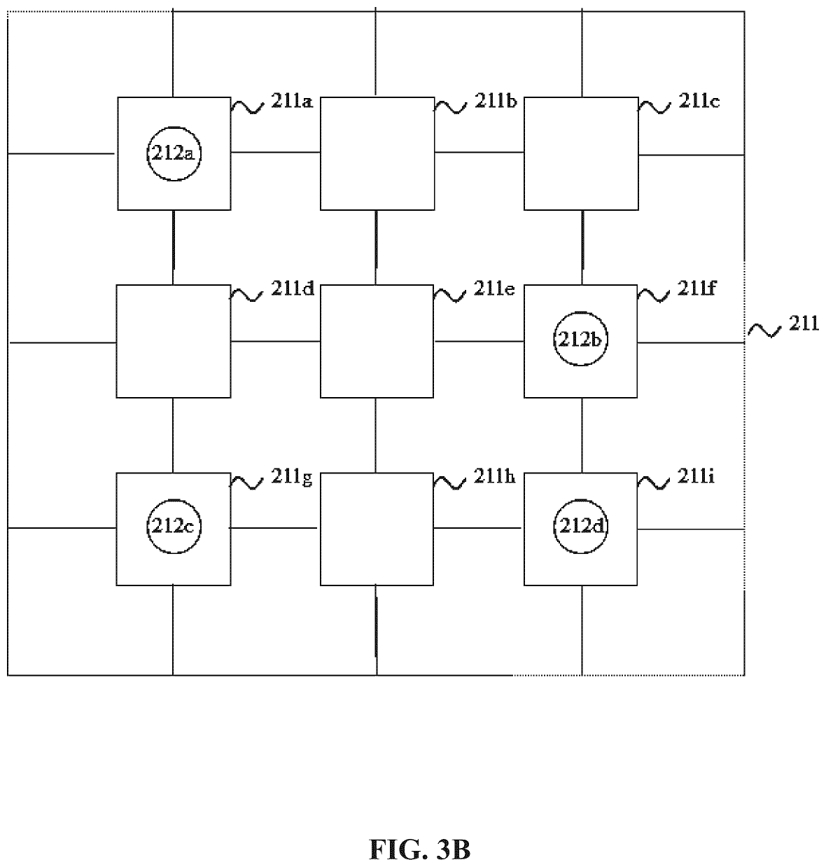

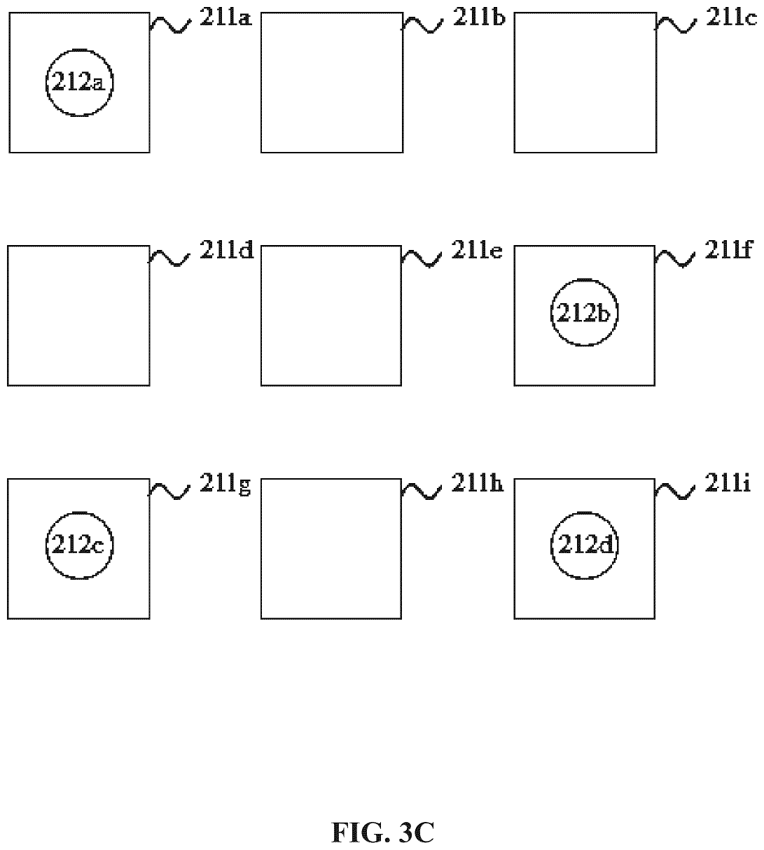

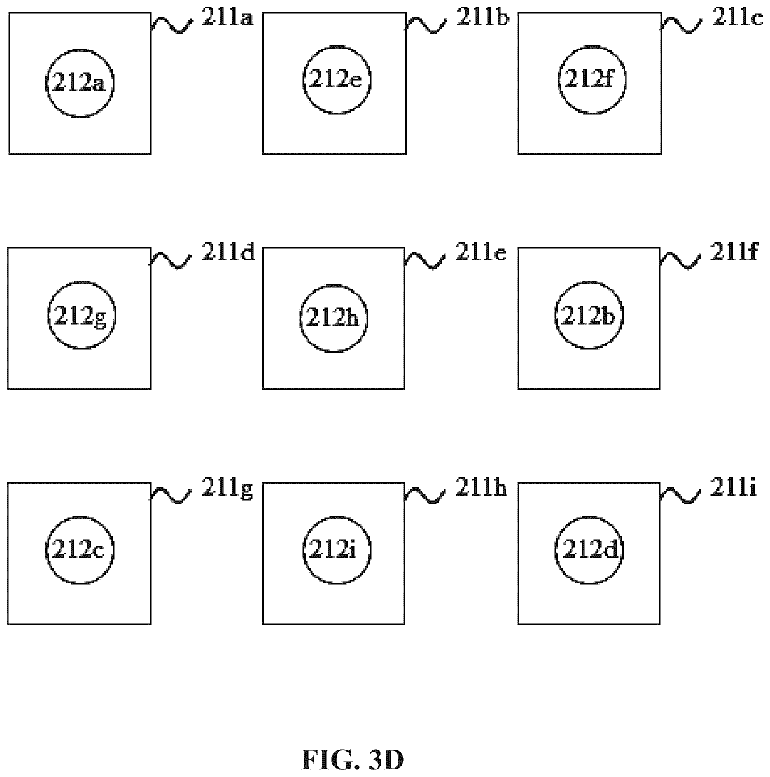

In some cases, the cold atoms 1460 may be trapped, cold, neutral atoms. Temperatures of the cold atoms 1460 may be below 100 μK. The cold atoms 1460 may be used for quantum computation, such as in the system for performing a non-classical computation of FIG. 2. For example, the cold atoms 1460 may be introduced into an optical array of spatially distinct trapping to be used as qubits. When trapped (e.g., in an optical trapping unit, such as described with respect to FIG. 3A), the qubits may fill one or more optical trapping sites (such as described with respect to FIGS. 3B-3D).

As illustrated, the diagram 1400 shows the combined beams 1415 (which may be the same as or similar to the co-propagating beam 1315) used in one illustrated example of a MOT. For example, the MOT may comprise a spatially-varying magnetic field (e.g., a quadrupolar magnetic field). However, in some cases, other configurations of a MOT beside the configuration illustrated may be used with the combined beams 1415. In some cases, the MOT may be the same as or similar to the MOT 252 of FIG. 5.

### Pairs of Diffractive Axicons

The diagrams 1200 and 1300 of FIGS. 12 and 13, respectively, illustrate the use of a diffractive-refractive axicon pair. However, in some cases, the refractive axicon 1225 of the diagram 1200 or the refractive axicon 1325 of the diagram 1300 may be substituted out for a diffractive axicon.

In some cases, two diffractive axicon (or a pair of diffractive axicons) may be used to generate an annular beam with a substantially dark center (e.g., not affected by the apex effect). For example, this configuration may resemble the configuration of the diagram 1200, but with a diffractive axicon used as the second axicon, rather than the refractive axicon 1225. While this pair of diffractive axicons may have a lower system efficiency than the system efficiency of a diffractive axicon followed by a refractive axicon, in some cases, the pair of diffractive axicons may present certain use cases. For example, paired diffractive axicons may be used to create a Bessel-like beam with an extended depth of focus.

In another example, the refractive axicon 1325 of the diagram 1300 may be substituted for a second diffractive axicon, while still maintaining a substantially dark center of the resulting annular light beam.

### Reflective Axicons

The diagrams 1200 and 1300 of FIGS. 12 and 13, respectively, illustrate the use of a diffractive-refractive axicon pair. However, in some cases, the diffractive axicon 1220 of the diagram 1200 or the diffractive axicon 1320 of the diagram 1300 may be substituted out for a reflective axicon. Further, in some cases, the refractive axicon 1225 of the diagram 1200 or the refractive axicon 1325 of the diagram 1300 may be substituted out for a reflective axicon. Therefore, reflective axicons may be used in place of one or both of diffractive or refractive axicons in FIG. 12 or 13.

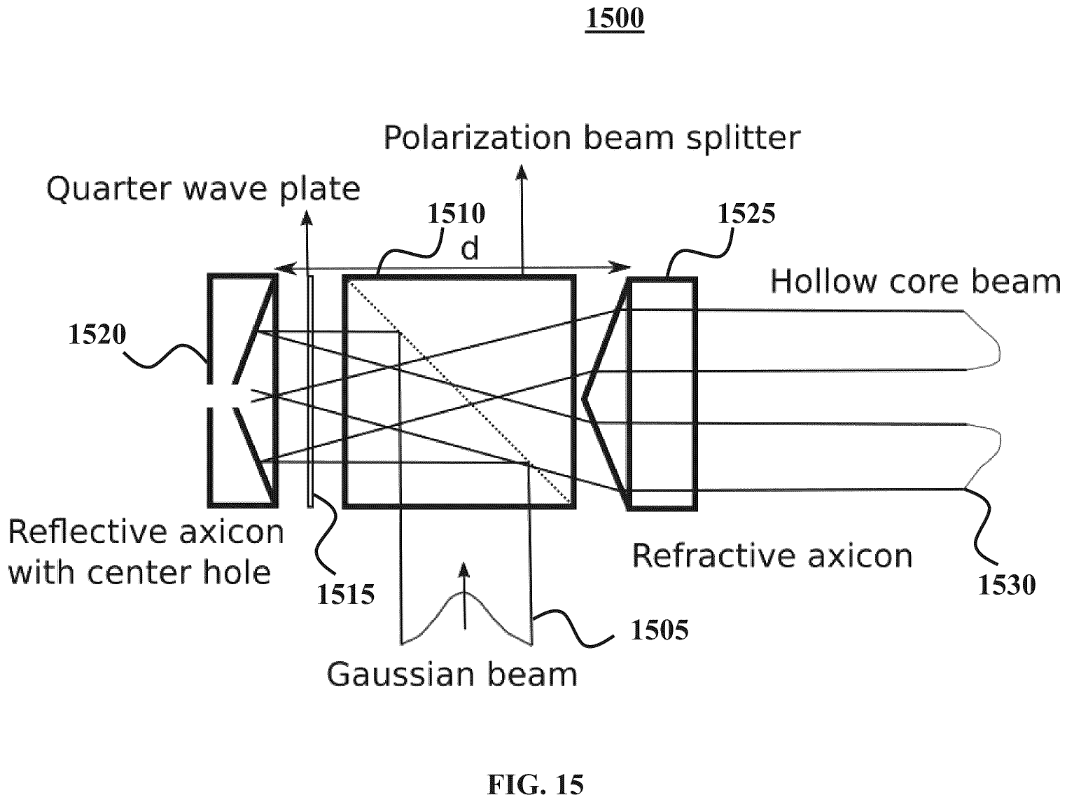

FIG. 15 shows an example of an implementation of a reflective-refractive axicon pair for generating an annular beam. The diagram 1500 shows a beam 1505, which is incident to a polarization beam splitter 1510. The diagram 1500 shows the polarization beam splitter 1510 diverts the beam 1505 through a quarter wave plate 1515 onto a reflective axicon 1520 with a center hole 1520. The reflective axicon diverts the beam 1505 onto a refractive axicon 1525. The refractive axicon 1525 then forms a diverging hollow core beam 1530 with a dark center and clean lobes. The diagram 1500 shows the refractive axicon 1525, which is placed at distance, d, away from the reflective axicon with center hole 1520. The refractive axicon 1525 collimates into the diverging hollow core beam 1530.

The reflective axicon 1525 may have a conical shape. However, the reflective axicon's 1525 conical shape may be akin to an “inverse” cone when compared to a refractive axicon. The reflective axicon 1525 may comprise a reflective material to enable light to bounce off the surface of the reflective axicon and may be polished to a high degree to enhance its reflective capacity. To reduce (e.g., eliminate) an analogous effect as the apex effect of conical refractive axicons when using reflective axicons, in some cases, the center of the reflective axicon 1520 (including the apex of the reflective axicon) may be omitted. For example, the reflective axicon 1525 may have a hole drilled straight down the center of the reflective axicon 1525. This omitted center region precludes the apex of the reflective axicon 1520, and therefore the reflective axicon 1520 may form an annular beam with a substantially dark center.

In some cases, the beam 1505 may be the same as or similar to the beam 1205 of the diagram 1200. For example, the beam 1505 may be a Gaussian beam. In some cases the hollow core beam 1530 may be the same as or similar to the beam 1215 of diagram 1200.

In some cases, the polarization beam splitter 1510 may be a cube type or plate type beam splitter. Cube beam splitters may be constructed using two or more prisms having a hypotenuse, which may be right angle (90°) prisms. The two or more prisms may be joined at a joined surface, which may be the hypotenuse or another surface. The joined surface may be coated with a beam splitting coating to form a cube beam splitter. Plate beam splitters may be constructed with a thin optical plate having an opposed first and second surface, and having a beam splitting coating on said first surface. The second surface may be coated with an anti-reflective coating in some cases. In some cases, the polarizing beam splitters may be designed to split an incident light beam, for example 1505, to achieve a desired Reflection/Transmission (R/T) ratio, while preserving the polarization state of the incident light beam. In some cases, the polarizing beam splitters may be designed to split an incident light beam, for example 1505, to achieve a desired R/T ratio, while not preserving the polarization state of the incident light beam. In some cases, a polarizing beam splitter may have a specified extinction ratio of transmitted p-polarized light to s-polarized light (Tp/Ts). In some cases, a polarizing beam splitter may have a specified ratio of reflected p-polarized light to s-polarized light (Rp/Rs), which in some cases may be different than the (Tp/Ts) ratio.

In some cases, the polarizing beam splitter 1510 may be designed for use with a particular angle of incidence (AOI) of incoming light. In some cases, the angle of incidence may be about 0° to about 45° In some cases, the angle of incidence may be about 0° to about 0.5°, about 0° to about 1°, about 0° to about 5°, about 0° to about 10°, about 0° to about 15°, about 0° to about 20°, about 0° to about 25°, about 0° to about 30°, about 0° to about 35°, about 0° to about 40° about 0° to about 45°, about 0.5° to about 1°, about 0.5° to about 5°, about 0.5° to about 10° about 0.5° to about 15°, about 0.5° to about 20°, about 0.5° to about 25°, about 0.5° to about 30°, about 0.5° to about 35°, about 0.5° to about 40°, about 0.5° to about 45°, about 1° to about 5°, about 1° to about 10 about 1° to about 150, about 1° to about 20°, about 1° to about 25 0 about 1° to about 30°, about 1° to about 35°, about 1° to about 40 0 about 1° to about 45°, about 5° to about 10°, about 5° to about 15°, about 5° to about 20°, about 5° to about 25° about 5° to about 30°, about 5° to about 35°, about 5° to about 40°, about 5° to about 45 0 about 10° to about 15°, about 10° to about 20°, about 10° to about 25°, about 10° to about 30°, about 10° to about 35°, about 10° to about 40°, about 10° to about 45°, about 15° to about 20°, about 15° to about 25°, about 15° to about 30°, about 15° to about 35°, about 15° to about 40°, about 15° to about 45° about 20° to about 25° about 20° to about 30°, about 20° to about 35°, about 20° to about 40°, about 20° to about 45°, about 25° to about 30°, about 25° to about 35°, about 25° to about 40°, about 25° to about 45°, about 30° to about 35°, about 30° to about 40°, about 30° to about 45°, about 35° to about 40°, about 35° to about 45°, or about 40° to about 45° In some cases, the angle of incidence may be about 0°, about 0.5°, about 1°, about 5°, about 10°, about 15°, about 20°, about 25°, about 30°, about 35°, about 40°, or about 45°. In some cases, the angle of incidence may be at least about 0°, about 0.5°, about 1°, about 5°, about 10°, about 15°, about 20°, about 25°, about 30°, about 35°, or about 40°. In some cases, the angle of incidence may be at most about 0.5°, about 1°, about 5°, about 10°, about 15°, about 20°, about 25°, about 30°, about 35°, about 40°, or about 45°.

In some cases, the optical elements of the polarizing beam splitter 1510 may comprise one or more of: glass (e.g., fused silica, borosilicate, crown glass, etc.), crystal (e.g., sapphire, quartz, zinc selenide, etc.), plastic (e.g., optically clear plastics), silicon, germanium, diamond, etc. In some cases, the materials of the polarizing beam splitter 1510 may be selected to minimize light loss due to absorption and reflection.

A wave plate may be designed to transmit a beam of light and modify the polarization state without attenuating, deviating, or displacing the beam. In some cases, wave plates are made of birefringent materials, for example crystalline quarts. The birefringent material of a wave plate may possess slightly different indices of refraction for light polarized in different orientations, called a fast axis and a slow axis. Light polarized along the fast axis can experience a lower index of refraction, and travel faster through the wave plate than light polarized along the slow axis. The retardation of the wave plate describes the phase shift between the polarization component projected along the fast axis and the component projected along the slow axis. Retardation may be given in units of degrees, waves, or nanometers. As an example, one full wave of retardation is equivalent to 360°, or the number of nanometers at the specific wavelength, k, of interest. In some cases, the quarter wave plate 1515 of diagram 1500 may be a wave plate with a retardation of λ/4 or 90°. In some cases, the quarter wave plate may be a wave plate with retardation about 0° to about 360°. In some cases, the quarter wave plate may be a wave plate with retardation about 0° to about 1°, about 0° to about 10°, about 0° to about 45°, about 0° to about 90°, about 0° to about 180°, about 0° to about 270°, about 0° to about 360°, about 1° to about 10°, about 1° to about 45°, about 1° to about 90°, about 1° to about 180°, about 1° to about 270°, about 1° to about 360°, about 10° to about 45°, about 10° to about 90°, about 10° to about 180°, about 10° to about 270°, about 10° to about 360°, about 45° to about 90°, about 45° to about 180°, about 45° to about 270°, about 45° to about 360°, about 90° to about 180°, about 90° to about 270°, about 90° to about 360°, about 180° to about 270°, about 180° to about 360°, or about 270° to about 360°. In some cases, the quarter wave plate may be a wave plate with retardation about 0°, about 1°, about 10°, about 45°, about 90°, about 180°, about 270°, or about 360°. In some cases, the quarter wave plate may be a wave plate with retardation at least about 0°, about 1°, about 10°, about 45°, about 90°, about 180°, or about 270°. In some cases, the quarter wave plate may be a wave plate with retardation at most about 1°, about 10°, about 45°, about 90°, about 180°, about 270°, or about 360°. In practice, the specific retardation value for the quarter wave plate 1515 may be chosen to complement an overall optical arrangement for producing the results described herein, which can be appreciated by one of skill in the art.

In some cases, the refractive axicon 1525 may be the same as or similar to the refractive axicon 1225 of diagram 1200.

### Example Annular Beam Performance

As discussed above, in some cases, the systems, the methods, the computer-readable media, and the techniques disclosed herein may use a plurality of axicons (e.g., a pair of two axicons). In some cases, the plurality of axicons are configured to generate annular light beams. However, as discussed, only certain configurations of pairs of axicons may be configured to generate annular beams with a dark (e.g., having a high rate of extinction) center.

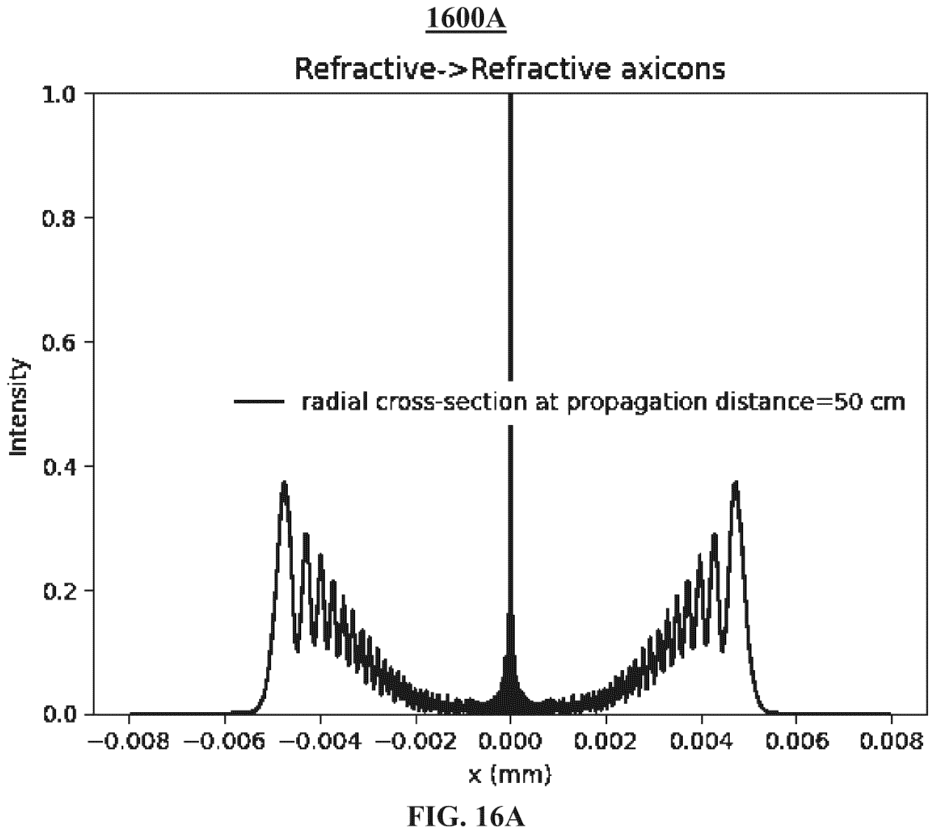

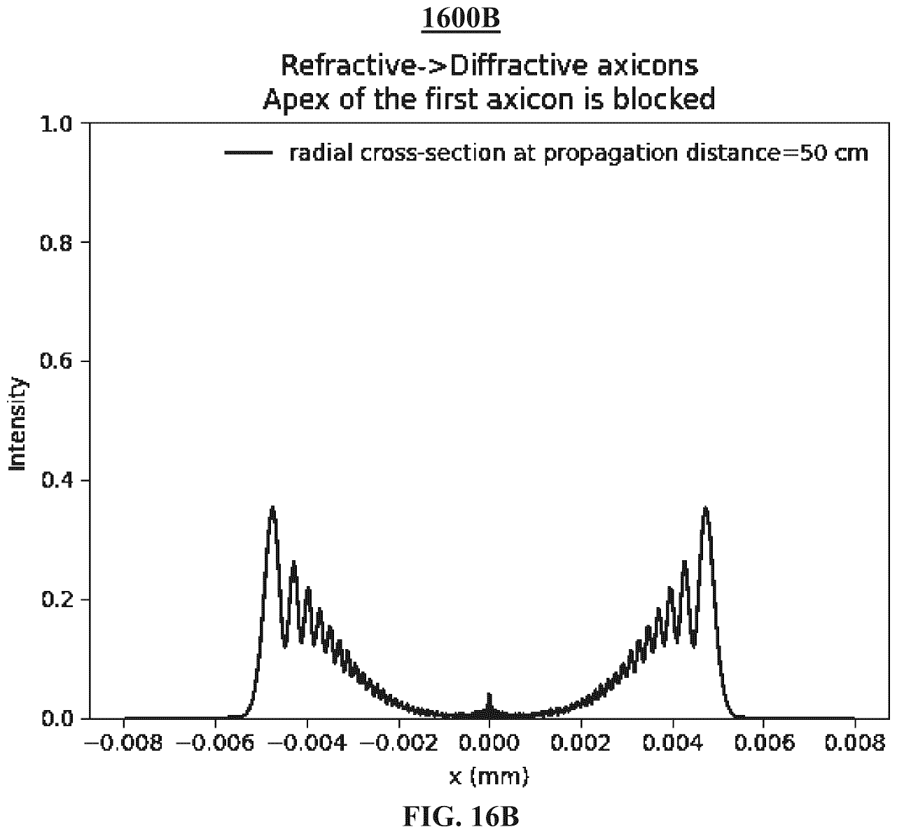

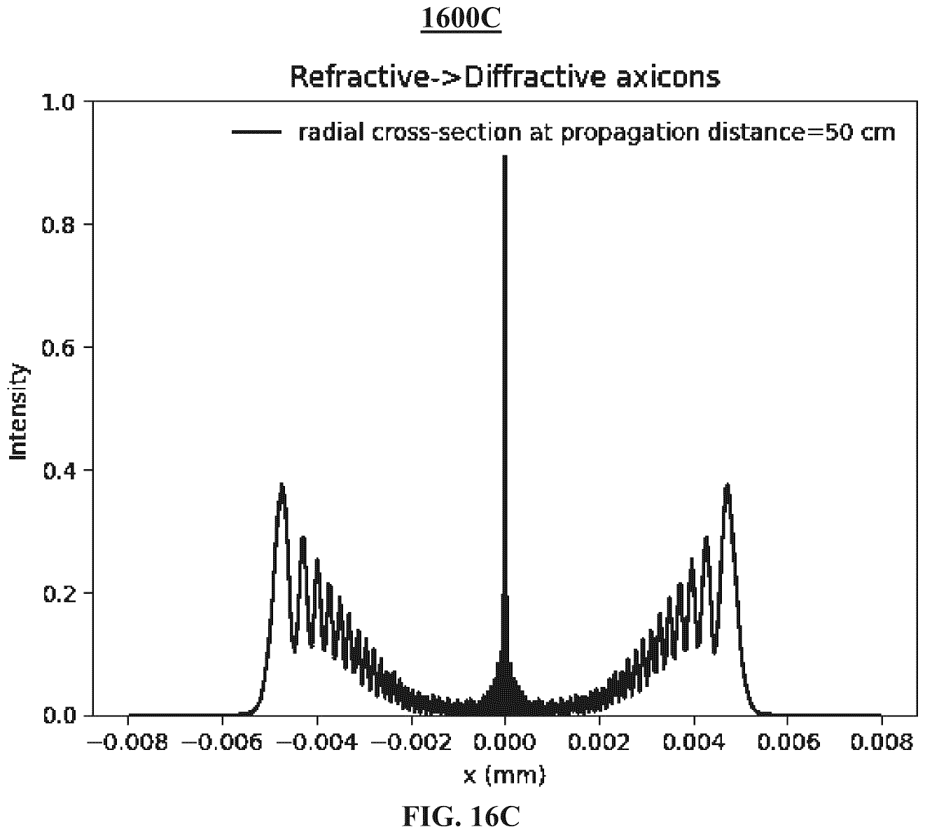

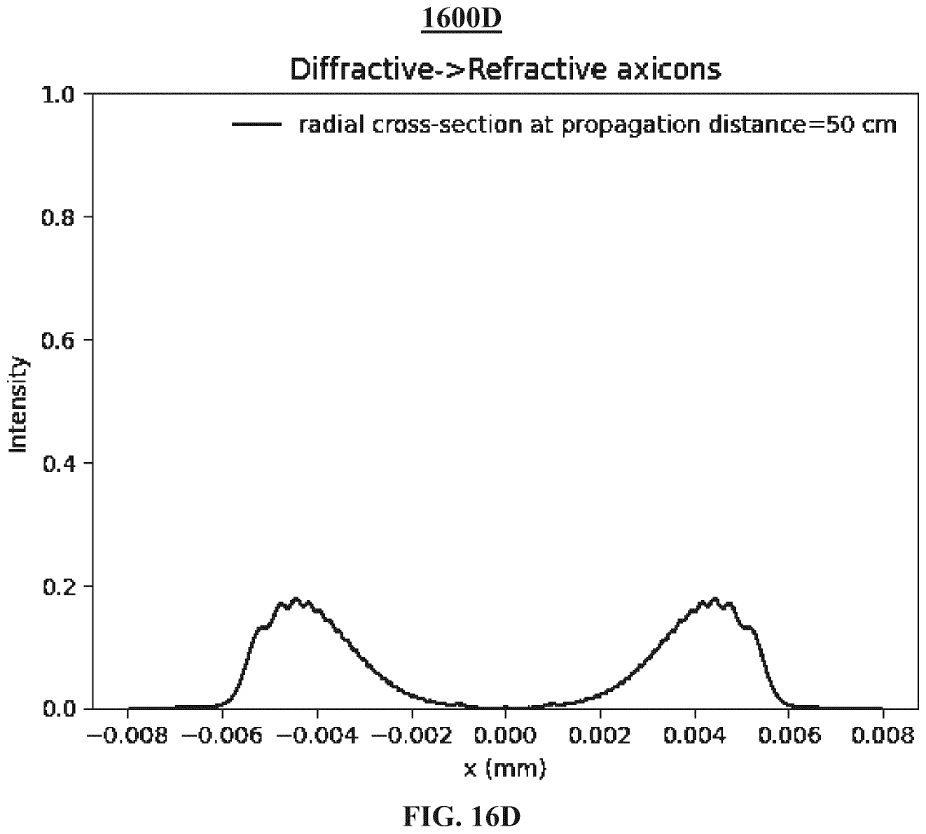

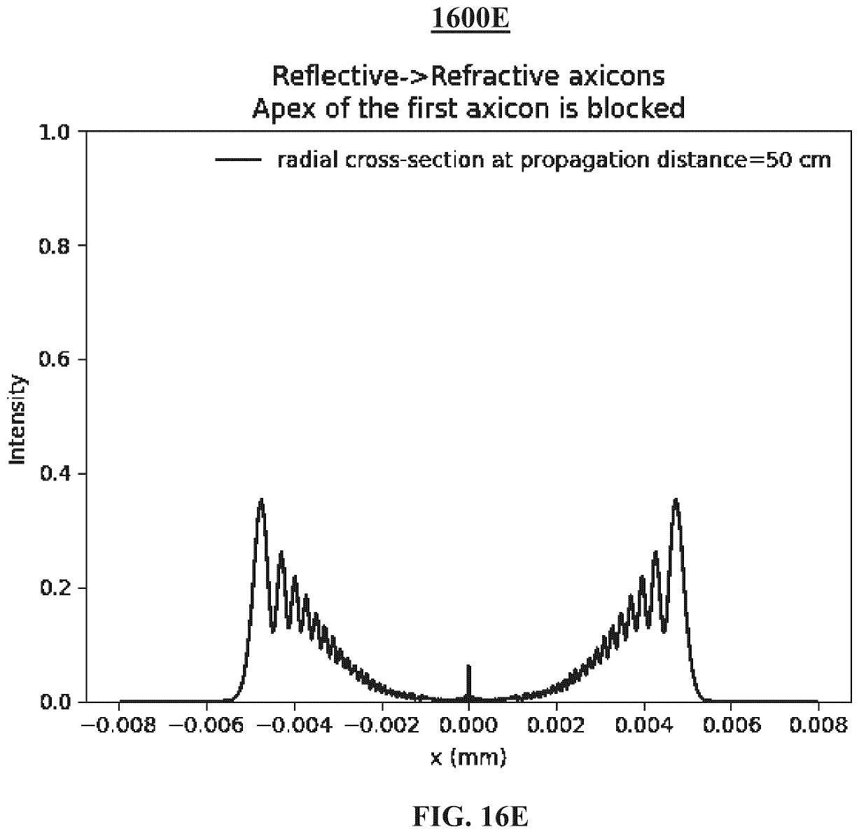

FIG. 16A shows an example numerical simulation 1600A of a refractive to refractive axicon pair. As disclosed herein, using a pair of refractive axicons may cause the apex effect, given the practical limitations of creating an infinitesimally small, pointed apex. As shown in the simulation 1600A, using a pair of refractive axicons produces an annular beam having a contaminated center (with a center peak of high intensity). Further, the simulation 1600A shows how the pair of refractive axicons produce substantial side ripples due to the apex of the refractive axicons. The results of the simulation 1600A may be substantially consistent with the ripples and center peak of FIG. 11A.

FIG. 16B shows an example numerical simulation 1600B of a refractive to diffractive axicon pair, with the apex of the refractive axicon blocked. As disclosed herein, when using a diffractive axicon and a refractive axicon, the diffractive axicon should be positioned in front of the refractive axicon to help reduce (e.g., eliminate) the apex effect. However, as shown in the simulation 1600B, using a refractive axicon in front of a diffractive axicon produces an annular beam having a contaminated center (with a center peak), even with the apex of the refractive axicon blocked. The simulation 1600B was modeled using an apex block about fifty times the size of the apex radius. While the center peak in the simulation 1600B is not as intense as the center peak of the simulation 1600C (where the apex of the refractive axicon is not blocked), the center peak of the simulation 1600B still deprives the annular beam from having a dark center. Further, the simulation 1600B shows how even with the apex of the refractive axicon blocked, the refractive to diffractive axicon pair nonetheless produces substantial side ripples.

FIG. 16C shows another example numerical simulation 1600C of a refractive to diffractive axicon pair. Similar to the simulation 1600B, in the simulation 1600C using a refractive axicon in front of a diffractive axicon produces an annular beam having a contaminated center (with a center peak of high intensity). Without the apex of the refractive axicon blocked, the center peak of the simulation 1600C is at an even higher intensity than the simulation 1600B. Further, the simulation 1600C shows how the refractive to diffractive axicon pair produces substantial side ripples.

FIG. 16D shows an example numerical simulation 1600D of a diffractive to refractive axicon pair. As disclosed herein, when using a diffractive axicon and a refractive axicon, the diffractive axicon should be positioned in front of the refractive axicon to help reduce (e.g., eliminate) the apex effect. As shown in the simulation 1600D, using a diffractive axicon in front of a refractive axicon produces an annular beam having a substantially dark center. Further, the simulation 1600D shows how the diffractive to refractive axicon pair produces minimal side ripples. The results of the simulation 1600D may be substantially consistent with the lack of ripples and lack of center peak of FIG. 11B.

FIG. 16E shows an example numerical simulation 1600E of a reflective to refractive axicon pair. Similar to the simulations 1600B and 1600C, in the simulation 1600E using a refractive axicon in front of a reflective axicon produces an annular beam having a contaminated center (with a center peak of high intensity). With the apex of the refractive axicon blocked by the center hole of the reflective axicon, the center peak of simulation 1600E is more similar to the peak of simulation 1600B, and deprives the annular beam from having a dark center. Also similar to simulation 1600B, even with the apex of the refractive axicon blocked, the reflective to refractive axicon pair nonetheless produces substantial side ripples.

### Examples of Methods for Transforming a Light Beam

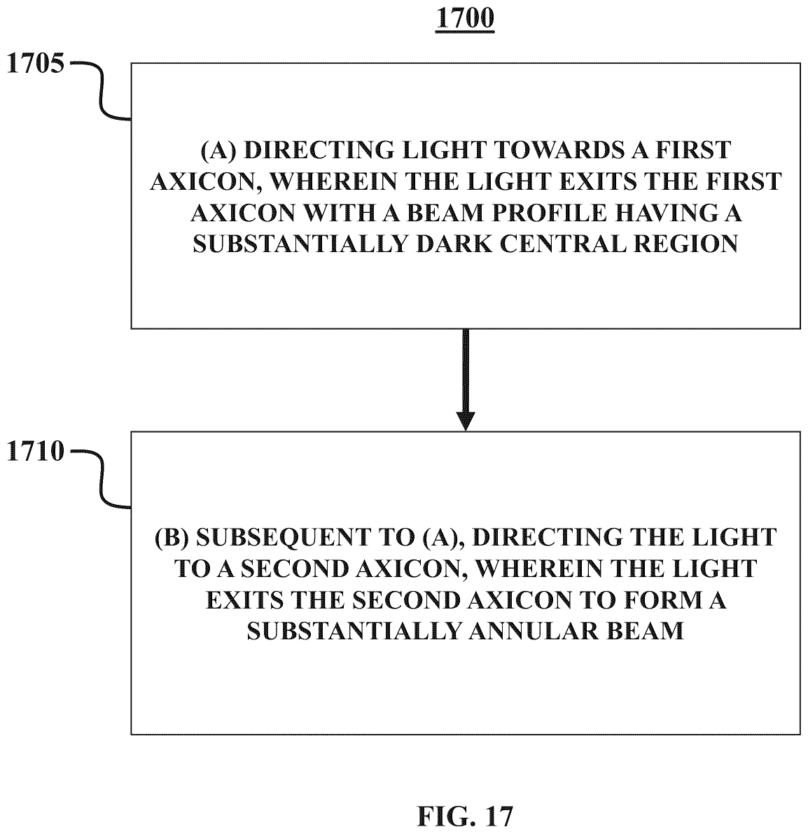

FIG. 17 shows an example method 1700 for transforming a light beam. In some cases, this method may comprise. (a) directing light towards a first axicon, wherein the light exits the first axicon with a beam profile having a substantially dark central region (block 1705); and (b) subsequent to (a), directing the light to a second axicon, wherein the light exits the second axicon to form a substantially annular beam (block 1710).

At block 1705, the first axicon may comprise a refractive axicon, diffractive axicon, reflective axicon, transmissive axicon (e.g., with a non-transmitting portion substantially centered in the reflective axicon), axicon-lens combinations (lensacons), meta-axicons, 2D photonic crystal (on-chip axicon), hollow core axicon, etc. In some cases, the first axicon is a transmissive, diffractive axicon. In some cases, the first axicon is a reflective axicon. In some cases, the reflective axicon is a reflective, diffractive axicon. In some cases, the reflective axicon comprises a non-transmitting portion substantially centered in the reflective axicon. In some cases, the light with a beam profile having a substantially dark central region comprises an extinction ratio from the substantially dark central region to a light region of the light is about 1 to 100.

At block 1710, the second axicon may comprise a refractive axicon, diffractive axicon, reflective axicon, transmissive axicon (e.g., with a non-transmitting portion substantially centered in the reflective axicon), axicon-lens combinations (lensacons), meta-axicons, 2D photonic crystal (on-chip axicon), hollow core axicon, etc. In some cases, the second axicon comprises a refractive axicon. In some cases, the second axicon comprises a diffractive axicon. In some cases, the second axicon comprises a reflective axicon. In some cases, the first axicon and the second axicon are aligned substantially normal to an optical axis. In some cases, the substantially annular beam is substantially collimated. In some cases, the substantially annular beam comprises a divergence with a half angle of less than about 5 degrees. In some cases, the divergence is less than about 1.5 degrees. In some cases, the substantially annular beam comprises a substantially dark central region. In some cases, an extinction ratio from the substantially dark central region of the substantially annular beam to a light region of the substantially annular beam is about 1 to 100. In some cases, the substantially annular beam comprises a transmission through the first axicon and the second axicon of at least about 80%. In some cases, the transmission is at least about 95%.

In some cases, the method 1700 may further comprise: combining the substantially annular beam and a second light with a beam combiner. In some cases, the method 1700 may further comprise: directing the substantially annular beam and the second light toward a plurality of spatially distinct optical traps; and cooling a plurality of atoms within the plurality of spatially distinct optical trap with the substantially annular beam and the second light. In some cases, one or more operations of the method 1700 of FIG. 17 may be performed in any order. Further, at least one of the one or more operations disclosed above with respect to the method 1700 may be repeated, e.g., iteratively.

### Example of Systems for Performing a Non-Classical Computation

FIG. 2 shows an example of a system 200 for performing a non-classical computation. The non-classical computation may comprise a quantum computation. The quantum computation may comprise a gate-model quantum computation.

The system 200 may comprise one or more trapping units 210. The trapping units may comprise one or more optical trapping units. The optical trapping units may comprise any optical trapping unit described herein, such as an optical trapping unit described herein with respect to FIG. 3A. The optical trapping units may be configured to generate a plurality of optical trapping sites. The optical trapping units may be configured to generate a plurality of spatially distinct optical trapping sites. For instance, the optical trapping units may be configured to generate at least about 10, 20, 30, 40, 50, 60, 70, 80, 90, 100, 200, 300, 400, 500, 600, 700, 800, 900, 1,000, 2,000, 3,000, 4,000, 5,000, 6,000, 7,000, 8,000, 9,000, 10,000, 20,000, 30,000, 40,(X)0, 50,0(X), 60,000, 70,000, 80,000, 90,000, 100,0(x), 200,000, 300,000, 400,000, 500,000, 600,000, 7(x),000, 800,000, 900,000, 1,000,000, or more optical trapping sites. The optical trapping units may be configured to generate at most about 1,000,0(X), 900,0(X), 800,000, 700,000, 600,000, 500,000, 400,000, 300,000, 200,000, 100,000, 90.000, 80,000, 70,000, 60,000, 50,000, 40,000, 30,000, 20,000, 10,000, 9.000, 8,000, 7,000, 6,000, 5,000, 4,000, 3.000, 2,000, 1,000, 900, 800, 700, 600, 500, 400, 300, 200, 100, 90, 80, 70, 60, 50, 40, 30, 20, 10, or fewer optical trapping sites. The optical trapping units may be configured to trap a number of optical trapping sites that is within a range defined by any two of the preceding values.

The optical trapping units may be configured to trap a plurality of atoms. For instance, the optical trapping units may be configured to trap at least about 10, 20, 30, 40, 50, 60, 70, 80, 90, 100, 200, 300, 400, 500, 600, 700, 800, 900, 1,0(X), 2,000, 3.000, 4,000, 5,000, 6,000, 7,0(X), 8,000, 9,000, 10.000, 20,000, 30,000, 40,000, 50,000, 60,000, 70,000, 80,000, 90.000, 100.000, 200,000, 300,000, 400,000, 500,000, 600.000, 700,000, 800,000, 900,000, 1,000,000, or more atoms. The optical trapping units may be configured to trap at most about 1,000,000, 900,000, 800,000, 700,000, 600,000, 500,000, 400,000, 300,000, 200,000, 100,000, 90,0(X), 80,000, 70,000, 60,000, 50,000, 40,000, 30,000, 20,000, 10.000, 9.000, 8,000, 7,000, 6,000, 5,000, 4,000, 3,000, 2,0(x), 1,000, 900, 800, 700, 600, 500, 400, 300, 200, 100, 90, 80, 70, 60, 50, 40, 30, 20, 10, or fewer atoms. The optical trapping units may be configured to trap a number of atoms that is within a range defined by any two of the preceding values.

Each optical trapping site of the optical trapping units may be configured to trap at least about 1, 2, 3, 4, 5, 6, 7, 8, 9, 10, or more atoms. Each optical trapping site may be configured to trap at most about 10, 9, 8, 7, 6, 5, 4, 3, 2, 1, or fewer atoms. Each optical trapping site may be configured to trap a number of atoms that is within a range defined by any two of the preceding values. Each optical trapping site may be configured to trap a single atom.

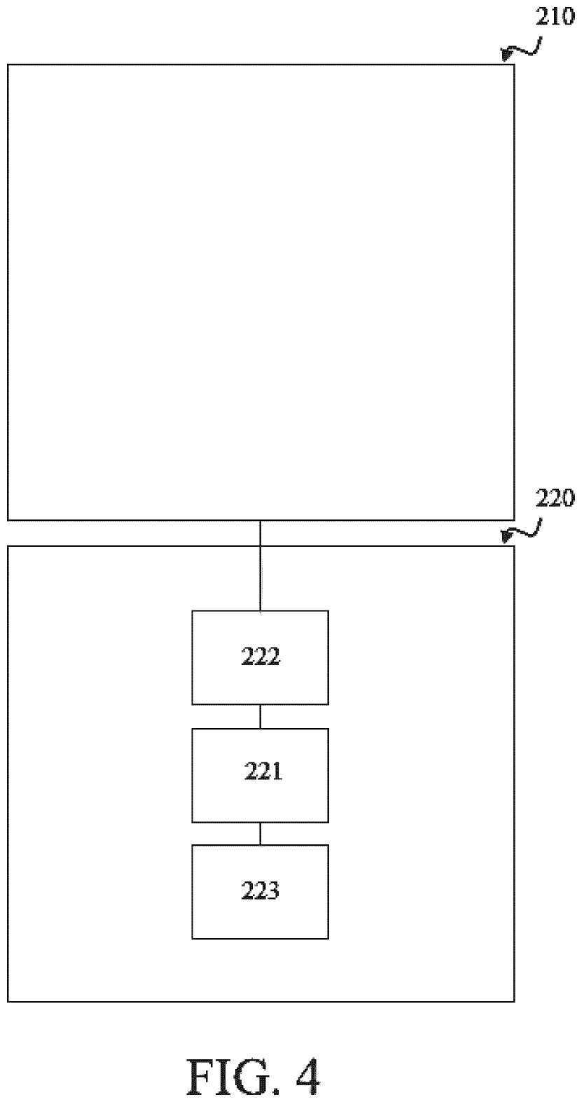

One or more atoms of the plurality of atoms may comprise qubits, as described herein (for instance, with respect to FIG. 4). Two or more atoms may be quantum mechanically entangled. Two or more atoms may be quantum mechanically entangled with a coherence lifetime of at least about 1 microsecond (μs). 2 μs. 3 μs, 4 μs, 5 μs, 6 μs, 7 μs, 8 μs, 9 μs, 10 μs, 20 μs, 30 μs, 40 μs, 50 μs, 60 μs, 70 μs, 80 μs, 90 μs, 100 μs, 200 μs, 300 μs, 400 μs, 500 μs, 600 μs, 700 μs, 800 μs, 900 μs, 1 millisecond (ms), 2 ms, 3 ms, 4 ms. 5 ms, 6 ms, 7 ms, 8 ms, 9 ms, 10 ms, 20 ms, 30 ms, 40 ms, 50 ms, 60 ms. 70 ms, 80 ms, 90 ms, 100 ms, 200 ms, 300 ms, 400 ms, 500 ms, 600 ms, 700 ms, 800 ms, 900 ms, 1 second (s), 2 s, 3 s, 4 s, 5 s, 6 s, 7 s, 8 s, 9 s, 10 s, or more. Two or more atoms may be quantum mechanically entangled with a coherence lifetime of at most about 10 s, 9 s, 8 s, 7 s, 6 s, 5 s, 4 s, 3 s, 2 s, 1 s, 900 ms, 800 ms, 700 ms, 600 ms, 500 ms, 400 ms. 300 ms, 200 ms, 100 ms, 90 ms, 80 ms, 70 ms, 60 ms, 50 ms, 40 ms, 30 ms, 20 ms, 10 ms, 9 ms, 8 ms. 7 ms, 6 ms, 5 ms, 4 ms, 3 ms, 2 ms, 1 ms, 900 μs, 800 μs, 700 μs, 600 μs, 500 μs, 400 μs, 300 μs, 200 μs, 100 μs, 90 μs, 80 μs, 70 μs, 60 μs. 50 μs. 40 μs. 30 μs, 20 μs, 10 μs, 9 μs, 8 μs, 7 μs, 6 μs, 5 μs, 4 μs, 3 μs, 2 μs, 1 μs, or less. Two or more atoms may be quantum mechanically entangled with a coherence lifetime that is within a range defined by any two of the preceding values. One or more atoms may comprise neutral atoms. One or more atoms may comprise uncharged atoms.

One or more atoms may comprise alkali atoms. One or more atoms may comprise lithium (Li) atoms, sodium (Na) atoms, potassium (K) atoms, rubidium (Rb) atoms, or cesium (Cs) atoms. One or more atoms may comprise lithium-6 atoms, lithium-7 atoms, sodium-23 atoms, potassium-39 atoms, potassium-40 atoms, potassium-41 atoms, rubidium-85 atoms, rubidium-87 atoms, or caesium-133 atoms. One or more atoms may comprise alkaline earth atoms. One or more atoms may comprise beryllium (Be) atoms, magnesium (Mg) atoms, calcium (Ca) atoms, strontium (Sr) atoms, or barium (Ba) atoms. One or more atoms may comprise beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, or barium-138 atoms. One or more atoms may comprise rare earth atoms. One or more atoms may comprise scandium (Sc) atoms, yttrium (Y) atoms, lanthanum (La) atoms, cerium (Ce) atoms, praseodymium (Pr) atoms, neodymium (Nd) atoms, samarium (Sm) atoms, europium (Eu) atoms, gadolinium (Gd) atoms, terbium (Tb) atoms, dysprosium (Dy) atoms, holmium (Ho) atoms, erbium (Er) atoms, thulium (Tm) atoms, ytterbium (Yb) atoms, or lutetium (Lu) atoms. One or more atoms may comprise scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms.

The plurality of atoms may comprise a single element selected from the group consisting of Li, Na, K, Rb, Cs, Be, Mg, Ca. Sr. and Ba. The plurality of atoms may comprise a mixture of elements selected from the group consisting of Li, Na, K, Rb, Cs, Be, Mg, Ca, Sr, and Ba. The plurality of atoms may comprise a natural isotopic mixture of one or more elements selected from the group consisting of Li, Na, K, Rb, Cs, Be, Mg, Ca, Sr, and Ba. The plurality of atoms may comprise an isotopically enriched mixture of one or more elements selected from the group consisting of Li, Na, K, Rb, Cs, Be, Mg, Ca, Sr, and Ba. The plurality of atoms may comprise a natural isotopic mixture of one or more elements selected from the group consisting of Sc, Y, La, Ce, Pr. Nd, Sm. Eu, Gd, Tb. Dy, Ho, Er, Tm, Yb. and Lu. The plurality of atoms may comprise an isotopically enriched mixture of one or more elements selected from the group consisting of Sc, Y. La, Ce, Pr, Nd, Sm, Eu, Gd, Tb, Dv, Ho, Er, Tm, Yb, and Lu, atoms may comprise rare earth atoms. For instance, the plurality of atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodvmium-146 atoms, neodymium-148 atoms, samanum-144 atoms, samarium-149 atoms, samarium-150 atoms, samarium-152 atoms, samanum-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, vtterbium-168 atoms, vtterbium-170 atoms, vtterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance of at least about 50⁰%, 60%, 70%, 80%, 9×0%, 91%, 92%, 93%, 94%, 95%, 96%, 97%, 98%, 99%. 99.1%, 99.2%, 99.3%, 99.4%. 99.5%, 99.6%, 99.7%, 99.8%, 99.9%, 99.91%, 99.92%, 99.93%, 99.94%, 99.95%. 99.96%, 99.97%, 99.98%, 99.99%, or more. The plurality of atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance of at most about 99.99%, 99.98%, 99.97%, 99.96%, 99.95%, 99.94%, 99.93%, 99.92%. 99.91%. 99.9%, 99.8%, 99.7%, 99.6%, 99.5%, 99.4%, 99.3%, 99.2%. 99.1%, 99%, 98%, 97%, 96%, 95%, 94%, 93%, 92%, 91%, 90%, 80%, 70%, 60%, 50%, or less. The plurality of atoms may comprise lithium-6 atoms, lithium-7 atoms, sodium-23 atoms, potassium-39 atoms, potassium-40 atoms, potassium-41 atoms, rubidium-85 atoms, rubidium-87 atoms, caesium-133 atoms, beryllium-9 atoms, magnesium-24 atoms, magnesium-25 atoms, magnesium-26 atoms, calcium-40 atoms, calcium-42 atoms, calcium-43 atoms, calcium-44 atoms, calcium-46 atoms, calcium-48 atoms, strontium-84 atoms, strontium-86 atoms, strontium-87 atoms, strontium-88 atoms, barium-130 atoms, barium-132 atoms, barium-133 atoms, barium-134 atoms, barium-135 atoms, barium-136 atoms, barium-137 atoms, barium-138 atoms, scandium-45 atoms, yttrium-89 atoms, lanthanum-139 atoms, cerium-136 atoms, cerium-138 atoms, cerium-140 atoms, cerium-142 atoms, praseodymium-141 atoms, neodymium-142 atoms, neodymium-143 atoms, neodymium-145 atoms, neodymium-146 atoms, neodymium-148 atoms, samarium-144 atoms, samarium-149 atoms, samarium-150 atoms, samarium-152 atoms, samarium-154 atoms, europium-151 atoms, europium-153 atoms, gadolinium-154 atoms, gadolinium-155 atoms, gadolinium-156 atoms, gadolinium-157 atoms, gadolinium-158 atoms, gadolinium-160 atoms, terbium-159 atoms, dysprosium-156 atoms, dysprosium-158 atoms, dysprosium-160 atoms, dysprosium-161 atoms, dysprosium-162 atoms, dysprosium-163 atoms, dysprosium-164 atoms, erbium-162 atoms, erbium-164 atoms, erbium-166 atoms, erbium-167 atoms, erbium-168 atoms, erbium-170 atoms, holmium-165 atoms, thulium-169 atoms, ytterbium-168 atoms, ytterbium-170 atoms, ytterbium-171 atoms, ytterbium-172 atoms, ytterbium-173 atoms, ytterbium-174 atoms, ytterbium-176 atoms, lutetium-175 atoms, or lutetium-176 atoms enriched to an isotopic abundance that is within a range defined by any two of the preceding values.

The system 200 may comprise one or more first electromagnetic delivery units 220. The first electromagnetic delivery units may comprise any electromagnetic delivery unit described herein, such as an electromagnetic delivery unit described herein with respect to FIG. 4. The first electromagnetic delivery units may be configured to apply first electromagnetic energy to one or more atoms of the plurality of atoms. Applying the first electromagnetic energy may induce the atoms to adopt one or more superposition states of a first atomic state and a second atomic state that is different from the first atomic state.

The first atomic state may comprise a first single-qubit state. The second atomic state may comprise a second single-qubit state. The first atomic state or second atomic state may be elevated in energy with respect to a ground atomic state of the atoms. The first atomic state or second atomic state may be equal in energy with respect to the ground atomic state of the atoms.

The first atomic state may comprise a first hyperfine electronic state and the second atomic state may comprise a second hyperfine electronic state that is different from the first hyperfine electronic state. For instance, the first and second atomic states may comprise first and second hyperfine states on a multiplet manifold, such as a triplet manifold. The first and second atomic states may comprise first and second hyperfine states, respectively, on a ³P¹ or ³P₂ manifold. The first and second atomic states may comprise first and second hyperfine states, respectively, on a ³P₁ or ³P₂ manifold of any atom described herein, such as a strontium-87 ³P₁ manifold or a strontium-87 ³P₂ manifold.

In some cases, the first and second atomic states are first and second hyperfine states of a first electronic state. Optical excitation may be applied between a first electronic state and a second electronic state. The optical excitation may excite the first hyperfine state and/or the second hyperfine state to the second electronic state. A single-qubit transition may comprise a two-photon transition between two hyperfine states within the first electronic state using a second electronic state as an intermediate state. To drive a single-qubit transition, a pair of frequencies, each detuned from a single-photon transition to the intermediate state, may be applied to drive a two-photon transition. In some cases, the first and second hyperfine states are hyperfine states of the ground electronic state. The ground electronic state may not decay by spontaneous or stimulated emission to a lower electronic state. The hyperfine states may comprise nuclear spin states.

In some cases, the hyperfine states comprise nuclear spin states of a strontium-87 ¹S₀ manifold and the qubit transition drives one or both of two nuclear spin states of strontium-87 ¹S₀ to a state detuned from or within the ³P₂ or ³P₁ manifold. In some cases, the one-qubit transition is a two photon Raman transition between nuclear spin states of strontium-87 ¹S₀ via a state detuned from or within the ³P₂ or ¹P₁ manifold. In some cases, the nuclear spin states may be Stark shifted nuclear spin states. A Stark shift may be driven optically. An optical Stark shift may be driven off resonance with any, all, or a combination of a single-qubit transition, a two-qubit transition, a shelving transition, an imaging transition, etc.

In some cases, the hyperfine states comprise nuclear spin states of a ytterbium

The first atomic state may comprise a first nuclear spin state and the second atomic state may comprise a second nuclear spin state that is different from the first nuclear spin state. The first and second atomic states may comprise first and second nuclear spin states, respectively, of a quadrupolar nucleus. The first and second atomic states may comprise first and second nuclear spin states, respectively, of a spin-1, spin-3/2, spin-2, spin-5/2, spin-3, spin-7/2, spin-4, or spin-9/2 nucleus. The first and second atomic states may comprise first and second nuclear spin states, respectively, of any atom described herein, such as first and second spin states of strontium-87.

For first and second nuclear spin states associated with a nucleus comprising a spin greater than 1/2 (such as a spin-1, spin-3/2, spin-2, spin-5/2, spin-3, spin-7/2, spin-4, or spin-9/2 nucleus), transitions between the first and second nuclear spin states may be accompanied by transitions between other spin states on the nuclear spin manifold. For instance, for a spin-9/2 nucleus in the presence of a uniform magnetic field, all of the nuclear spin levels may be separated by equal energy. Thus, a transition (such as a Raman transition) designed to transfer atoms from, for instance, an m_{N}=9/2 spin state to an m_{N}=7/2 spin state, may also drive M_{N}=7/2 to m_{N}=5/2, m_{N}=5/2 to m_{N}=3/2, m_{N}=3/2 to m_{N}=1/2, m_{N}=1/2 to m_{N}=−1/2, m_{N}=−1/2 to m_{N}=−3/2, M_{N}=−3/2 to m_{N}=−5/2, m_{N}=−5/2 to m_{N}=−7/2, and m_{N}=−7/2 to m_{N}=−9/2, where m_{N} is the nuclear spin state. Similarly, a transition (such as a Raman transition) designed to transfer atoms from, for instance, an m_{N}=9/2 spin state to an m_{N}=5/2 spin state, may also drive m_{N}=7/2 to m_{N}=3/2, m_{N}=5/2 to m_{N}=1/2, m_{N}=3/2 to m_{N}=−1/2, m_{N}=1/2 to m_{N}=−3/2, m_{N}=−1/2 to m_{N}=−5/2, m_{N}=−3/2 to m_{N}=−7/2, and m_{N}=−5/2 to m_{N}=−9/2. Such a transition may thus not be selective for inducing transitions between particular spin states on the nuclear spin manifold.

It may be desirable to instead implement selective transitions between particular first and second spins states on the nuclear spin manifold. This may be accomplished by providing light from a light source that provides an AC Stark shift and pushes neighboring nuclear spin states out of resonance with a transition between the desired transition between the first and second nuclear spin states. For instance, if a transition from first and second nuclear spin states having m_{N}=−9/2 and m_{N}=−7/2 is desired, the light may provide an AC Stark shift to the m_{N}=−5/2 spin state, thereby greatly reducing transitions between the m_{N}=−7/2 and m_{N}=−5/2 states. Similarly, if a transition from first and second nuclear spin states having m_{N}=−9/2 and m_{N}=−5/2 is desired, the light may provide an AC Stark shift to the m_{N}=−1/2 spin state, thereby greatly reducing transitions between the m_{N}=−5/2 and m_{N}=−1/2 states. This may effectively create a two-level subsystem within the nuclear spin manifold that is decoupled from the remainder of the nuclear spin manifold, greatly simplifying the dynamics of the qubit systems. It may be advantageous to use nuclear spin states near the edge of the nuclear spin manifold (e.g., my=−9/2 and m_{N}=−7/2, m_{N}=7/2 and m_{N}=9/2, m_{N}=−9/2 and m_{N}=−5/2, or m_{N}=5/2 and m_{N}=9/2 for a spin-9/2 nucleus) such that only one AC Stark shift is required. Alternatively, nuclear spin states farther from the edge of the nuclear spin manifold (e.g., my=−5/2 and m_{N}=−3/2 or m_{N}=−5/2 and my=−1/2) may be used and two AC Stark shifts may be implemented (e.g., at m_{N}=−7/2 and m_{N}=−1/2 or m_{N}=−9/2 and m;N=3/2).

Stark shifting of the nuclear spin manifold may shift neighboring nuclear spin states out of resonance with the desired transition between the first and second nuclear spin states and a second electronic state or a state detuned therefrom. Stark shifting may decrease leakage from the first and second nuclear spin state to other states in the nuclear spin manifold. Starks shifts may be achievable up to 100s of kHz for less than 10 mW beam powers. Upper state frequency selectivity may decrease scattering from imperfect polarization control. Separation of different angular momentum states in the ³P₁ manifold may be many gigahertz from the single and two-qubit gate light. Leakage to other states in the nuclear spin manifold may lead to decoherence. The Rabi frequency for two-qubit transitions (e.g., how quickly the transition can be driven) may be faster than the decoherence rate. Scattering from the intermediate state in the two-qubit transition may be a source of decoherence. Detuning from the intermediate state may improve fidelity of two-qubit transitions.

Qubits based on nuclear spin states in the electronic ground state may allow exploitation of long-lived metastable excited electronic states (such as a ³P₀ state in strontium-87) for qubit storage. Atoms may be selectively transferred into such a state to reduce cross-talk or to improve gate or detection fidelity. Such a storage or shelving process may be atom-selective using the SLMs or AODs described herein. A shelving transition may comprise a transition between the ¹S₀ state in strontium-87 to the ³P₀ or ³P₂ state in strontium-87.

The clock transition (also a “shelving transition” or a “storage transition” herein) may be qubit-state selective. The upper state of the clock transition may have a very long natural lifetime, e.g., greater than 1 second. The linewidth of the clock transition may be much narrower than the qubit energy spacing. This may allow direct spectral resolution. Population may be transferred from one of the qubit states into the clock state. This may allow individual qubit states to be read out separately, by first transferring population from one qubit state into the clock state, performing imaging on the qubits, then transferring the population back into the ground state from the clock state and imaging again. In some cases, a magic wavelength transition is used to drive the clock transition.

The clock light for shelving can be atom-selective or not atom-selective. In some cases, the clock transition is globally applied (e.g., not atom selective). A globally applied clock transition may include directing the light without passing through a microscope objective or structuring the light. In some cases, the clock transition is atom-selective. Clock transition which are atom-selective may potentially allow us to improve gate fidelities by minimizing cross-talk. For example, to reduce cross talk in an atom, the atom may be shelved in the clock state where it may not be affected by the light. This may reduce cross-talk between neighboring qubits undergoing transitions. To implement atom-selective clock transitions, the light may pass through one or more microscope objectives and/or may be structured on one or more of a spatial light modulator, digital micromirror device, crossed acousto-optic deflectors, etc.

The system 200 may comprise one or more readout units 230. The readout units may comprise one or more readout optical units. The readout optical units may be configured to perform one or more measurements of the one or more superposition states to obtain the non-classical computation. The readout optical units may comprise one or more optical detectors. The detectors may comprise one or more photomultiplier tubes (PMTs), photodiodes, avalanche diodes, single-photon avalanche diodes, single-photon avalanche diode arrays, phototransistors, reverse-biased light emitting diodes (LEDs), charge coupled devices (CCDs), or complementary metal oxide semiconductor (CMOS) cameras. The optical detectors may comprise one or more fluorescence detectors. The readout optical unit may comprise one or more objectives, such as one or more objective having a numerical aperture (NA) of at least about 0.1, 0.15, 0.2, 0.25, 0.3, 0.35, 0.4, 0.45, 0.5, 0.55, 0.6, 0.65, 0.7, 0.75, 0.8, 0.85, 0.9, 0.95, 1, or more. The objective may have an NA of at most about 1, 0.95, 0.9, 0.85, 0.8, 0.75, 0.7, 0.65, 0.6, 0.55, 0.5, 0.45, 0.4, 0.35, 0.3, 0.25, 0.2, 0.15, 0.1, or less. The objective may have an NA that is within a range defined by any two of the preceding values.

The one or more readout optical units 230 may make measurements, such as projective measurements, by applying light resonant with an imaging transition. The imaging transition may cause fluorescence. An imaging transition may comprise a transition between the ¹S₀ state in strontium-87 to the ¹P₁ state in strontium-87. The ¹P₁ state in strontium-87 may fluoresce. The lower state of the qubit transition may comprise two nuclear spin states in the 'S₀ manifold. The one or more states may be resonant with the imaging transition. A measurement may comprise two excitations. In a first excitation, one of the two lower states may be excited to the shelving state (e.g., ³P₀ state in strontium-87). In a second excitation, the imaging transition may be excited. The first transition may reduce cross-talk between neighboring atoms during computation. Fluorescence generated from the imaging transition may be collected on one or more readout optical units 230.

The imaging units may be used to determine if one or more atoms were lost from the trap. The imaging units may be used to observe the arrangement of atoms in the trap.

The system 200 may comprise one or more vacuum units 240. The one or more vacuum units may comprise one or more vacuum pumps. The vacuum units may comprise one or more roughing vacuum pumps, such as one or more rotary pumps, rotary vane pumps, rotary piston pumps, diaphragm pumps, piston pumps, reciprocating piston pumps, scroll pumps, or screw pumps. The one or more roughing vacuum pumps may comprise one or more wet (for instance, oil-sealed) or dry roughing vacuum pumps. The vacuum units may comprise one or more high-vacuum pumps, such as one or more cryosorption pumps, diffusion pumps, turbomolecular pumps, molecular drag pumps, turbo-drag hybrid pumps, cryogenic pumps, ions pumps, or getter pumps.

The vacuum units may comprise any combination of vacuum pumps described herein. For instance, the vacuum units may comprise one or more roughing pumps (such as a scroll pump) configured to provide a first stage of rough vacuum pumping. The roughing vacuum pumps may be configured to pump gases out of the system 200 to achieve a low vacuum pressure condition. For instance, the roughing pumps may be configured to pump gases out of the system 200 to achieve a low vacuum pressure of at most about 10³ Pascals (Pa). The vacuum units may further comprise one or more high-vacuum pumps (such as one or more ion pumps, getter pumps, or both) configured to provide a second stage of high vacuum pumping or ultra-high vacuum pumping. The high-vacuum pumps may be configured to pump gases out of the system 200 to achieve a high vacuum pressure of at most about 10⁻³ Pa or an ultra-high vacuum pressure of at most about 10⁻⁶ Pa once the system 200 has reached the low vacuum pressure condition provided by the one or more roughing pumps.

The vacuum units may be configured to maintain the system 200 at a pressure of at most about 10-Pa, 9×10⁻⁷ Pa. 8×10⁻⁷ Pa, 7×10⁻⁷ Pa, 6×10⁻⁷ Pa, 5×10⁻⁷ Pa, 4×10⁻⁷ Pa, 3×10⁻⁷ Pa, 2×10⁻⁷ Pa, 10⁻⁷ Pa, 9×10⁻⁸ Pa, 8×10⁻⁸ Pa. 7×10⁻⁸ Pa, 6×10⁻Pa, 5×10⁻⁸ Pa, 4×10⁻⁸ Pa. 3 ×10⁻⁸ Pa. 2×10⁻⁸ Pa, 10⁻⁸ Pa, 9×10⁹ Pa. 8×10⁹ Pa, 7×10-Pa, 6×10⁻⁹ Pa, 5×10⁹ Pa, 4×10-⁹ Pa, 3×10⁻⁹ Pa. 2×10⁹ Pa, 10⁹ Pa, 9×10⁻¹⁰ Pa, 8×10⁻¹⁰ Pa. 7×10⁻Pa, 6×10⁻¹⁰ Pa, 5×10⁻¹⁰ Pa, 4×10.10 Pa, 3×10⁴⁰ Pa, 2×10⁻¹⁰ Pa. 10-10 Pa, 9×10⁻¹¹Pa, 8×10⁻¹ Pa, 7×10⁻¹¹ Pa. 6 ×10-“Pa. 5×10-” Pa, 4×10^{-10 Pa,} 3×10^{31 11} Pa, 2×10⁻¹¹ Pa, 1010⁻¹¹ Pa, 9×10-Pa, 8×10⁻² Pa, 7×10⁻² Pa, 6×10⁻² Pa, 5×10⁻¹⁴ Pa, 4×10⁻¹² Pa. 3×10⁻¹² Pa, 2×10⁻² Pa, 10⁻¹² Pa, or lower. The vacuum units may be configured to maintain the system 200 at a pressure of at least about 10.¹² Pa,2×10⁻² Pa,3×10⁻¹² Pa,4×10-rPa,5×10⁻⁴² Pa,6′×10⁻⁴ Pa, 7×1042 Pa,8×10⁻² Pa,9×10˜² Pa, 10⁻¹¹ Pa. 2×10⁻¹¹ Pa, 3×10⁻¹¹ Pa, 4×10⁻¹¹ Pa, 5×10⁻¹¹ Pa, 6×10⁻¹ Pa. 7×10⁻¹¹ Pa, 8 ×10⁻¹¹ Pa, 9×10⁻¹¹ Pa, 10¹⁰ Pa, 2×10⁻¹⁰ Pa. 3×10⁻¹⁰ Pa, 4×10⁻¹⁰ Pa, 5×10⁻¹⁰ Pa, 6×10⁻¹⁰ Pa. 7×10⁻¹ Pa, 8×10⁻¹⁰ Pa, 9×10⁻¹¹ Pa, 10˜9 Pa, 2×10⁻⁹ Pa. 3×10⁻⁹ Pa. 4×10⁻⁹ Pa, 5×10˜9 Pa, 6 ×10˜9 Pa, 7×10⁻⁹ Pa, 8×10⁻⁹ Pa. 9×10⁻⁹ Pa, 10⁻⁸ Pa, 2×10⁻⁸ Pa. 3×10⁻⁸ Pa, 4×10˜⁸ Pa, 5×10-⁸ Pa, 6×10⁻⁸ Pa, 7×10⁻⁸ Pa, 8×10⁻⁸ Pa. 9×10⁻⁸ Pa, 10⁻⁷ Pa, 2×10⁻⁷ Pa. 3×10⁻⁷ Pa, 4×10⁻⁷ Pa, 5×10⁻⁷ Pa, 6×10⁻⁷ Pa, 7×10⁻⁷ Pa, 8×10⁻⁷ Pa. 9×10⁻⁷ Pa, 10-Pa, or higher. The vacuum units may be configured to maintain the system 200 at a pressure that is within a range defined by any two of the preceding values.

The system 200 may comprise one or more state preparation units 250. The state preparation units may comprise any state preparation unit described herein, such as a state preparation unit described herein with respect to FIG. 5. The state preparation units may be configured to prepare a state of the plurality of atoms.

The system 200 may comprise one or more atom reservoirs 260. The atom reservoirs may be configured to supply one or more replacement atoms to replace one or more atoms at one or more optical trapping sites upon loss of the atoms from the optical trapping sites. The atom reservoirs may be spatially separated from the optical trapping units. For instance, the atom reservoirs may be located at a distance from the optical trapping units.

Alternatively or in addition, the atom reservoirs may comprise a portion of the optical trapping sites of the optical trapping units. A first subset of the optical trapping sites may be utilized for performing quantum computations and may be referred to as a set of computationally-active optical trapping sites, while a second subset of the optical trapping sites may serve as an atom reservoir. For instance, the first subset of optical trapping sites may comprise an interior array of optical trapping sites, while the second subset of optical trapping sites comprises an exterior array of optical trapping sites surrounding the interior array. The interior array may comprise a rectangular, square, rectangular prism, or cubic array of optical trapping sites.

The system 200 may comprise one or more atom movement units 270. The atom movement units may be configured to move the one or more replacement atoms from the one or more atoms reservoirs to the one or more optical trapping sites. For instance, the one or more atom movement units may comprise one or more electrically tunable lenses, acousto-optic deflectors (AODs), or spatial light modulators (SLMs).

The system 200 may comprise one or more entanglement units 280. The entanglement units may be configured to quantum mechanically entangle at least a first atom of the plurality of atoms with at least a second atom of the plurality of atoms. The first or second atom may be in a superposition state at the time of quantum mechanical entanglement. Alternatively or in addition, the first or second atom may not be in a superposition state at the time of quantum mechanical entanglement. The first atom and the second atom may be quantum mechanically entangled through one or more magnetic dipole interactions, induced magnetic dipole interactions, electric dipole interactions, or induced electric dipole interactions. The entanglement units may be configured to quantum mechanically entangle any number of atoms described herein.

The entanglement units may also be configured to quantum mechanically entangle at least a subset of the atoms with at least another atom to form one or more multi-qubit units. The multi-qubit units may comprise two-qubit units, three-qubit units, four-qubit units, or n-qubit units, where n may be 5, 6, 7, 8, 9, 10, or more. For instance, a two-qubit unit may comprise a first atom quantum mechanically entangled with a second atom, a three-qubit unit may comprise a first atom quantum mechanically entangled with a second and third atom, a four-qubit unit may comprise a first atom quantum mechanically entangled with a second, third, and fourth atom, and so forth. The first, second, third, or fourth atom may be in a superposition state at the time of quantum mechanical entanglement. Alternatively or in addition, the first, second, third, or fourth atom may not be in a superposition state at the time of quantum mechanical entanglement. The first, second, third, and fourth atom may be quantum mechanically entangled through one or more magnetic dipole interactions, induced magnetic dipole interactions, electric dipole interactions, or induced electric dipole interactions.

The entanglement units may comprise one or more Rydberg units. The Rydberg units may be configured to electronically excite the at least first atom to a Rydberg state or to a superposition of a Rydberg state and a lower-energy atomic state, thereby forming one or more Rydberg atoms or dressed Rydberg atoms. The Rydberg units may be configured to induce one or more quantum mechanical entanglements between the Rydberg atoms or dressed Rydberg atoms and the at least second atom. The second atom may be located at a distance of at least about 200 nanometers (nm), 300 nm, 400 nm, 500 nm, 600 nm, 700 nm, 800 nm, 900 nm, 1 micrometer (μm), 2 μm, 3 μm. 4 μm, 5 μm, 6 μm. 7 μm, 8 μm, 9 μm. 10 μm, or more from the Rydberg atoms or dressed Rydberg atoms. The second atom may be located at a distance of at most about 10 μm. 9 μm, 8 μm, 7 μm. 6 μm, 5 μm, 4 μm, 3 μm, 2 μm, 1 pn 900 nm, 800 nm, 700 nm, 600 nm, 500 nm, 400 nm, 300 nm, 200 nm, or less from the Rydberg atoms or dressed Rydberg atoms. The second atom may be located at a distance from the Rydberg atoms or dressed Rydberg atoms that is within a range defined by any two of the preceding values. The Rydberg units may be configured to allow the Rydberg atoms or dressed Rydberg atoms to relax to a lower-energy atomic state, thereby forming one or more two-qubit units. The Rydberg units may be configured to induce the Rydberg atoms or dressed Rydberg atoms to relax to a lower-energy atomic state. The Rydberg units may be configured to drive the Rydberg atoms or dressed Rydberg atoms to a lower-energy atomic state. For instance, the Rydberg units may be configured to apply electromagnetic radiation (such as RF radiation or optical radiation) to drive the Rydberg atoms or dressed Rydberg atoms to a lower-energy atomic state. The Rydberg units may be configured to induce any number of quantum mechanical entanglements between any number of atoms of the plurality of atoms.

The Rydberg units may comprise one or more light sources (such as any light source described herein) configured to emit light having one or more ultraviolet (UV) wavelengths. The UV wavelengths may be selected to correspond to a wavelength that forms the Rydberg atoms or dressed Rydberg atoms. For instance, the light may comprise one or more wavelengths of at least about 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, or more. The light may comprise one or more wavelengths of at most about 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm, or less. The light may comprise one or more wavelengths that are within a range defined by any two of the preceding values. For instance, the light may comprise one or more wavelengths that are within a range from 300 nm to 400 nm.

The Rydberg units may be configured to induce a two-photon transition to generate an entanglement. The Rydberg units may be configured to induce a two-photon transition to generate an entanglement between two atoms. The Rydberg units may be configured to selectively induce a two-photon transition to selectively generate an entanglement between two atoms. For instance, the Rydberg units may be configured to direct electromagnetic energy (such as optical energy) to particular optical trapping sites to selectively induce a two-photon transition to selectively generate the entanglement between the two atoms. The two atoms may be trapped in nearby optical trapping sites. For instance, the two atoms may be trapped in adjacent optical trapping sites. The two-photon transition may be induced using first and second light from first and second light sources, respectively. The first and second light sources may each comprise any light source described herein (such as any laser described herein). The first light source may be the same or similar to a light source used to perform a single-qubit operation described herein. Alternatively, different light sources may be used to perform a single-qubit operation and to induce a two-photon transition to generate an entanglement. The first light source may emit light comprising one or more wavelengths in the visible region of the optical spectrum (e.g., within a range from 400 nm to 800 nm or from 650 nm to 700 nm). The second light source may emit light comprising one or more wavelengths in the ultraviolet region of the optical spectrum (e.g., within a range from 200 nm to 400 nm or from 300 nm to 350 nm). The first and second light sources may emit light having substantially equal and opposite spatially-dependent frequency shifts.

The Rydberg atoms or dressed Rydberg atoms may comprise a Rydberg state that may have sufficiently strong interatomic interactions with nearby atoms (such as nearby atoms trapped in nearby optical trapping sites) to enable the implementation of multi-qubit operations. The Rydberg states may comprise a principal quantum number of at least about 50, 60, 70, 80, 90, 100, or more. The Rydberg states may comprise a principal quantum number of at most about 100, 90, 80, 70, 60, 50, or less. The Rydberg states may comprise a principal quantum number that is within a range defined by any two of the preceding values. The Rydberg states may interact with nearby atoms through van der Waals interactions. The van der Waals interactions may shift atomic energy levels of the atoms.

State selective excitation of atoms to Rydberg levels may enable the implementation of multi-qubit operations. The multi-qubit operations may comprise two-qubit operations, three-qubit operations, or n-qubit operations, where n is 4, 5, 6, 7, 8, 9, 10, or more. Two-photon transitions may be used to excite atoms from a ground state (such as a ¹S₀ ground state) to a Rydberg state (such as an n³S₁ state, wherein n is a principal quantum number described herein). State selectivity may be accomplished by a combination of laser polarization and spectral selectivity. The two-photon transitions may be implemented using first and second laser sources, as described herein. The first laser source may emit pi-polarized light, which may not change the projection of atomic angular momentum along a magnetic field. The second laser may emit circularly polarized light, which may change the projection of atomic angular momentum along the magnetic field by one unit. The first and second qubit levels may be excited to Rydberg level using this polarization. However, the Rydberg levels may be more sensitive to magnetic fields than the ground state so that large splittings (for instance, on the order of 100s of MHz) may be readily obtained. This spectral selectivity may allow state selective excitation to Rydberg levels.

Multi-qubit operations (such as two-qubit operations, three-qubit operations, four-qubit operations, and so forth) may rely on energy shifts of levels due to van der Waals interactions described herein. Such shifts may either prevent the excitation of one atom conditional on the state of the other or change the coherent dynamics of excitation of the two-atom system to enact a two-qubit operation. In some cases, “dressed states” may be generated under continuous driving to enact two-qubit operations without requiring full excitation to a Rydberg level (for instance, as described in www.arxiv.org/abs/1605.05207, which is incorporated herein by reference in its entirety for all purposes).

The system 200 may comprise one or more second electromagnetic delivery units (not shown in FIG. 2). The second electromagnetic delivery units may comprise any electromagnetic delivery unit described herein, such as an electromagnetic delivery unit described herein with respect to FIG. 4. The first and second electromagnetic delivery units may be the same. The first and second electromagnetic delivery units may be different. The second electromagnetic delivery units may be configured to apply second electromagnetic energy to the one or more multi-qubit units. The second electromagnetic energy may comprise one or more pulse sequences. The first electromagnetic energy may precede, be simultaneous with, or follow the second electromagnetic energy.

The pulse sequences may comprise any number of pulses. For instance, the pulse sequences may comprise at least about 1, 2, 3, 4, 5, 6, 7, 8, 9, 10, 20, 30, 40, 50, 60, 70, 80, 90, 100, 200, 300, 400, 500, 600, 700, 800, 900, 1,000, or more pulses. The pulse sequences may comprise at most about 1,000, 900, 800, 700, 600, 500, 400, 300, 200, 100, 90, 80, 70, 60, 50, 40, 30, 20, 10, 9, 8, 7, 6, 5, 4, 3, 2, or 1 pulses. The pulse sequences may comprise a number of pulses that is within a range defined by any two of the preceding values. Each pulse of the pulse sequence may comprise any pulse shape, such as any pulse shape described herein.

The pulse sequences may be configured to decrease the duration of time required to implement multi-qubit operations, as described herein (for instance, with respect to Example 3). For instance, the pulse sequences may comprise a duration of at least about 10 nanoseconds (ns), 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, I microsecond (μs), 2 μs, 3 μs, 4 μs, 5 μs, 6 μs, 7 μs, 8 μs, 9 μs, 10 μs, 20 μs, 30 μs, 40 μs, 50 μs, 60 μs, 70 μs, 80 μs, 90 μs, 100 μs, or more. The pulse sequences may comprise a duration of at most about 100 μs, 90 μs, 80 μs, 70 μs, 60 μs, 50 μs, 40 μs, 30 μs, 20 μs, 10 μs, 9 μs, 8 μs, 7 μs, 6 μs, 5 μs, 4 μs, 3 μs, 2 μs, 1 μs, 900 ns, 800 ns, 700 ns, 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, or less. The pulse sequences may comprise a duration that is within a range defined by any two of the preceding values.

The pulse sequences may be configured to increase the fidelity of multi-qubit operations, as described herein. For instance, the pulse sequences may enable multi-qubit operations with a fidelity of at least about 0.5, 0.6, 0.7, 0.8, 0.9, 0.91, 0.92, 0.93, 0.94, 0.95, 0.96, 0.97, 0.98, 0.99, 0.991, 0.992, 0.993, 0.994, 0.995, 0.996, 0.997, 0.998, 0.999, 0.9991, 0.9992, 0.9993, 0.9994, 0.9995, 0.9996, 0.9997, 0.9998, 0.9999, 0.99991, 0.99992, 0.99993, 0.99994, 0.99995, 0.99996, 0.99997, 0.99998, 0.99999, 0.999991, 0.999992, 0.999993, 0.999994, 0.999995, 0.999996, 0.999997, 0.999998, 0.999999, or more. The pulse sequences may enable multi-qubit operations with a fidelity of at most about 0.999999, 0.999998, 0.999997, 0.999996, 0.999995, 0.999994, 0.999993, 0.999992, 0.999991, 0.99999, 0.99998, 0.99997, 0.99996, 0.99995, 0.99994, 0.99993, 0, 99992, 0.99991, 0.9999, 0.9998, 0.9997, 0.9996, 0.9995, 0.9994, 0.9993, 0.9992, 0.9991, 0.999, 0.998, 0.997, 0.996, 0.995, 0.994, 0.993, 0.992, 0.991, 0.99, 0.98, 0.97, 0.96, 0.95, 0.94, 0.93, 0.92, 0.91, 0.9, 0.8, 0.7, 0.6, 0.5, or less. The pulse sequences may enable multi-qubit operations with a fidelity that is within a range defined by any two of the preceding values.

The pulse sequences may enable the implementation of multi-qubit operations on non-adiabatic timescales while maintaining effectively adiabatic dynamics. For instance, the pulse sequences may comprise one or more of shortcut to adiabaticity (STA) pulse sequences, transitionless quantum driving (TQD) pulse sequences, superadiabatic pulse sequences, counterdiabatic driving pulse sequences, derivative removal by adiabatic gate (DRAG) pulse sequences, and weak anharmonicity with average Hamiltonian (Wah Wah) pulse sequences. For instance, the pulse sequences may be similar to those described in M.V. Berry, “Transitionless Quantum Driving,” Journal of Physics A: Mathematical and Theoretical 42(36), 365303 (2009), www.doi.org/10.1088/1751-8113/42/36/365303; Y.-Y. Jau et al., “Entangling Atomic Spins with a Strong Rydberg-Dressed Interaction,” Nature Physics 12(1), 71-74 (2016): T. Keating et al., “Robust Quantum Logic in Neutral Atoms via Adiabatic Rydberg Dressing,” Physical Review A 91, 012337 (2015): A. Mitra et al., “Robust Mölmer-Sörenson Gate for Neutral Atoms Using Rapid Adiabatic Rydberg Dressing,” www.arxiv.org/abs/1911.04045 (2019); or L.S. Theis et al., “Counteracting Systems of Diabaticities Using DRAG Controls: The Status after 10 Years,” Europhysics Letters 123(6), 60001 (2018), each of which is incorporated herein by reference in its entirety for all purposes.

The pulse sequences may further comprise one or more optimal control pulse sequences. The optimal control pulse sequences may be derived from one or more procedures, including gradient ascent pulse engineering (GRAPE) methods, Krotov's method, chopped basis methods, chopped random basis (CRAB) methods, Nelder-Mead methods, gradient optimization using parametrization (GROUP) methods, genetic algorithm methods, and gradient optimization of analytic controls (GOAT) methods. For instance, the pulse sequences may be similar to those described in N. Khaneja et al., “Optimal Control of Coupled Spin Dynamics: Design of NMR Pulse Sequences by Gradient Ascent Algorithms,” Journal of Magnetic Resonance 172(2), 296-305 (2005); or J. T. Merrill et al., “Progress in Compensating Pulse Sequences for Quantum Computation,” Advances in Chemical Physics 154, 241-294 (2014), each of which is incorporated by reference in its entirety for all purposes.

### Example of Cloud Computing

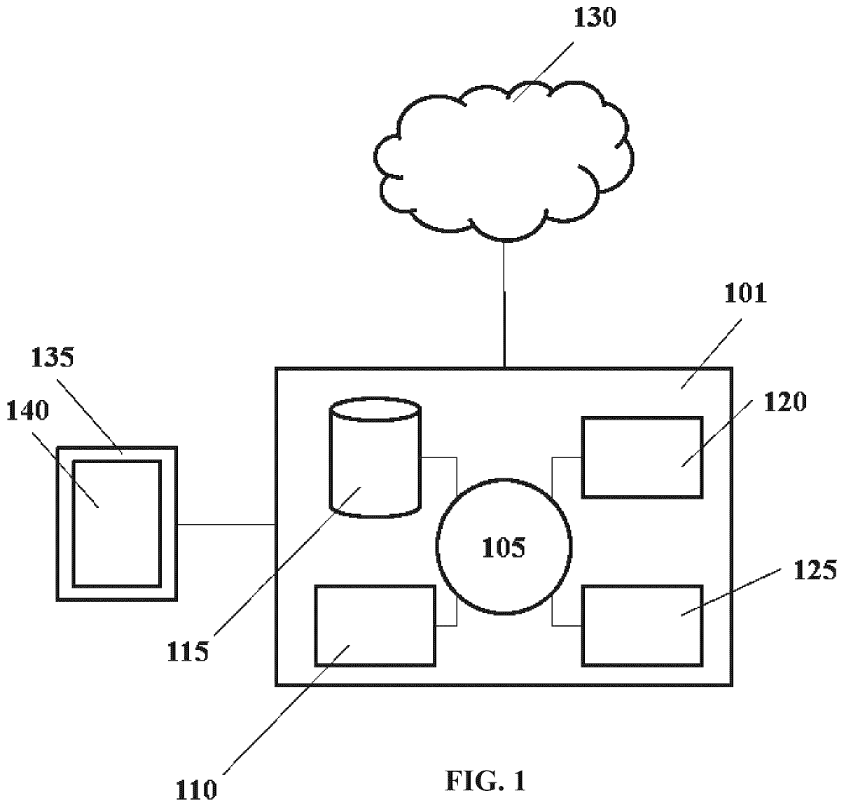

The system 200 may be operatively coupled to a digital computer described herein (such as a digital computer described herein with respect to FIG. 1) over a network described herein (such as a network described herein with respect to FIG. 1). The network may comprise a cloud computing network.

### Example of Optical Trapping Units

FIG. 3A shows an example of an optical trapping unit 210. The optical trapping unit may be configured to generate a plurality 211 of spatially distinct optical trapping sites, as described herein. For instance, as shown in FIG. 3B, the optical trapping unit may be configured to generate a first optical trapping site 211a, second optical trapping site 211b, third optical trapping site 211c, fourth optical trapping site 211d, fifth optical trapping site 211e, sixth optical trapping site 211f, seventh optical trapping site 211g, eighth optical trapping site 211h, and ninth optical trapping site 211i, as depicted in FIG. 3A. The plurality of spatially distinct optical trapping sites may be configured to trap a plurality of atoms, such as first atom 212a, second atom 212b, third atom 212c, and fourth atom 212d, as depicted in FIG. 3A. As depicted in FIG. 3B, each optical trapping site may be configured to trap a single atom. As depicted in FIG. 3B, some of the optical trapping sites may be empty (i.e., not trap an atom).

As shown in FIG. 3D, the plurality of optical trapping sites may comprise a two-dimensional (2D) array. The 2D array may be perpendicular to the optical axis of optical components of the optical trapping unit depicted in FIG. 3A. Alternatively, the plurality of optical trapping sites may comprise a one-dimensional (1D) array or a three-dimensional (3D) array.

Although depicted as comprising nine optical trapping sites filled by four atoms in FIG. 3B, the optical trapping unit 210 may be configured to generate any number of spatially distinct optical trapping sites described herein and may be configured to trap any number of atoms described herein.

Each optical trapping site of the plurality of optical trapping sites may be spatially separated from each other optical trapping site by a distance of at least about 200 nm, 300 nm, 400 nm, 500 nm, 600 nm, 700 nm, 800 nm, 900 nm, 1 μm, 2 μm, 3 μm, 4 μm, 5 μm, 6 μm, 7 μm. 8 μm, 9 μm. 10 μm, or more. Each optical trapping site may be spatially separated from each other optical trapping site by a distance of at most about 10 μm, 9 μm, 8 μm, 7 μm, 6 μm, 5 μm, 4 μm, 3 μm, 2 μm, 1 μm, 900 nm, 800 nm, 700 nm, 600 nm, 500 nm, 400 nm, 300 nm, 200 nm, or less. Each optical trapping site maybe spatially separated from each other optical trapping site by a distance that is within a range defined by any two of the preceding values.

The optical trapping sites may comprise one or more optical tweezers. Optical tweezers may comprise one or more focused laser beams to provide an attractive or repulsive force to hold or move the one or more atoms. The beam waist of the focused laser beams may comprise a strong electric field gradient. The atoms may be attracted or repelled along the electric field gradient to the center of the laser beam, which may contain the strongest electric field. The optical trapping sites may comprise one or more optical lattice sites of one or more optical lattices. The optical trapping sites may comprise one or more optical lattice sites of one or more one-dimensional (I D) optical lattices, two-dimensional (2D) optical lattices, or three-dimensional (3D) optical lattices. For instance, the optical trapping sites may comprise one or more optical lattice sites of a 2D optical lattice, as depicted in FIG. 3B.

The optical lattices may be generated by interfering counter-propagating light (such as counter-propagating laser light) to generate a standing wave pattern having a periodic succession of intensity minima and maxima along a particular direction. A 1D optical lattice may be generated by interfering a single pair of counter-propagating light beams. A 2D optical lattice may be generated by interfering two pairs of counter-propagating light beams. A 3D optical lattice may be generated by interfering three pairs of counter-propagating lights beams. The light beams may be generated by different light sources or by the same light source. Therefore, an optical lattice may be generated by at least about 1, 2, 3, 4, 5, 6, or more light sources or at most about 6, 5, 4, 3, 2, or 1 light sources.

Returning to the description of FIG. 3A, the optical trapping unit may comprise one or more light sources configured to emit light to generate the plurality of optical trapping sites as described herein. For instance, the optical trapping unit may comprise a single light source 213, as depicted in FIG. 3A. Though depicted as comprising a single light source in FIG. 3A, the optical trapping unit may comprise any number of light sources, such as at least about 1, 2, 3, 4, 5, 6, 7, 8, 9, 10, or more light sources or at most about 10, 9, 8, 7, 6, 5, 4, 3, 2, or 1 light sources. The light sources may comprise one or more lasers. The lasers may be configured to operate at a resolution limit of the lasers. For example, the lasers can be configured to provide diffraction limited spot sizes for optical trapping.

The lasers may comprise one or more continuous wave lasers. The lasers may comprise one or more pulsed lasers. The lasers may comprise one or more gas lasers, such as one or more helium-neon (HeNe) lasers, argon (Ar) lasers, krypton (Kr) lasers, xenon (Xe) ion lasers, nitrogen (N₂) lasers, carbon dioxide (CO₂) lasers, carbon monoxide (CO) lasers, transversely excited atmospheric (TEA) lasers, or excimer lasers. For instance, the lasers may comprise one or more argon dimer (Ar₂) excimer lasers, krypton dimer (Kr₂) excimer lasers, fluorine dimer (F₂) excimer lasers, xenon dimer (Xe₂) excimer lasers, argon fluoride (ArF) excimer lasers, krypton chloride (KrCl) excimer lasers, krypton fluoride (KrF) excimer lasers, xenon bromide (XeBr) excimer lasers, xenon chloride (XeCl) excimer lasers, or xenon fluoride (XeF) excimer lasers. The laser may comprise one or more dye lasers.

The lasers may comprise one or more metal-vapor lasers, such as one or more helium-cadmium (HeCd) metal-vapor lasers, helium-mercury (HeHg) metal-vapor lasers, helium-selenium (HeSe) metal-vapor lasers, helium-silver (HeAg) metal-vapor lasers, strontium (Sr) metal-vapor lasers, neon-copper (NeCu) metal-vapor lasers, copper (Cu) metal-vapor lasers, gold (Au) metal-vapor lasers, manganese (Mn) metal-vapor laser, or manganese chloride (MnCl₂) metal-vapor lasers.

The lasers may comprise one or more solid-state lasers, such as one or more ruby lasers, metal-doped crystal lasers, or metal-doped fiber lasers. For instance, the lasers may comprise one or more neodymium-doped yttrium aluminum gamet (Nd:YAG) lasers, neodvmium/chromium doped yttrium aluminum gamet (Nd/Cr:YAG) lasers, erbium-doped yttrium aluminum gamet (Er:YAG) lasers, neodymium-doped yttrium lithium fluoride (Nd:YLF) lasers, neodymium-doped yttrium orthovanadate (ND:YVO₄) lasers, neodymium-doped yttrium calcium oxoborate (Nd:YCOB) lasers, neodymium glass (Nd:glass) lasers, titanium sapphire (Ti:sapphire) lasers, thulium-doped ytrium aluminum gamet (Tm:YAG) lasers, ytterbium-doped ytrrium aluminum gamet (Yb:YAG) lasers, ytterbium-doped glass (Yt:glass) lasers, holmium ytrrium aluminum gamet (Ho:YAG) lasers, chromium-doped zinc selenide (Cr:ZnSe) lasers, cerium-doped lithium strontium aluminum fluoride (Ce:LiSAF) lasers, cerium-doped lithium calcium aluminum fluoride (Ce:LiCAF) lasers, erbium-doped glass (Er:glass) lasers, erbium-ytterbium-codoped glass (Er/Yt:glass) lasers, uranium-doped calcium fluoride (U:CaF₂) lasers, or samarium-doped calcium fluoride (Sm:CaF₂) lasers.

The lasers may comprise one or more semiconductor lasers or diode lasers, such as one or more gallium nitride (GaN) lasers, indium gallium nitride (InGaN) lasers, aluminum gallium indium phosphide (AlGaInP) lasers, aluminum gallium arsenide (AlGaAs) lasers, indium gallium arsenic phosphide (InGaAsP) lasers, vertical cavity surface emitting lasers (VCSELs), or quantum cascade lasers.

The lasers may emit continuous wave laser light. The lasers may emit pulsed laser light. The lasers may have a pulse length of at least about 1 femtoseconds (fs), 2 fs, 3 fs, 4 fs. 5 fs, 6 fs, 7 fs. 8 fs, 9 fs, 10 fs, 20 fs, 30 fs, 40 fs, 50 fs, 60 fs, 70 fs, 80 fs, 90 fs. 100 fs, 200 fs, 300 fs, 400 fs, 500 fs, 600 fs, 700 fs, 800 fs, 900 fs, 1 picosecond (ps), 2 ps, 3 ps, 4 ps, 5 ps, 6 ps, 7 ps, 8 ps, 9 ps, 10 ps, 20 ps, 30 ps, 40 ps, 50 ps, 60 ps, 70 ps, 80 ps, 90 ps, 100 ps, 200 ps, 300 ps, 400 ps, 500 ps, 600 ps, 700 ps, 800 ps, 900 ps, 1 nanosecond (ns), 2 ns, 3 ns. 4 ns, 5 ns, 6 ns, 7 ns, 8 ns, 9 ns, 10 ns, 20 ns, 30 ns, 40 ns, 50 ns, 60 ns, 70 ns, 80 ns, 90 ns, 100 ns, 200 ns, 300 ns, 400 ns, 500 ns, 600 ns, 700 ns, 800 ns, 900 ns, 1,000 ns, or more. The lasers may have a pulse length of at most about 1,000 ns, 900 ns, 800 ns, 700 ns, 600 ns, 500 ns, 400 ns, 300 ns, 200 ns, 100 ns, 90 ns, 80 ns. 70 ns, 60 ns, 50 ns, 40 ns, 30 ns, 20 ns, 10 ns, 9 ns, 8 ns, 7 ns, 6 ns. 5 ns, 4 ns, 3 ns, 2 ns, 1 ns, 900 ps, 800 ps, 700 ps, 600 ps, 500 ps, 400 ps. 300 ps, 200 ps, 100 ps, 90 ps, 80 ps, 70 ps, 60 ps, 50 ps, 40 ps, 30 ps, 20 ps, 10 ps, 9 ps, 8 ps, 7 ps, 6 ps, 5 ps, 4 ps, 3 ps, 2 ps, 1 ps, 900 fs. 800 fs, 700 fs. 600 fs, 500 fs. 400 fs, 300 fs, 200 fs, 100 fs, 90 fs, 80 fs, 70 fs, 60 fs. 50 fs, 40 fs, 30 fs, 20 fs, 10 fs, 9 fs, 8 fs. 7 fs, 6 fs, 5 fs, 4 fs, 3 fs, 2 fs, I fs, or less. The lasers may have a pulse length that is within a range defined by any two of the preceding values.

The lasers may have a repetition rate of at least about 1 hertz (Hz), 2 Hz, 3 Hz, 4 Hz, 5 Hz, 6 Hz, 7 Hz, 8 Hz, 9 Hz, 10 Hz, 20 Hz, 30 Hz, 40 Hz, 50 Hz, 60 Hz, 70 Hz, 80 Hz, 90 Hz, 100 Hz, 200 Hz, 300 Hz, 400 Hz, 500 Hz, 600 Hz, 700 Hz, 800 Hz, 900 Hz, 1 kilohertz (kHz), 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 6( ) kHz, 70 kHz, 80 kHz, 90 kHz, 100 kHz, 200 kHz, 300 kHz, 400 kHz, 500 kHz. 600 kHz. 700 kHz, 800 kHz, 900 kHz, 1 megahertz (MHz), 2 MHz, 3 MHz. 4 MHz, 5 MHz. 6 MHz, 7 MHz, 8 MHz, 9 MHz, 10 MHz, 20 MHz, 30 MHz, 40 MHz, 50 MHz, 60 MHz, 70 MHz, 80 MHz, 90 MHz, 100 MHz, 200 MHz, 300 MHz, 400 MHz, 500 MHz, 600 MHz, 700 MHz, 800 MHz, 900 MHz, 1,000 MHz. or more. The lasers may have a repetition rate of at most about 1,000 MHz, 900 MHz, 800 MHz, 700 MHz, 600 MHz, 500 MHz, 400 MHz, 300 MHz, 200 MHz, 100 MHz, 90 MHz, 80 MHz, 70 MHz, 60 MHz, 50 MHz, 40 MHz, 30 MHz, 20 MHz, 10 MHz, 9 MHz, 8 MHz, 7 MHz, 6 MHz, 5 MHz, 4 MHz, 3 MHz, 2 MHz, 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz. 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, 900 Hz, 800 Hz, 700 Hz, 600 Hz, 500 Hz, 400 Hz, 300 Hz, 200 Hz, 100 Hz, 90 Hz, 80 Hz. 70 Hz, 60 Hz, 50 Hz, 40 Hz, 30 Hz, 20 Hz, 10 Hz, 9 Hz, 8 Hz, 7 Hz, 6 Hz, 5 Hz, 4 Hz, 3 Hz, 2 Hz, 1 Hz, or less. The lasers may have a repetition rate that is within a range defined by any two of the preceding values.

The lasers may emit light having a pulse energy of at least about 1 nanojoule (nJ), 2 nJ, 3 nJ, 4 nJ, 5 nJ, 6 nJ, 7 nJ, 8 nJ. 9 nJ, 10 nJ. 20 nJ, 30 n. 40 nJ, 50 nJ, 60 nJ, 70 nJ, 80 nJ, 90 nJ, 100 nJ, 200 nJ, 300 nJ, 400 nJ, 500 nJ, 600 nJ, 700 nJ, 800 nJ, 900 nJ, 1 microjoule (pJ), 2 pJ, 3 pJ, 4 pJ. 5 pJ. 6 pJ. 7 pJ. 8 pJ. 9 pJ, 10 pJ, 20 pJ. 30 pJ. 40 pJ, 50 pJ, 60 pJ. 70 pJ. 80 pJ. 90 pJ. 100 pJ, 200 pJ, 300 ptJ, 400 pJ. 500 pJ. 600 pJ, 700 p), 800 pJ, 900 pJ, a least 1 millijoule (mJ), 2 mJ, 3 mJ, 4 mJ, 5 mJ, 6 mJ, 7 mJ, 8 mJ, 9 mJ, 10 mJ, 20 mJ, 30 mJ, 40 mJ, 50 mJ, 6( ) mJ, 70 mJ, 80 mJ. 90 mJ, 100 mJ, 200 mJ. 300 mJ, 400 mJ, 500 mJ, 600 mJ, 700 ml, 800 ml, 900 ml, a least 1 Joule (J), or more. The lasers may emit light having a pulse energy of at most about 1 J, 900 mJ, 800 mJ, 700 mJ, 600 mJ, 500 mJ, 400 mJ, 300 mJ, 200 mJ, 100 mJ, 90 mJ, 80 mJ, 70 mJ, 60 mJ, 50 mJ, 40 mJ, 30 mJ, 20 mJ, 10 mJ, 9 mJ, 8 mJ, 7 mJ, 6 mJ, 5 mJ, 4 mJ, 3 mJ, 2 mJ, 1 mJ. 900 pJ. 800 pJ, 700 pJ. 600 pJ. 500 pJ, 400 pJ, 300 pJ, 200 pJ, 100 pJ, 90 pJ, 80 pJ, 70 pJ, 60 pJ, 50 pJ, 40 pJ, 30 pJ, 20 pJ, 10 pJ, 9 pJ, 8 pJ, 7 pJ, 6 pJ, 5 pJ, 4 pJ, 3 pJ, 2 pJ, 1 pJ, 900 nJ, 800 nJ. 700 nJ, 600 nJ. 500 nJ, 400 nJ. 300 nJ, 200 nJ, 100 nJ, 90 nJ, 80 nJ, 70 nJ, 60 nJ, 50 nJ, 40 nJ, 30 nJ, 20 nJW, nJ 9 nJ, 8 n, 7 nJ. 6 nJ, 5 n, 4 nJ, 3 n, 2 nJ, 1 n, or less. The lasers may emit light having a pulse energy that is within a range defined by any two of the preceding values.

The lasers may emit light having an average power of at least about 1 microwatt (μW), 2 μW, 3 μW, 4 μW, 5 μW, 6 μW, 7 μW, 8 μW, 9 μW, 10 μW, 20 μW, 30 μW, 40 μW, 50 μW, 60 μW, 70 μW, 80 μW, 90 μW, 100 μW, 200 μW, 300 μW, 400 μW, 500 μW, 600 μW, 700 μW, 800 μW, 900 μW, 1 milliwatt (mW), 2 mW, 3 mW, 4 mW, 5 mW, 6 mW, 7 mW, 8 mW, 9 mW, 10 mW, 20 mW, 30 mW, 40 mW, 50 mW, 60 mW, 70 mW, 80 mW, 90 mW, 100 mW, 200 mW, 300 mW, 400 mW, 500 mW, 600 mW, 700 mW, 800 mW, 900 mW, I watt (W), 2 W, 3 W, 4 W, 5 W, 6 W, 7 W, 8 W, 9 W, 10 W, 20 W, 30 W, 40 W, 50 W, 60 W, 70 W, 80 W, 90 W, 100 W. 200 W, 300 W, 400 W, 500 W, 600 W, 700 W, 800 W, 900 W, 1,000 W, or more. The lasers may emit light having an average power of at most about 1,000 W, 900 W, 800 W, 700 W, 600 W, 500 W, 400 W, 300 W, 200 W, 100 W, 90 W, 80 W, 70 W, 60 W, 50 W, 40 W, 30 W, 20 W, 10 W, 9 W, 8 W, 7 W, 6 W, 5 W, 4 W, 3 W, 2 W, I W, 900 mW, 800 mW, 700 mW, 600 mW, 500 mW, 400 mW, 300 mW, 200 mW, 100 mW, 90 mW, 80 mW, 70 mW, 60 mW, 50 mW, 40 mW. 30 mW, 20 mW, 10 mW, 9 mW, 8 mW, 7 mW, 6 mW, 5 mW, 4 mW, 3 mW, 2 mW, 1 mW, 900 μW, 800 μW, 700 μW, 600 μW, 500 μW, 400 μW, 300 μW, 200 μW, 100 μW, 90 μW, 80 μW, 70 μW, 60 μW, 50 μW, 40 μW, 30 μW, 20 μW, 10 μW, 9 μW, 8 μW, 7 μW, 6 μW, 5 μW, 4 μW, 3 μW, 2 μW, 1 μW, or more. The lasers may emit light having a power that is within a range defined by any two of the preceding values.

The lasers may emit light comprising one or more wavelengths in the ultraviolet (UV), visible, or infrared (IR) portions of the electromagnetic spectrum. The lasers may emit light comprising one or more wavelengths of at least about 200 nm, 210 nm, 220 nm, 230 nm, 240 nm, 250 nm, 260 nm, 270 nm, 280 nm, 290 nm, 300 nm, 310 nm, 320 nm, 330 nm, 340 nm, 350 nm, 360 nm, 370 nm, 380 nm, 390 nm, 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, 1,010 nm, 1,020 nm, 1,030 nm, 1,040 nm, 1,050 nm, 1,060 nm, 1,070 nm, 1,080 nm, 1,090 nm, 1,100 nm, 1,110 nm, 1,120 nm, 1,130 nm, 1,140 nm, 1,150 nm, 1,160 nm, 1,170 nm, 1,180 nm, 1,190 nm, 1,200 nm, 1,210 nm, 1,220 nm, 1,230 nm, 1,240 nm, 1,250 nm, 1,260 nm, 1,270 nm, 1,280 nm, 1,290 nm, 1,300 nm, 1,310 nm, 1,320 nm, 1,330 nm, 1,340 nm, 1,350 nm, 1,360 nm, 1,370 nm, 1,380 nm, 1,390 nm, 1,400 nm, or more. The lasers may emit light comprising one or more wavelengths of at most about 1,400 nm, 1,390 nm, 1,380 nm, 1,370 n, 1,360 nm, 1,350 nm, 1,340 nm, 1,330 nm, 1,320 nm, 1,310 nm, 1,300 nm, 1,290 nm, 1,280 nm, 1,270 n, 1,260 nm, 1,250 nm, 1,240 nm, 1,230 nm, 1,220 nm, 1,210 nm, 1,200 nm, 1,190 nm, 1,180 nm, 1,170 n, 1,160 nm, 1,150 nm, 1,140 nm, 1,130 nm, 1,120 nm, 1,110 nm, 1,100 nm, 1,090 nm, 1,080 nm, 1,070 n, 1,060 nm, 1,050 nm, 1,040 nm, 1,030 nm, 1,020 nm, 1,010 nm, 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, 390 nm, 380 nm, 370 nm, 360 nm, 350 nm, 340 nm, 330 nm, 320 nm, 310 nm, 300 nm, 290 nm, 280 nm, 270 nm, 260 nm, 250 nm, 240 nm, 230 nm, 220 nm, 210 nm, 200 nm. The lasers may emit light comprising one or more wavelengths that are within a range defined by any two of the preceding values.

The lasers may emit light having a bandwidth of at least about 1×10-nm, 2×10-r nm. 3×10⁻¹⁵ nm, 4×10⁻¹⁵ nm, 5×10⁻¹⁵ nm,6×10-“nm,7×10-nm,8×10” ⁵ nm,9×10 nm, 1 ×10-14 nm, 2×10^{-—}nm, 3×10⁻¹⁴ nm, 4×10⁻¹⁴ nm, 5×10⁻¹⁴ nm, 6×10⁻⁴ nm, 7×10⁻¹⁴ nm, 8×10-¹⁴ nm, 9×10⁻¹⁴ nm, I×10⁻¹³ nm, 2×10⁻¹ nm, 3×10⁻¹ nm, 4×10^{—}nm, 5×10³ nm, 6×10.13 nm, 7×10⁻¹³ nm, 8×10⁻¹r nm, 9×10⁻¹³ nm, 1×10⁻¹² nm, 2×10⁻¹² nm, 3×10¹² nm, 4×10⁻¹ -nm, 5×10.1⁻¹² nm, 6×10⁻¹² nm, 7×10.12 nm, 8×10⁻¹² nm, 9×10⁻¹⁴ nm, 1×10⁻¹¹ nm, 2×10-11 nm, 3×10⁻¹¹ nm, 4×10⁻¹¹ nm, 5×10⁻¹¹ nm, 6×10⁻¹¹ nm, 7×10⁻¹¹ nm, 8×10⁻¹¹ nm, 9×10-11m, 1×10⁻¹⁰ nm, 2×10⁻¹⁰ nm, 3×10⁻¹¹ nm, 4×10⁻¹⁰ nm, 5×10⁻¹⁰ nm, 6×10⁻¹⁰ nm, 7×10-⁰ rnm, 8×10⁻⁰ nm, 9×10⁻¹⁰ m, 1×10⁻⁹ nm, 2×10⁻⁹ nm, 3×10⁻⁹ nm, 4×10⁻⁹ nm, 5×10-nm, 6×10⁻⁹ nm, 7×10⁻⁹ nm, 8×10 nm, 9×10⁻⁹ nm, I×10⁻⁸ nm, 2×10⁻⁸ nm, 3×10⁻⁸ nm, 4×10⁻⁸ nm, 5×10⁻⁸ nm, 6×10 mm, 7×10-nm, 8×10⁻⁸ nm, 9×10⁻⁸ nm, 1×10⁻⁷ nm, 2×10⁻⁷ nm, 3×10⁻⁷ nmi, 4×10⁷ nm, 5×10⁻⁷ nm 6×10⁻⁷ nm, 7×10⁻⁷ nm, 8×10⁻⁷ nm, 9×10⁻⁷ nm,1×10-nm, 2×10-nm, 3×10-nm, 4×10-nm, 5×10-nm, 6×10-nm, 7×10-nm, 8×10-nm, 9×10-nm, 1×10⁻⁵ nm, 2×10⁻⁵ nm, 3×10⁻⁵ nm, 4×10⁻⁵ nm, 5×10⁻⁵ nm, 6×10⁻¹³ mm, 7×10⁵ nm, 8×10⁻⁵ nm, 9×10⁻⁵ nm,1×104 nm, 2×10⁴ nm, 3×10⁴ m, 4×10⁴ nmi, 5×10⁴ nm, 6×10⁴ nm, 7×10⁴ mm, 8×10⁴ nm, 9×10⁴ nm, 1×10-nm, or more. The lasers may emit light having a bandwidth of at most aboutI×10³ nm, 9×10⁴ nm, 8×10⁴ nm, 7×10⁴ nm, 6×10⁴ nm. 5×10⁴ nm, 4×10⁴ nm, 3×10⁴ nm, 2×10⁴ nm, I×104 nm, 9×10⁵ nm, 8×10-nm, 7×10⁵ nm, 6×10⁵ nm, 5×10⁵ nm, 4×10⁵ nm, 3×10⁵ nm, 2×10⁻⁵ nm,1×10⁵ nm, 9×10⁴ m, 8×10-m, 7×10¹ nm, 6×10-nm, 5×10-nm, 4×10¹ nm, 3×10⁻⁴ m, 2×10⁻⁴ m, 1×10 nm, 9×10⁻⁷ nm, 8×10⁻⁷ nm, 7×10⁻⁷ nm, 6×10⁻⁷ inm, 5×10⁻⁷ nm, 4×10⁻⁷ nm, 3×10⁻⁷ nm, 2×10⁻⁷ nm, 1×10⁻⁷ nm, 9×10⁻⁸ nm, 8×10˜nm, 7×10˜* nm, 6×10⁻⁸ nm, 5×10 nm, 4×10⁻⁸ nm, 3×10⁻⁸ nm, 2×10⁻⁸ mm, 1×10-nm, 9×10⁻⁹ nm 8×10⁻⁹ nm, 7×10⁻⁹ nm, 6×10⁻⁹ nm, 5×10⁻⁹ nm, 4×10⁻⁹ nm, 3×10⁻⁹ nm, 2×10⁻⁹ nm, 1×10-nm, 9×10⁻⁰ nm, 8×10⁻¹⁰ nm, 7×⁻¹⁰nm, 6×10⁻¹⁰ nm, 5×10⁻¹⁰ nm, 4×10⁻¹⁰ nm, 3×10⁻¹⁰ nm, 2×10.10 mm, 1×10.10 mm, 9×10⁻¹¹ mm, 8×10⁻¹¹ nm, 7×⁻¹⁰ nim, 6×10¹ nm, 5×10¹ nm, 4×⁻¹⁰ nim, 3×10⁻¹⁴ nm, 2×10⁻¹¹ nm, 1×10 m, 9×10⁻¹² m, 8×10⁻¹² m, 7×10⁻¹′ m, 6×10⁻² nm, 5×10⁻² nm, 4×10⁻² nm, 3×10⁻¹² mm. 2×10⁻¹² mm, 1×10⁻¹² mm, 9×10⁻¹ nm, 8×10⁻¹ nm, 7×10⁻¹³ nm, 6×10⁻¹³ mm, 5×10⁻³ mm. 4×10⁻¹³ mm, 3×10⁻¹³ mm, 2×10⁻¹³ nm, I×10⁻¹³ nm, 9×10⁻¹⁴ nm, 8×10⁻¹⁴ mm, 7×10⁻¹⁴ nm, 6×10⁻¹⁴ nm, 5×10⁻¹⁴ m, 4×10⁻⁴ nm, 3×10⁻¹⁴ m, 2×10⁻¹⁴ nm, 1×10¹⁴ m, 9×10⁻¹⁵ nm, 8×10⁻¹⁵ nm, 7×10⁻¹ nm, 6×10⁻³ nm, 5×⁻¹⁵ nm, 4×10⁻¹⁵ mm, 3×10⁻¹ mm, 2×10⁻¹⁵ nm, 1×10⁵ nm, or less. The lasers may emit light having a bandwidth that is within a range defined by any two of the preceding values.

The light sources may be configured to emit light tuned to one or more magic wavelengths corresponding to the plurality of atoms. A magic wavelength corresponding to an atom may comprise any wavelength of light that gives rise to equal or nearly equal polarizabilities of the first and second atomic states. The magic wavelengths for a transition between the first and second atomic states may be determined by calculating the wavelength-dependent polarizabilities of the first and second atomic states and finding crossing points. Light timed to such a magic wavelength may give rise to equal or nearly equal differential light shifts in the first and second atomic states, regardless of the intensity of the light emitted by the light sources. This may effectively decouple the first and second atomic states from motion of the atoms. The magic wavelengths may utilize one or more scalar or tensor light shifts. The scalar or tensor light shifts may depend on magnetic sublevels within the first and second atomic states.

For instance, group III atoms and metastable states of alkaline earth or alkaline earth-like atoms may possess relatively large tensor shifts whose angle relative to an applied magnetic field may be tuned to cause a situation in which scalar and tensor shifts balance and give a zero or near zero differential light shift between the first and second atomic states. The angle θ may be tuned by selecting the polarization of the emitted light. For instance, when the emitted light is linearly polarized, the total polarizability a may be written as a sum of the scalar component α_{scalar} and the tensor component αₜₑₙₛₒᵣ:

$$α = {α}_{scalar} + ( 3 cos cos {θ}^{2} - 1 ) {α}_{tensor}$$

By choosing θ appropriately, the polarizability of the first and second atomic states may be chosen to be equal or nearly equal, corresponding to a zero or near zero differential light shift and the motion of the atoms may be decoupled.

The light sources may be configured to direct light to one or more optical modulators (OMs) configured to generate the plurality of optical trapping sites. Ffor instance, the optical trapping unit may comprise an OM 214 configured to generate the plurality of optical trapping sites. Although depicted as comprising one OM in FIG. 3A, the optical trapping unit may comprise any number of OMs, such as at least about 1, 2, 3, 4, 5, 6, 7, 8, 9, 10, or more OMs or at most about 10, 9, 8, 7, 6, 5, 4, 3, 2, or 1 OMs. The OMs may comprise one or more digital micromirror devices (DMDs). The OMs may comprise one or more liquid crystal devices, such as one or more liquid crystal on silicon (LCoS) devices. The OMs may comprise one or more spatial light modulators (SLMs). The OMs may comprise one or more acousto-optic deflectors (AODs) or acousto-optic modulators (AOMs). The OMs may comprise one or more electro-optic deflectors (EODs) or electro-optic modulators (EOMs).

The OM may be optically coupled to one or more optical element to generate a regular array of optical trapping sites. For instance, the OM may be optically coupled to optical element 219, as shown in FIG. 3A. The optical elements may comprise lenses or microscope objectives configured to re-direct light from the OMs to form a regular rectangular grid of optical trapping sites.

For instance, as shown in FIG. 3A, the OM may comprise an SLM. DMD, or LCoS device. The SLM, DMD, or LCoS device may be imaged onto the back focal plane of the microscope objectives. This may allow for the generation of an arbitrary configuration of optical trapping sites in two or three dimensions.

Alternatively or in addition, the OMs may comprise first and second AODs. The active regions of the first and second AODs may be imaged onto the back focal plane of the microscope objectives. The output of the first AOD may be optically coupled to the input of the second AOD. In this manner, the second AOD may make a copy of the optical output of the first AOD. This may allow for the generation of optical trapping sites in two or three dimensions.

Alternatively or in addition, the OMs may comprise static optical elements, such as one or more microlens arrays or holographic optical elements. The static optical elements may be imaged onto the back focal plane of the microscope objectives. This may allow for the generation of an arbitrary configuration of optical trapping sites in two or three dimensions.

The optical trapping unit may comprise one or more imaging units configured to obtain one or more images of a spatial configuration of the plurality of atoms trapped within the optical trapping sites. For instance, the optical trapping unit may comprise imaging unit 215. Although depicted as comprising a single imaging unit in FIG. 3A, the optical trapping unit may comprise any number of imaging units, such as at least about 1, 2, 3, 4, 5, 6, 7, 8, 9, 10, or more imaging units or at most about 10, 9, 8, 7, 6, 5, 4, 3, 2, or 1 imaging units. The imaging units may comprise one or more lens or objectives. The imaging units may comprise one or more PMTs, photodiodes, avalanche photodiodes, phototransistors, reverse-biased LEDs. CCDs, or CMOS cameras. The imaging unit may comprise one or more fluorescence detectors. The images may comprise one or more fluorescence images, single-atom fluorescence images, absorption images, single-atom absorption images, phase contrast images, or single-atom phase contrast images.

The optical trapping unit may comprise one or more spatial configuration artificial intelligence (AI) units configured to perform one or more AI operations to determine the spatial configuration of the plurality of atoms trapped within the optical trapping sites based on the images obtained by the imaging unit. For instance, the optical trapping unit may comprise spatial configuration AI unit 216. Although depicted as comprising a single spatial configuration AI unit in FIG. 3A, the optical trapping unit may comprise any number of spatial configuration AI units, such as at least about 1, 2, 3, 4, 5, 6, 7, 8, 9, 10, or more spatial configuration AI units or at most about 10, 9, 8, 7, 6, 5, 4, 3, 2, or 1 spatial configuration AI units. The AI operations may comprise any machine learning (ML) or reinforcement learning (RL) operations described herein.

The optical trapping unit may comprise one or more atom rearrangement units configured to impart an altered spatial arrangement of the plurality of atoms trapped with the optical trapping sites based on the one or more images obtained by the imaging unit. For instance, the optical trapping unit may comprise atom rearrangement unit 217. Although depicted as comprising a single atom rearrangement unit in FIG. 3A, the optical trapping unit may comprise any number of atom rearrangement units, such as at least about 1, 2, 3, 4, 5, 6, 7, 8, 9, 10, or more atom rearrangement units or at most about 10, 9, 8, 7, 6, 5, 4, 3, 2, or 1 atom rearrangement units.

The optical trapping unit may comprise one or more spatial arrangement artificial intelligence (AI) units configured to perform one or more AI operations to determine the altered spatial arrangement of the plurality of atoms trapped within the optical trapping sites based on the images obtained by the imaging unit. For instance, the optical trapping unit may comprise spatial arrangement AI unit 218. Although depicted as comprising a single spatial arrangement AI unit in FIG. 3A, the optical trapping unit may comprise any number of spatial arrangement AI units, such as at least about 1, 2, 3, 4, 5, 6, 7, 8, 9, 10, or more spatial arrangement AI units or at most about 10, 9, 8, 7, 6, 5, 4, 3, 2, or 1 spatial arrangement AI units. The AI operations may comprise any machine learning (ML) or reinforcement learning (RL) operations described herein.

In some cases, the spatial configuration AI units and the spatial arrangement AI units may be integrated into an integrated AI unit. The optical trapping unit may comprise any number of integrated AI units, such as at least about 1, 2, 3, 4, 5, 6, 7, 8, 9, 10, or more integrated AI units, or at most about 10, 9, 8, 7, 6, 5, 4, 3, 2, or 1 integrated AI units.

The atom rearrangement unit may be configured to alter the spatial arrangement in order to obtain an increase in a filling factor of the plurality of optical trapping sites. A filling factor may be defined as a ratio of the number of computationally active optical trapping sites occupied by one or more atoms to the total number of computationally active optical trapping sites available in the optical trapping unit or in a portion of the optical trapping unit. For instance, initial loading of atoms within the computationally active optical trapping sites may give rise to a filling factor of less than 100%, 90%, 80%, 70%, 60%, 50%, or less, such that atoms occupy fewer than 100%, 90%, 70%, 60%, 50%, or less of the available computationally active optical trapping sites, respectively. It may be desirable to rearrange the atoms to achieve a filling factor of at least about 50%, 60%, 70%, 80%, 90%, or 100%. By analyzing the imaging information obtained by the imaging unit, the atom rearrangement unit may attain a filling factor of at least about 50%, 60%, 70%, 80%, 90%, 91%, 92%, 93%, 94%, 95%, 96%, 97%, 98%, 99%, 99.1%, 99.2%, 99.3%, 99.4%, 99.5%, 99.6%. 99.7%, 99.8%, 99.9%, 99.91%, 99.92%, 99.93%, 99.94%, 99.95%, 99.96%, 99.97%, 99.98%, 99.99%, or more. The atom rearrangement unit may attain a filling factor of at most about 99.99%, 99.98%, 99.97%, 99.96%, 99.95%, 99.94%, 99.93%, 99.92%, 99.91%. 99.9%, 99.8%, 99.7%, 99.6%, 99.5%, 99.4%, 99.3%, 99.2%. 99.1%, 99%, 98%, 97%, 96%, 95%, 94%, 93%, 92%, 91%, 90%, 80%, 70%, 60%, 50%, or less. The atom rearrangement unit may attain a filling factor that is within a range defined by any two of the preceding values.

By way of example, FIG. 3C shows an example of an optical trapping unit that is partially filled with atoms. As depicted in FIG. 3C, initial loading of atoms within the optical trapping sites may give rise to a filling factor of 44.4% (4 atoms filling 9 available optical trapping sites). By moving atoms from different regions of the optical trapping unit (not shown in FIG. 3C) to unoccupied optical trapping sites or by moving atoms from an atom reservoir described herein, a much higher filling factor may be obtained, as shown in FIG. 3D.

FIG. 3D shows an example of an optical trapping unit that is completely filled with atoms. As depicted in FIG. 3D, fifth atom 212e, sixth atom 212f, seventh atom 212g, eighth atom 212h, and ninth atom 212i may be moved to fill unoccupied optical trapping sites. The fifth, sixth, seventh, eighth, and ninth atoms may be moved from different regions of the optical trapping unit (not shown in FIG. 3C) or by moving atoms from an atom reservoir described herein. Thus, the filling factor may be substantially improved following rearrangement of atoms within the optical trapping sites. For instance, a filling factor of up to 100% (such 9 atoms filling 9 available optical trapping sites, as shown in FIG. 3D) may be attained.

Atom rearrangement may be performed by (i) acquiring an image of the optical trapping unit, identifying filled and unfilled optical trapping sites, (ii) determining a set of moves to bring atoms from filled optical trapping sites to unfilled optical trapping sites, and (iii) moving the atoms from filled optical trapping sites to unfilled optical trapping sites. Operations (i), (ii), and (iii) may be performed iteratively until a large filling factor is achieved. Operation (iii) may comprise translating the moves identified in operation (ii) to waveforms that may be sent to an arbitrary waveform generator (AWG) and using the AWG to drive AODs to move the atoms. The set of moves may be determined using the Hungarian algorithm described in W. Lee et al, “Defect-Free Atomic Array Formation Using Hungarian Rearrangement Algorithm” Physical Review A 95, 053424 (2017), which is incorporated herein by reference in its entirety for all purposes.

### Example of Ultramagnetic Delivery Units

FIG. 4 shows an example of an electromagnetic delivery unit 220. The electromagnetic delivery unit may be configured to apply electromagnetic energy to one or more atoms of the plurality of atoms, as described herein. The electromagnetic delivery unit may comprise one or more light sources, such as any light source described herein. The electromagnetic energy may comprise optical energy. The optical energy may comprise any repetition rate, pulse energy, average power, wavelength, or bandwidth described herein.

The electromagnetic delivery unit may comprise one or more microwave or radio-frequency (RF) energy sources, such as one or more magnetrons, klystrons, traveling-wave tubes, gyrotrons, field-effect transistors (FETs), tunnel diodes, Gunn diodes, impact ionization avalanche transit-time (IMPATT) diodes, or masers. The electromagnetic energy may comprise microwave energy or RF energy. The RF energy may comprise one or more wavelengths of at least about 1 millimeter (mm). 2 mm, 3 mm, 4 mm, 5 mm, 6 mm, 7 mm, 8 mm, 9 mm, 10 mm, 20 mm, 30 mm. 40 mm, 50 mm, 60 mm, 70 mm, 80 mm, 90 mm, 100 mm. 200 mm, 300 mm, 400 mm, 500 mm, 600 mm, 7M) mm, 800 mm, 900 mm, 1 meter (m), 2 m, 3 m, 4 m, 5 m, 6 m, 7 m, 8 m, 9 m, 10 m, 20 m, 30 m, 40 m. 50 m, 60 m. 70 m, 80 m, 90 m, 100 in, 200 m, 300 m, 400 m. 500 m, 600 m, 700 m, 800 in. 900 in. 1 kilometer (km), 2 km, 3 km, 4 km, 5 km, 6 km, 7 km, 8 km, 9 km, 10 km, or more. The RF energy may comprise one or more wavelengths of at most about 10 km. 9 km. 8 km, 7 km, 6 km, 5 km, 4 km, 3 km. 2 km. 1 km, 900 m, 800 m, 700 m, 600 m, 500 m, 400 in, 300 in. 200 m, 100 m, 90 m, 80 m. 70 m. 60 m, 50 m, 40 m, 30 m, 20 m, 10 in, 9 m. 8 in. 7 m, 6 m, 5 m, 4 m, 3 m, 2 m, I m, 900 mm, 800 mm, 700 mm, 600 mm, 500 mm. 400 mm, 3M) mm, 200 mm, 100 mm, 90 mm, 80 mm, 70 mm, 60 mm, 50 mm, 40 mm, 30 mm, 20 mm, 10 mm. 9 mm, 8 mm, 7 mm, 6 mm. 5 mm, 4 mm, 3 mm, 2 mm, 1 mm, or less. The RF energy may comprise one or more wavelengths that are within a range defined by any two of the preceding values.

The RF energy may comprise an average power of at least about 1 nicrowatt (μW), 2 μW, 3 μW, 4 μW, 5 μW, 6 μW, 7 μW, 8 μW, 9 μW, 10 μW, 20 μW, 30 μW, 40 μW, 50 μW, 60 μW, 70 μW, 80 μW, 90 μW, 100 μW, 200 μW, 300 μW, 4(X) pW, 500 μW, 600 μW, 700 μW, 800 μW, 900 μW, 1 milliwatt (mW), 2 mW, 3 mW, 4 mW, 5 mW, 6 mW, 7 mW, 8 mW, 9 mW, 10 mW, 20 mW, 30 mW, 40 mW, 50 mW, 60 mW, 70 mW, 80 mW, 90 mW, 100 mW, 200 mW, 300 mW, 400 mW, 500 mW, 600 mW, 700 mW, 800 mW, 900 mW, 1 Watt (W), 2 W, 3 W, 4 W, 5 W, 6 W, 7 W, 8 W, 9 W, 10 W, 20 W, 30 W, 40 W, 50 W, 60 W, 70 W, 80 W, 90 W, 1(0) W, 200 W, 300 W, 400 W, 500 W, 600 W, 700 W, 800 W, 900 W, 1,000 W, or more. The RF energy may comprise an average power of at most about 1,000 W, 900 W, 800 W, 700 W, 600 W, 500 W, 400 W, 300 W, 200 W, 100 W, 90 W, 80 W, 70 W, 60 W, 50 W, 40 W, 30 W, 20 W. 10 W, 9 W, 8 W, 7 W, 6 W, 5 W, 4 W, 3 W, 2 W, 1 W, 900 mW, 800 mW, 700 mW, 600 mW, 500 mW, 400 mW, 30( ) mW, 200 mW, 100 mW, 90 mW, 80 mW, 70 mW, 60 mW, 50 mW, 40 mW, 30 mW, 20 mW, 10 mW, 9 mW, 8 mW, 7 mW, 6 mW, 5 mW, 4 mW, 3 mW, 2 mW, 1 mW, 900 pW, 800 pW, 700 pW, 600 pW, 500 pW, 400 pW, 300 pW, 200 pW, 100 pW, 90 pW, 80 pW, 70 pW, 60 pW, 50 pW, 40 pW, 30 pW, 20 pW, 10 pW, 9 pW, 8 pW, 7 pW, 6 pW, 5 pW, 4 pW, 3 pW, 2 pW, 1 pW, or less. The RF energy may comprise an average power that is within a range defined by any two of the preceding values.

The electromagnetic delivery unit may comprise one or more light sources, such as any light source described herein. For instance, the electromagnetic delivery unit may comprise light source 221. Although depicted as comprising a single light source in FIG. 4, the electromagnetic delivery unit may comprise any number of light sources, such as at least about 1, 2, 3, 4, 5, 6, 7, 8, 9, 10, or more light sources or at most about 10, 9, 8, 7, 6, 5, 4, 3, 2, or 1 light sources.

The light sources may be configured to direct light to one or more OMs configured to selectively apply the electromagnetic energy to one or more atoms of the plurality of atoms. For instance, the electromagnetic delivery unit may comprise OM 222. Although depicted as comprising a single OM in FIG. 4, the electromagnetic delivery unit may comprise any number of OMs, such as at least about 1, 2, 3, 4, 5, 6, 7, 8, 9, 10, or more OMs or at most about 10, 9, 8, 7, 6, 5, 4, 3, 2, or 1 OMs. The OMs may comprise one or more SLMs, AODs, or AOMs. The OMs may comprise one or more DMDs. The OMs may comprise one or more liquid crystal devices, such as one or more LCoS devices.

The electromagnetic delivery unit may comprise one or more electromagnetic energy artificial intelligence (AI) units configured to perform one or more AI operations to selectively apply the electromagnetic energy to the atoms. For instance, the electromagnetic delivery unit may comprise AI unit 223. Although depicted as comprising a single AI unit in FIG. 4, the electromagnetic delivery unit may comprise any number of AI units, such as at least about 1, 2, 3, 4, 5, 6, 7, 8, 9, 10, or more AI units or at most about 10, 9, 8, 7, 6, 5, 4, 3, 2, or 1 AI units. The AI operations may comprise any machine learning (ML) or reinforcement learning (RL) operations described herein.

The electromagnetic delivery unit may be configured to apply one or more single-qubit operations (such as one or more single-qubit gate operations) on the qubits described herein. The electromagnetic delivery unit may be configured to apply one or more two-qubit operations (such as one or more two-qubit gate operations) on the two-qubit units described herein. Each single-qubit or two-qubit operation may comprise a duration of at least about 10 nanoseconds (ns), 20 ns. 30 ns, 40 ns, 50 ns, 60 ns, 70 ns, 80 ns, 90 ns, 100 ns, 200 ns, 300 ns. 400 ns, 500 ns. 600 ns, 700 ns, 800 ns, 900 ns, I microsecond (μs), 2 μs, 3 μs, 4 μs. 5 μs. 6 μs. 7 μs. 8 μs, 9 μs, 10 μs, 20 μs, 30 μs, 40 μs, 50 μs, 60 μs, 70 μs, 80 μs, 90 μs, 100 μs, or more. Each single-qubit or two-qubit operation may comprise a duration of at most about 100 μs, 90 μs, 80 μs, 70 μs, 60 μs, 50 μs. 40 μs. 30 μs. 20 μs, 10 μs, 9 μs, 8 μs. 7 μs. 6 μs. 5 μs. 4 μs. 3 μs, 2 μs, 1 μs, 900 ns, 800 ns. 700 ns. 600 ns, 500 ns, 400 ns, 300 ns, 200 ns, 100 ns, 90 ns, 80 ns, 70 ns, 60 ns, 50 ns, 40 ns, 30 ns, 20 ns, 10 ns, or less. Each single-qubit or two-qubit operation may comprise a duration that is within a range defined by any two of the preceding values. The single-qubit or two-qubit operations may be applied with a repetition frequency of at least 1 kilohertz (kHz), 2 kHz. 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1.000 kHz, or more. The single-qubit or two-qubit operations may be applied with a repetition frequency of at most 1,000 kHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, or less. The single-qubit or two-qubit operations may be applied with a repetition frequency that is within a range defined by any two of the preceding values.

The electromagnetic delivery unit may be configured to apply one or more single-qubit operations by inducing one or more Raman transitions between a first qubit state and a second qubit state described herein. The Raman transitions may be detuned from a ³P₀ or ³P₁ line described herein. For instance, the Raman transitions may be detuned by at least about 1 kHz, 2 kHz, 3 kHz, 4 kHz, 5 kHz, 6 kHz, 7 kHz, 8 kHz, 9 kHz, 10 kHz, 20 kHz, 30 kHz, 40 kHz, 50 kHz, 60 kHz, 70 kHz, 80 kHz, 90 kHz, 100 kHz, 200 kHz, 300 kHz, 400 kHz, 500 kHz, 600 kHz, 700 kHz, 800 kHz, 900 kHz, 1 MHz, 2 MHz, 3 MHz, 4 MHz, 5 MHz, 6 MHz, 7 MHz, 8 MHz, 9 MHz, 10 MHz, 20 MHz, 30 MHz, 40 MHz, 50 MHz, 60 MHz, 70 MHz, 80 MHz, 90 MHz, 100 MHz, 200 MHz, 300 MHz, 400 MHz, 500 MHz, 600 MHz, 700 MHz, 800 MHz, 900 MHz, 1 GHz, or more. The Raman transitions may be detuned by at most about 1 GHz. 900 MHz, 800 MHz, 700 MHz. 600 MHz, 500 MHz, 400 MHz, 300 MHz, 200 MHz, 100 MHz, 90 MHz, 80 MHz, 70 MHz, 60 MHz, 50 MHz, 40 MHz, 30 MHz, 20 MHz, 10 MHz, 9 MHz, 8 MHz, 7 MHz, 6 MHz, 5 MHz, 4 MHz, 3 MHz, 2 MHz, 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz, 60 kHz, 50 kHz, 40 kHz, 30 kHz, 20 kHz, 10 kHz, 9 kHz, 8 kHz, 7 kHz, 6 kHz, 5 kHz, 4 kHz, 3 kHz, 2 kHz, 1 kHz, or less. The Raman transitions may be detuned by a value that is within a range defined by any two of the preceding values.

Raman transitions may be induced on individually selected atoms using one or more spatial light modulators (SLMs) or acousto-optic deflectors (AODs) to impart a deflection angle and/or a frequency shift to a light beam based on an applied radio-frequency (RF) signal. The SLM or AOD may be combined with an optical conditioning system that images the SLM or AOD active region onto the back focal plane of a microscope objective. The microscope objective may perform a spatial Fourier transform on the optical field at the position of the SLM or AOD. As such, angle (which may be proportional to RF frequency) may be converted into position. For example, applying a comb of radio frequencies to an AOD may generate a linear array of spots at a focal plane of the objective, with each spot having a finite extent determined by the characteristics of the optical conditioning system (such as the point spread function of the optical conditioning system).

To perform a Raman transition on a single atom with a single SLM or AOD, a pair of frequencies may be applied to the SLM or AOD simultaneously. The two frequencies of the pair may have a frequency difference that matches or nearly matches the splitting energy between the first and second qubit states. For instance, the frequency difference may differ from the splitting energy by at most about 1 MHz, 900 kHz, 800 kHz, 700 kHz, 600 kHz, 500 kHz, 400 kHz, 300 kHz, 200 kHz, 100 kHz, 90 kHz, 80 kHz, 70 kHz. 60 kHz. 50 kHz, 40 kHz, 30 kHz, 20 kHz, 10 kHz, 9 kHz, 8 kHz. 7 kHz, 6 kHz, 5 kHz, 4 kHz, 3 kHz, 2 kHz, I kHz, 900 Hz, 800 Hz, 700 Hz, 600 Hz, 500 Hz, 400 Hz, 300 Hz, 200 Hz, 100 Hz, 90 Hz, 80 Hz, 70 Hz, 60 Hz, 50 Hz, 40 Hz, 30 Hz, 20 Hz, 10 Hz, 9 Hz, 8 Hz, 7 Hz, 6 Hz, 5 Hz, 4 Hz, 3 Hz, 2 Hz, 1 Hz, or less. The frequency difference may differ from the splitting energy by at least about 1 Hz, 2 Hz, 3 Hz, 4 Hz, 5 Hz, 6 Hz, 7 Hz, 8 Hz, 9 Hz, 10 Hz, 20 Hz, 30 Hz, 40 Hz, 50 Hz, 60 Hz, 70 Hz, 80 Hz, 90 Hz, 100 Hz, 200 Hz. 300 Hz, 400 Hz, 500 Hz, 600 Hz, 700 Hz, 800 Hz, 900 Hz, 1 kHz, 2 kHz. 3 kHz. 4 kHz, 5 kHz. 6 kHz, 7 kHz, 8 kHz, 9 kHz, 10 kHz, 20 kHz. 30 kHz. 40 kHz. 50 kHz, 60 kHz, 70 kHz, 80 kHz. 90 kHz, 10 kHz, 200 kHz, 300 kHz, 400 kHz, 500 kHz, 600 kHz, 700 kHz, 800 kHz, 900 kHz, 1 MHz, or more. The frequency difference may differ from the splitting energy by about 0 Hz. The frequency difference may differ from the splitting energy by a value that is within a range defined by any two of the preceding values. The optical system may be configured such that the position spacing corresponding to the frequency difference is not resolved and such that light at both of the two frequencies interacts with a single atom.

The electromagnetic delivery units may be configured to provide a beam with a characteristic dimension of at least about 10 nm, 50 nm, 75 nm, 1(0 nm, 125 nm, 150 nm, 175 nm, 200 nm, 225 nm, 250 nm, 275 nm, 300 nm, 325 nm, 350 nm, 375 nm, 400 nm, 425 nm, 450 nm, 475 nm, 500 nm, 525 nm, 550 nm, 575 nm, 600 nm, 625 nm, 650 nm, 675 nm, 700 nm, 725 nm, 750 nm, 775 nm, 800 nm, 825 nm, 850 nm, 875 nm, 900 nm, 925 nm, 950 nm, 975 nm, 1 micrometer (μm), 1.5 μm, 2 μm, 2.5 μm 3 μm, 3.5 μm, 4 μm, 4.5 μm, 5 μm, 5.5 μm, 6 μm, 6.5 μm, 7 μm, 7.5 μm, 8 μm, 8.5 μm, 9 μm, 9.5 μm. 10 μm, or more. The electromagnetic delivery units may be configured to provide a beam with a characteristic dimension of at most about 10 μm, 9.5 μm, 9 μm, 8.5 μm, 8 μm, 7.5 μm, 7 μm. 6.5 μm, 6 μm, 5.5 μm, 5 μm, 4.5 μm, 4 μm, 3.5 μm. 3 μm, 2.5 μm, 2 μm, 1.5 μm, 1 μm, 975 nm, 950 nm, 925 nm, 900 nm, 875 nm, 850 nm, 825 nm, 800 nm, 775 nm, 750 nm, 725 nm, 700 nm, 675 nm, 650 nm, 625 nm, 600 nm, 575 nm, 550 nm, 525 nm, 500 nm, 475 nm, 450 nm, 425 nm, 400 nm, 375 nm, 350 nm, 325 nm, 300 nm, 275 nm, 250 nm, 225 nm, 200 nm, 175 nm, 150 nm, 125 nm, 100 nm, 75 nm, 25 nm, 10 nm, or less. The electromagnetic delivery units may be configured to provide a beam with a characteristic dimension as defined by any two of the proceeding values. For example, the beam can have a characteristic dimension of about 1.5 micrometers to about 2.5 micrometers. Examples of characteristic dimensions include, but are not limited to, a Gaussian beam waist, the full width at half maximum (FWHM) of the beam size, the beam diameter, the 1/e² width, the D4σ width, the D86 width, and the like. For example, the beam may have a Gaussian beam waist of at least about 1.5 micrometers.

The characteristic dimension of the beam may be bounded at the low end by the size of the atomic wavepacket of an optical trapping site. For example, the beam can be formed such that the intensity variation of the beam over the trapping site is sufficiently small as to be substantially homogeneous over the trapping site. In this example, the beam homogeneity can improve the fidelity of a qubit in the trapping site. The characteristic dimension of the beam may be bounded at the high end by the spacing between trapping sites. For example, a beam can be formed such that it is small enough that the effect of the beam on a neighboring trapping site/atom is negligible. In this example, the effect may be negligible if the effect can be minimized by techniques such as, for example, composite pulse engineering. The characteristic dimension may be different from a maximum achievable resolution of the system. For example, a system can have a maximum resolution of 700 nm, but the system may be operated at 1.5 micrometers. In this example, the value of the characteristic dimension may be selected to optimize the performance of the system in view of the considerations described elsewhere herein. The characteristic dimension may be invariant for different maximally achievable resolutions. For example, a system with a maximum resolution of 500 nm and a system with a maximum resolution of 2 micrometers may both be configured to operate at a characteristic dimension of 2 micrometers. In this example, 2 micrometers may be the optimal resolution based on the size of the trapping sites.

### Example of Integrated Optical Trapping Units and Electromagnetic Delivery Units

The optical trapping units and electromagnetic delivery units described herein may be integrated into a single optical system. A microscope objective may be used to deliver electromagnetic radiation generated by an electromagnetic delivery unit described herein and to deliver light for trapping atoms generated by an optical trapping unit described herein. Alternatively or in addition, different objectives may be used to deliver electromagnetic radiation generated by an electromagnetic delivery unit and to deliver light from trapping atoms generated by an optical trapping unit.

A single SLM or AOD may allow the implementation of qubit operations (such as any single-qubit or two-qubit operations described herein) on a linear array of atoms. Alternatively or in addition, two separate SLMs or AODs may be configured to each handle light with orthogonal polarizations. The light with orthogonal polarizations may be overlapped before the microscope objective. In such a scheme, each photon used in a two-photon transition described herein may be passed to the objective by a separate SLM or AOD, which may allow for increased polarization control. Qubit operations may be performed on a two-dimensional arrangement of atoms by bringing light from a first SLM or AOD into a second SLM or AOD that is oriented substantially orthogonally to the first SLM or AOD via an optical relay. Alternatively or in addition, qubit operations may be performed on a two-dimensional arrangement of atoms by using a one-dimensional array of SLMs or AODs.

The stability of qubit gate fidelity may be improved by maintaining overlap of light from the various light sources described herein (such as light sources associated with the optical trapping units or electromagnetic delivery units described herein). Such overlap may be maintained by an optical subsystem that measures the direction of light emitted by the various light sources, allowing closed-loop control of the direction of light emission. The optical subsystem may comprise a pickoff mirror located before the microscope objective. The pickoff mirror may be configured to direct a small amount of light to a lens, which may focus a collimated beam and convert angular deviation into position deviation. A position-sensitive optical detector, such as a lateral-effect position sensor or quadrant photodiode, may convert the position deviation into an electronic signal and information about the deviation may be fed into a compensation optic, such as an active mirror.

The stability of qubit gate manipulation may be improved by controlling the intensity of light from the various light sources described herein (such as light sources associated with the optical trapping units or electromagnetic delivery units described herein). Such intensity control may be maintained by an optical subsystem that measures the intensity of light emitted by the various light sources, allowing closed-loop control of the intensity. Each light source may be coupled to an intensity actuator, such as an intensity servo control. The actuator may comprise an acousto-optic modulator (AOM) or electro-optic modulator (EOM). The intensity may be measured using an optical detector, such as a photodiode or any other optical detector described herein. Information about the intensity may be integrated into a feedback loop to stabilize the intensity.

### Example of State Preparation Units

FIG. 5 shows an example of a state preparation unit 250. The state preparation unit may be configured to prepare a state of the plurality of atoms, as described herein. The state preparation unit may be coupled to the optical trapping unit and may direct atoms that have been prepared by the state preparation unit to the optical trapping unit. The state preparation unit may be configured to cool the plurality of atoms. The state preparation unit may be configured to cool the plurality of atoms prior to trapping the plurality of atoms at the plurality of optical trapping sites.

The state preparation unit may comprise one or more Zeeman slowers. For instance, the state preparation unit may comprise a Zeeman slower 251. Although depicted as comprising a single Zeeman slower in FIG. 5, the state preparation may comprise any number of Zeeman slowers, such as at least about 1, 2, 3, 4, 5, 6, 7, 8, 9, 10, or more Zeeman slowers or at most about 10, 9, 8, 7, 6, 5, 4, 3, 2, or 1 Zeeman slowers. The Zeeman slowers may be configured to cool one or more atoms of the plurality of atoms from a first velocity or distribution of velocities (such an emission velocity from an of an atom source, room temperature, liquid nitrogen temperature, or any other temperature) to a second velocity that is lower than the first velocity or distribution of velocities.

The first velocity or distribution of velocities may be associated with a temperature of at least about 50 Kelvin (K), 60 K, 70 K, 80 K, 90 K, 100 K, 200 K, 300 K, 400 K, 500 K, 600 K, 700 K, 800 K, X)0 K, 1,000 K, or more. The first velocity or distribution of velocities may be associated with a temperature of at most about 1,000 K, 900 K, 800 K, 700 K, 600 K, 500 K, 400 K, 300 K. 200 K, 100 K. 90 K, 80 K, 70 K, 60 K, 50 K, or less. The first velocity or distribution of velocities may be associated with a temperature that is within a range defined by any two of the preceding values. The second velocity may be at least about 1 meter per second (m/s), 2 m/s, 3 m/s, 4 m/s, 5 m/s, 6 m/s, 7 m/s, 8 m/s. 9 m/s, 10 m/s, or more. The second velocity may be at most about 10 m/s, 9 m/s, 8 m/s, 7 m/s, 6 m/s, 5 m/s, 4 m/s, 3 m/s, 2 m/s, 1 m/s, or less. The second velocity may be within a range defined by any two of the preceding values. The Zeeman slowers may comprise 1D Zeeman slowers.

The state preparation unit may comprise a first magneto-optical trap (MOT) 252. The first MOT may be configured to cool the atoms to a first temperature. The first temperature may be at most about 10 millikelvin (mK), 9 mK, 8 mK, 7 mK, 6 mK. 5 mK, 4 mK, 3 mK, 2 mK, 1 mK, 0.9 mK, 0.8 mK. 0.7 mK, 0.6 mK, 0.5 mK, 0.4 mK, 0.3 mK. 0.2 mK, 0.1 mK, or less. The first temperature may be at least about 0.1 mK. 0.2 mK, 0.3 mK, 0.4 mK. 0.5 mK, 0.6 mK, 0.7 mK, 0.8 mK, 0.9 mK, 1 mK, 2 mK, 3 mK, 4 mK, 5 mK. 6 mK, 7 mK, 8 mK, 9 mK, 10 mK, or more.

The first temperature may be within a range defined by any two of the preceding values. The first MOT may comprise a 1D, 2D, or 3D MOT.

The first MOT may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,(X)0 nm, or more. The light may comprise one or more wavelengths of at most about 1,000 nm. 9YX) nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm. 730 nm, 720 nm, 710 nm, 700 nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 rnm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 60 nm, 400 nm to 5X) nm, 5X) nm to 700 nm, or 650 nm to 700 nm.

The state preparation unit may comprise a second MOT 253. The second MOT may be configured to cool the atoms from the first temperature to a second temperature that is lower than the first temperature. The second temperature may be at most about 100 microkelvin (PK), 90 pK, 80 pK, 70 pK, 60 pK, 50 pK, 40 pK, 30 pK, 20 pK, 10 pK, 9 pK, 8 pK, 7 pK, 6 pK, 5 pK, 4 pK, 3 pK, 2 pK, 1 pK, 900 nanokelvin (nK), 800 nK, 700 nK, 600 nK, 500 nK, 400 nK, 300 nK, 200 nK, 100 nK, or less. The second temperature may be at least about 100 nK, 200 nK, 300 nK, 400 nK, 500 nK, 600 nK, 700 nK, 800 nK, 900 nK, 1 pK, 2 pK, 3 pK, 4 pK, 5 pK, 6 pK, 7 pK, 8 pK, 9 pK, 10 pK, 20 pK, 30 pK, 40 pK, 50 pK, 60 pK, 70 pK, 80 pK, 90 pK, 100 pK, or more. The second temperature may be within a range defined by any two of the preceding values. The second MOT may comprise a 1D, 2D, or 3D MOT.

The second MOT may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm 870 nm, 860 nm, 850 nm. 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm, 640 nm, 630 rnm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

Although depicted as comprising two MOTs in FIG. 5, the state preparation unit may comprise any number of MOTs, such as at least about 1, 2, 3, 4, 5, 6, 7, 8, 9, 10, or more MOTs or at most about 10, 9, 8, 7, 6, 5, 4, 3, 2, or 1 MOTs.

The state preparation unit may comprise one or more sideband cooling units or Sisyphus cooling units (such as a sideband cooling unit described in www.arxiv.org/abs/1810.06626 or a Sisyphus cooling unit described in www.arxiv.org/abs/1811.06014, each of which is incorporated herein by reference in its entirety for all purposes). For instance, the state preparation unit may comprise sideband cooling unit or Sisyphus cooling unit 254. Although depicted as comprising a single sideband cooling unit or Sisyphus cooling unit in FIG. 5, the state preparation may comprise any number of sideband cooling units or Sisyphus cooling units, such as at least about 1, 2, 3, 4, 5, 6, 7, 8, 9, 10, or more sideband cooling units or Sisyphus cooling units, or at most about 10, 9, 8, 7, 6, 5, 4, 3, 2, or 1 sideband cooling units or Sisyphus cooling units. The sideband cooling units or Sisyphus cooling units may be configured to use sideband cooling to cool the atoms from the second temperature to a third temperature that is lower than the second temperature. The third temperature may be at most about 10 μK, 9 pK, 8 pK, 7 pK, 6 pK, 5 pK, 4 pK, 3 pK, 2 pK, I pK, 900 nK, 800 nK, 700 nK, 600 nK, 500 nK, 400 nK, 300 nK, 200 nK, 100 nK, 90 nK, 80 nK, 70 nK, 60 nK, 50 nK, 40 nK, 30 nK, 20 nK, 10 nK, or less. The third temperature may be at most about 10 nK, 20 nK, 30 nK, 40 nK, 50 nK, 60 nK, 70 nK, 80 nK, 90 nK, 100 nK, 200 nK, 300 nK, 400 nK, 500 nK, 600 nK, 700 nK, 800 nK, 900 nK, 1 pK, 2 pK, 3 pK, 4 pK, 5 pK, 6 pK, 7 pK, 8 pK, 9 pK, 10 pK, or more. The third temperature may be within a range defined by any two of the preceding values.

The sideband cooling units or Sisyphus cooling units may comprise one or more light sources (such as any light source described herein) configured to emit light. The light may comprise one or more wavelengths of at least about 400 nm, 410 nm, 420 nm, 430 nm, 440 nm. 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm, 650 nm, 660 nm. 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm. 990 nm, 980 nm, 970 nm, 960 nm, 950 nm, 940 nm, 930 nm, 920 nm, 910 nm, 9(0 nm, 890 nm, 880 nm, 870 nm, 860 nm, 850 nm, 840 nm, 830 nm, 820 nm, 810 nm, 800 nm, 790 nm, 780 nm, 770 nm, 760 nm, 750 nm, 740 nm, 730 nm, 720 nm, 710 nm, 700 nm, 690 nm, 680 nm, 670 nm. 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 50 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm. 400r nm to 500 nm, 500 nm to 700 nm, or 650 nm to 700 nm.

The state preparation unit may comprise one or more optical pumping units. For instance, the state preparation unit may comprise optical pumping unit 255. Although depicted as comprising a single optical pumping unit in FIG. 5, the state preparation may comprise any number of optical pumping units, such as at least about 1, 2, 3, 4, 5, 6, 7, 8, 9, 10, or more optical pumping units, or at most about 10, 9, 8, 7, 6, 5, 4, 3, 2, or 1 optical pumping units. The optical pumping units may be configured to emit light to optically pump the atoms from an equilibrium distribution of atomic states to a non-equilibrium atomic state. For instance, the optical pumping units may be configured to emit light to optically pump the atoms from an equilibrium distribution of atomic states to a single pure atomic state. The optical pumping units may be configured to emit light to optically pump the atoms to a ground atomic state or to any other atomic state. The optical pumping units may be configured to optically pump the atoms between any two atomic states. The optical pumping units may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm 480 nm 490 nm, 500 nm, 510 nm, 520 nm, 530 nm, 540 nm, 550 nm, 560 nm, 570 nm, 580 nm 590 nm, 600 nm, 610 nm, 620 nm, 630 nm, 640 nm, 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm 900 nm, 910 nm, 920 nm, 930 nm 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm 800 nm, 790 nm, 780 nm, 770 nm, 760 nm, 750 nm, 740 nm, 730 nm, 720 nm, 710 nm, 700 nm, 690 nm, 680 nm, 670 nm, 660 nm, 650 nm. 640 nm, 630 nm, 620 nm, 610 nm, 600 nm, 590 nm, 580 nm, 570 nm, 560 nm, 550 nm, 540 nm. 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nnm 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nm.

The state preparation unit may comprise one or more coherent driving units. For instance, the state preparation unit may comprise coherent driving unit 256. Although depicted as comprising a coherent driving unit in FIG. 5, the state preparation may comprise any number of coherent driving units, such as at least about 1, 2, 3, 4, 5, 6, 7, 8, 9, 10, or more coherent driving units or at most about 10, 9, 8, 7, 6, 5, 4, 3, 2, or 1 coherent driving units. The coherent driving units may be configured to coherently drive the atoms from the non-equilibrium state to the first or second atomic states described herein. Thus, the atoms may be optically pumped to an atomic state that is convenient to access (for instance, based on availability of light sources that emit particular wavelengths or based on other factors) and then coherently driven to atomic states described herein that are useful for performing quantum computations. The coherent driving units may be configured to induce a single photon transition between the non-equilibrium state and the first or second atomic state. The coherent driving units may be configured to induce a two-photon transition between the non-equilibrium state and the first or second atomic state. The two-photon transition may be induced using light from two light sources described herein (such as two lasers described herein).

The coherent driving units may comprise one or more light sources (such as any light source described herein) configured to emit light. The light may comprise one or more wavelengths of at least about 400 nm, 410 nm, 420 nm, 430 nm, 440 nm, 450 nm, 460 nm, 470 nm, 480 nm, 490 nm, 500 nm, 510 nm, 520 nm, 530 nm, 540 nm, 550 nm, 560 nm, 570 nm, 580 nm, 590 nm, 600 nm, 610 nm, 620 nm, 630 nm, 640 nm 650 nm, 660 nm, 670 nm, 680 nm, 690 nm, 700 nm, 710 nm, 720 nm, 730 nm, 740 nm, 750 nm, 760 nm, 770 nm, 780 nm, 790 nm, 800 nm, 810 nm, 820 nm, 830 nm, 840 nm, 850 nm, 860 nm, 870 nm, 880 nm, 890 nm, 900 nm, 910 nm, 920 nm, 930 nm, 940 nm, 950 nm, 960 nm, 970 nm, 980 nm, 990 nm, 1,000 nm, or more. The light may comprise one or more wavelengths of at most about 1,000 nm, 990 nm, 980 nm, 970 nm, 960 nm, 950 nm, 940 nm, 930 nm, 920 nm, 910 nm, 900 nm, 890 nm, 880 nm, 870 nm, 860 nm, 850 nm, 840 nm, 830 nm, 820 nm, 810 nm, 800 nm, 790 nm, 780 mm, 770 nm, 760 nm, 750 nm, 740 nm, 730 nm, 720 nm, 710 nm. 700r nm, 690 nm, 680 nm, 670 nm, 660 nm, 650 nm, 640 nm, 630 nm, 620 nm, 610 nm, 600 nm, 590 nm, 580 nm, 570 nm, 560 nm, 550 nm, 540 nm, 530 nm, 520 nm, 510 nm, 500 nm, 490 nm, 480 nm, 470 nm, 460 nm, 450 nm, 440 nm, 430 nm, 420 nm, 410 nm, 400 nm, or less. The light may comprise one or more wavelengths that are within a range defined by any two of the preceding values. For instance, the light may comprise one or more wavelengths that are within a range from 400 nm to 1,000 nm, 500 nm to 1,000 nm, 600 nm to 1,000 nm, 650 nm to 1,000 nm, 400 nm to 900 nm, 400 nm to 800 nm, 400 nm to 700 nm, 400 nm to 600 nm, 400 nm to 500 nm, 500 nm to 700 nm, or 650 nm to 700 nn.

The coherent driving units may be configured to induce an RF transition between the non-equilibrium state and the first or second atomic state. The coherent driving units may comprise one or more electromagnetic radiation sources configured to emit electromagnetic radiation configured to induce the RF transition. For instance, the coherent driving units may comprise one or more RF sources (such as any RF source described herein) configured to emit RF radiation. The RF radiation may comprise one or more wavelengths of at least about 10 centimeters (cm), 20 cm, 30 cm, 40 cm, 50 cm, 60 cm, 70 cm. 80 cm, 90 cm. 1 meter (m), 2 m, 3 in, 4 m, 5 m, 6 in, 7 m, 8 m, 9 in, 10 m, or more. The RF radiation may comprise one or more wavelengths of at most about 10 in, 9 m, 8 m, 7 m, 6 m, 5 m, 4 in, 3 m, 2 m. 1 m, 90 cm, 80 cm, 70 cm, 60 cm, 50 cm, 40 cm, 30 cm, 20 cm, 10 cm, or less. The RF radiation may comprise one or more wavelengths that are within a range defined by any two of the preceding values. Alternatively or in addition, the coherent driving units may comprise one or more light sources (such as any light sources described herein) configured to induce a two-photon transition corresponding to the RF transition.

### Example of Controllers

The optical trapping units, electromagnetic delivery units, entanglement units, readout optical units, vacuum units, imaging units, spatial configuration AI units, spatial arrangement AI units, atom rearrangement units, state preparation units, sideband cooling units, optical pumping units, coherent driving units, electromagnetic energy AI units, atom reservoirs, atom movement units, or Rydberg excitation units may include one or more circuits or controllers (such as one or more electronic circuits or controllers) that is connected (for instance, by one or more electronic connections) to the optical trapping units, electromagnetic delivery units, entanglement units, readout optical units, vacuum units, imaging units, spatial configuration AI units, spatial arrangement AI units, atom rearrangement units, state preparation units, sideband cooling units, optical pumping units, coherent driving units, electromagnetic energy AI units, atom reservoirs, atom movement units, or Rydberg excitation units. The circuits or controllers may be configured to control the optical trapping units, electromagnetic delivery units, entanglement units, readout optical units, vacuum units, imaging units, spatial configuration AI units, spatial arrangement AI units, atom rearrangement units, state preparation units, sideband cooling units, optical pumping units, coherent driving units, electromagnetic energy AI units, atom reservoirs, atom movement units, or Rydberg excitation units.

### Example of Non-Classical Computers

In an aspect, the present disclosure provides a non-classical computer comprising: a plurality of qubits comprising greater than 60 atoms, each atom trapped within an optical trapping site of a plurality of spatially distinct optical trapping sites, wherein the plurality of qubits comprise at least a first qubit state and a second qubit state, wherein the first qubit state comprises a first atomic state and the second qubit state comprises a second atomic state; one or more electromagnetic delivery units configured to apply electromagnetic energy to one or more qubits of the plurality of qubits, thereby imparting a non-classical operation to the one or more qubits, which non-classical operation includes a superposition between at least the first qubit state and the second qubit state; one or more entanglement units configured to quantum mechanically entangle at least a subset of the plurality of qubits in the superposition with at least another qubit of the plurality of qubits; and one or more readout optical units configured to perform one or more measurements of the one or more qubits, thereby obtaining a non-classical computation.

In an aspect, the present disclosure provides a non-classical computer comprising a plurality of qubits comprising greater than 60 atoms each trapped within an optical trapping site of a plurality of spatially distinct optical trapping sites.

### Example of Methods for Performing a Non-Classical Computation

In an aspect, the present disclosure provides a method for performing a non-classical computation, comprising: (a) generating a plurality of spatially distinct optical trapping sites, the plurality of optical trapping sites configured to trap a plurality of atoms, the plurality of atoms comprising greater than 60 atoms: (b) applying electromagnetic energy to one or more atoms of the plurality of atoms, thereby inducing the one or more atoms to adopt one or more superposition states of a first atomic state and at least a second atomic state that is different from the first atomic state: (c) quantum mechanically entangling at least a subset of the one or more atoms in the one or more superposition states with at least another atom of the plurality of atoms; and (d) performing one or more optical measurements of the one or more superposition state to obtain the non-classical computation.

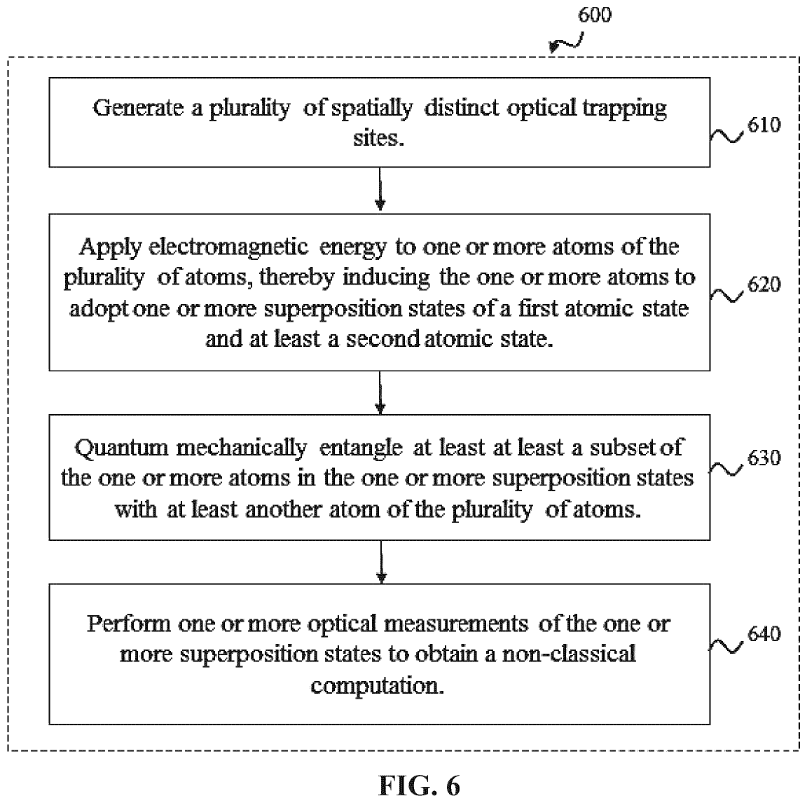

FIG. 6 shows a flowchart for an example of a first method 600 for performing a non-classical computation.

In a first operation 610, the method 600 may comprise generating a plurality of spatially distinct optical trapping sites. The plurality of optical trapping sites may be configured to trap a plurality of atoms. The plurality of atoms may comprise greater than 60 atoms. The optical trapping sites may comprise any optical trapping sites described herein. The atoms may comprise any atoms described herein.

In a second operation 620, the method 600 may comprise applying electromagnetic energy to one or more atoms of the plurality of atoms, thereby inducing the one or more atoms to adopt one or more superposition states of a first atomic state and at least a second atomic state that is different from the first atomic state. The electromagnetic energy may comprise any electromagnetic energy described herein. The first atomic state may comprise any first atomic state described herein. The second atomic state may comprise any second atomic state described herein.

In a third operation 630, the method 600 may comprise quantum mechanically entangling at least a subset of the one or more atoms in the one or more superposition states with at least another atom of the plurality of atoms. The atoms may be quantum mechanically entangled in any manner described herein (for instance, as described herein with respect to FIG. 2).

In a fourth operation 640, the method 600 may comprise performing one or more optical measurements of the one or more superposition state to obtain the non-classical computation. The optical measurements may comprise any optical measurements described herein.

In an aspect, the present disclosure provides a method for performing anon-classical computation, comprising: (a) providing a plurality of qubits comprising greater than 60 atoms, each atom trapped within an optical trapping site of a plurality of spatially distinct optical trapping sites, wherein the plurality of qubits comprise at least a first qubit state and a second qubit state, wherein the first qubit state comprises a first atomic state and the second qubit state comprises a second atomic state: (b) applying electromagnetic energy to one or more qubits of the plurality of qubits, thereby imparting a non-classical operation to the one or more qubits, which non-classical operation includes a superposition between at least the first qubit state and the second qubit state; (c) quantum mechanically entangling at least a subset of the plurality of qubits in the superposition with at least another qubit of the plurality of qubits; and (d) performing one or more optical measurements of the one or more qubits, thereby obtaining said the-classical computation.

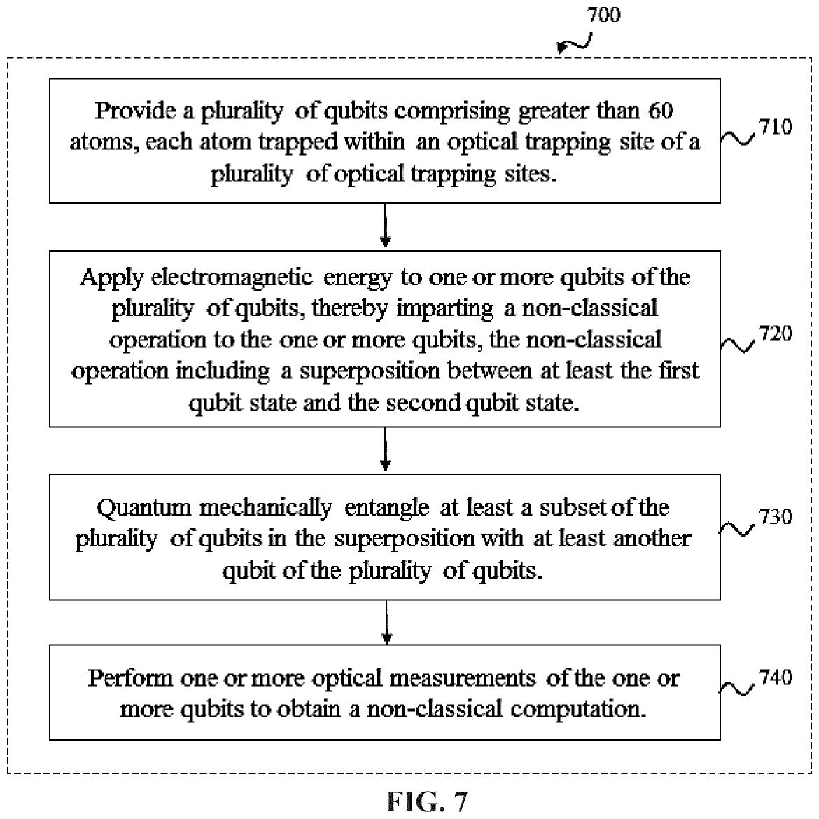

FIG. 7 shows a flowchart for an example of a second method 700 for performing a non-classical computation.

In a first operation 710, the method 700 may comprise providing a plurality of qubits comprising greater than 60 atoms, each atom trapped within an optical trapping site of a plurality of spatially distinct optical trapping sites, wherein the plurality of qubits comprise at least a first qubit state and a second qubit state, wherein the first qubit state comprises a first atomic state and the second qubit state comprises a second atomic state. The optical trapping sites may comprise any optical trapping sites described herein. The qubits may comprise any qubits described herein. The atoms may comprise any atoms described herein. The first qubit state may comprise any first qubit state described herein. The second qubit state may comprise any second qubit state described herein. The first atomic state may comprise any first atomic state described herein. The second atomic state may comprise any second atomic state described herein.

In a second operation 720, the method 700 may comprise applying electromagnetic energy to one or more qubits of the plurality of qubits, thereby imparting a non-classical operation to the one or more qubits, which non-classical operation includes a superposition between at least the first qubit state and the second qubit state. The electromagnetic energy may comprise any electromagnetic energy described herein.

In a third operation 730, the method 700 may comprise quantum mechanically entangling at least a subset of the plurality of qubits in the superposition with at least another qubit of the plurality of qubits. The qubits may be quantum mechanically entangled in any manner described herein (for instance, as described herein with respect to FIG. 2).

In a fourth operation 740, the method 700 may comprise performing one or more optical measurements of the one or more qubits, thereby obtaining the non-classical computation. The optical measurements may comprise any optical measurements described herein.

In an aspect, the present disclosure provides a method for performing anon-classical computation, comprising: (a) providing a plurality of qubits comprising greater than 60 atoms each trapped within an optical trapping site of a plurality of spatially distinct optical trapping sites, and (b) using at least a subset of the plurality of qubits to perform the non-classical computation.

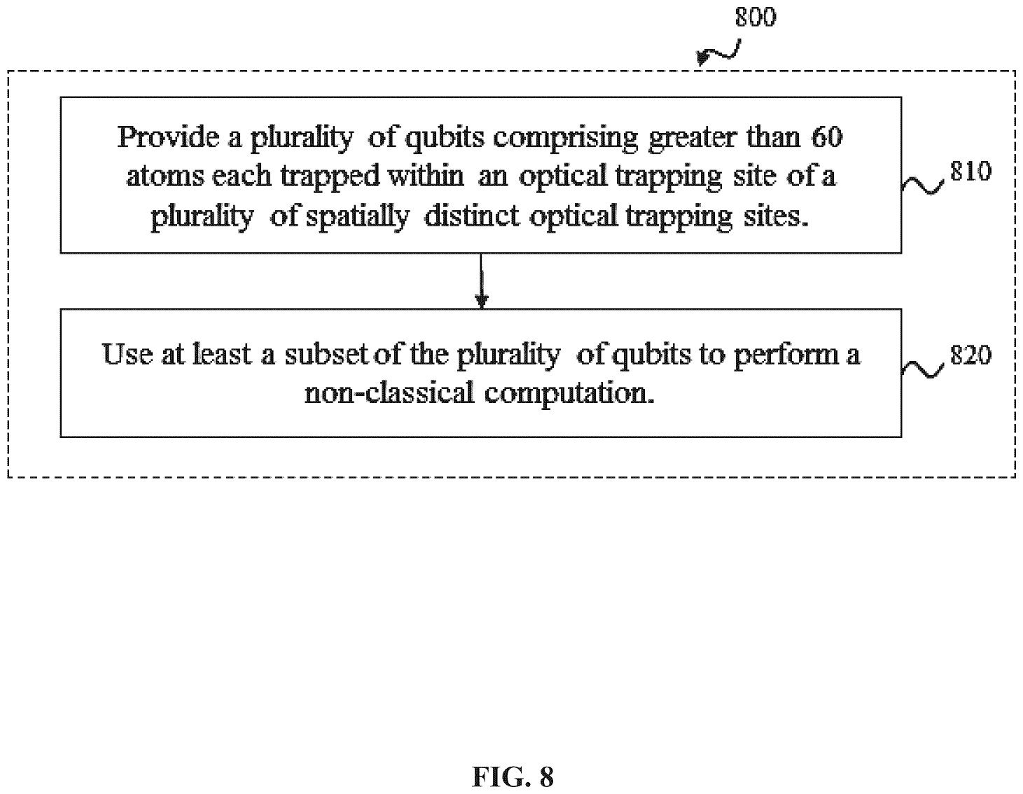

FIG. 8 shows a flowchart for an example of a third method 800 for performing a non-classical computation.

In a first operation 810, the method 800 may comprise providing a plurality of qubits comprising greater than 60 atoms each trapped within an optical trapping site of a plurality of spatially distinct optical trapping sites. The qubits may comprise any qubits described herein. The atoms may comprise any atoms described herein. The optical trapping sites may comprise any optical trapping sites described herein.

In a second operation 820, the method 800 may comprise using at least a subset of the plurality of qubits to perform a non-classical computation.

### Example of Parallel Addressing of Multi-Qubit Units

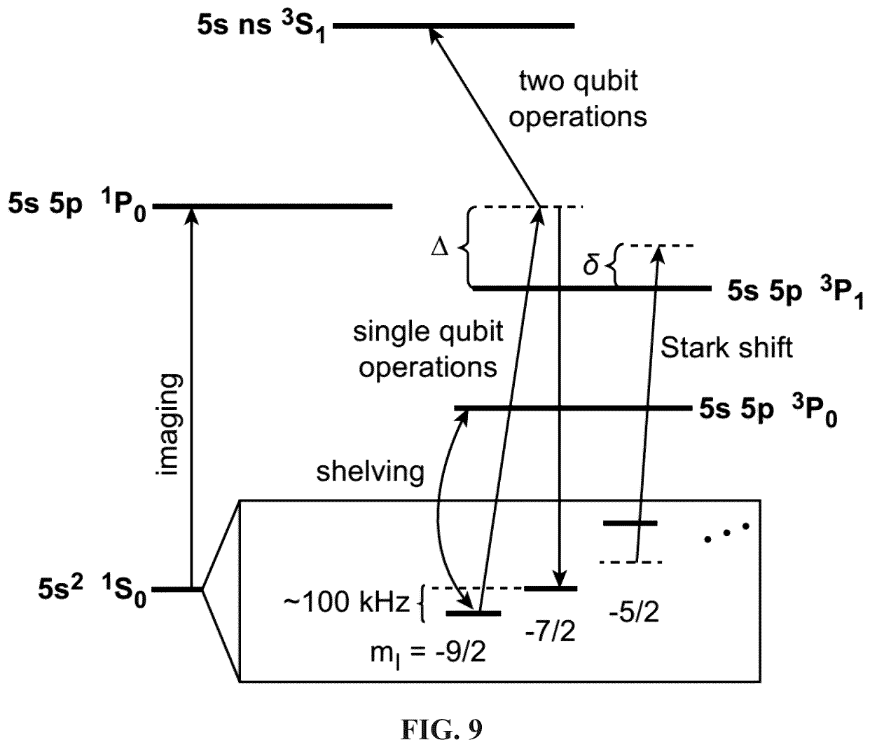

Direct excitation of strontium-87 from the ground state to Rydberg levels would require a laser with a wavelength of approximately 218 nm. Alternatively, the Rydberg excitation operation can be performed using two-photon excitation combining 689 nm and 319 nm light, each detuned from the intermediate ³P₁ state. The approximately 7 kHz width of the ³P₁ state provides an effective balance between the two-photon effective Rabi rate and scattering via spontaneous decay from the ³P₁. FIG. 9 shows an energy level structure for single-qubit and multi-qubit operations in strontium-87.

The optical system for single-qubit operations is also designed to work well for multi-qubit gates. One of the single-qubit beams is used as one leg of the two-photon excitation scheme that drives transitions to the Rydberg electronic manifold. To satisfy the spatially-dependent frequency and phase matching condition, AODs are also used for the UV light. Importantly, the optical systems are matched so that the frequency shift of the UV light from one site to another is identical to that of the 689 nm light. The consequence of this constraint is that the performance of state-of-the-art UV AODs dictate the accessible field of view (FOV) for multi-qubit operations. Further, because one of the single-qubit beams is being used for multi-qubit operations (and the two single-qubit beams are matched), the FOV for single-qubit operations may be the same. A figure of merit for UV AODs is the product of the active aperture and the RF bandwidth of the device. For a fixed beam size in the back focal plane of the objective, increasing either of these quantities results in a larger scan angle of the beams, and thus a larger FOV in the plane of the qubit array. An FOV of approximately 100 μm×100 μm was achieved, which is sufficient to address an array of approximately 1,000 atoms with a trapping site spacing of 3 μm.

### Example of Computer Systems

FIG. 1 shows a computer system 101 that is programmed or otherwise configured to operate any method or system described herein (such as system or method for operating a pair of axicons, described herein). The computer system 101 can regulate various aspects of the present disclosure. The computer system 101 can be an electronic device of a user or a computer system that is remotely located with respect to the electronic device. The electronic device can be a mobile electronic device.

In some cases, the computer system 101 may be configured to determine an optical layout using axicons to meet specific performance metrics or applications (e.g., a MOT). For example, a user may provide as input the specific performance metrics or applications and the computer system 101 may help to provide the spacing, positioning, angles, etc. for laying out a plurality of axicons. In another example, a user may provide, in addition or in alternative to the specific performance metrics or applications, parameters of a plurality of axicons (e.g., axicons in inventory) and the computer system 101 may help to provide the spacing, positioning, angles, etc. for laying out a plurality of axicons. In some cases, the computer system 101 may help to model annular beams generated by a specific axicon arrangement. For example, the computer system 101 may be used to generate simulated images of an annular beam (that, e.g., may be the same as or similar to FIG. 11A or 11B). In another example, the computer system 101 may be used to generate numerical simulations of profiles of an annular beam (that, e.g., may be the same as or similar to FIGS. 16A-15D).

The computer system 101 includes a central processing unit (CPU, also “processor” and “computer processor” herein) 105, which can be a single core or multi core processor, or a plurality of processors for parallel processing. The computer system 101 also includes memory or memory location 110 (e.g., random-access memory, read-only memory, flash memory), electronic storage unit 115 (e.g., hard disk), communication interface 120 (e.g., network adapter) for communicating with one or more other systems, and peripheral devices 125, such as cache, other memory, data storage and/or electronic display adapters. The memory 110, storage unit 115, interface 120 and peripheral devices 125 are in communication with the CPU 105 through a communication bus (solid lines), such as a motherboard. The storage unit 115 can be a data storage unit (or data repository) for storing data. The computer system 101 can be operatively coupled to a computer network (“network”) 130 with the aid of the communication interface 120. The network 130 can be the Internet, an internet and/or extranet, or an intranet and/or extranet that is in communication with the Internet. The network 130 in some cases is a telecommunication and/or data network. The network 130 can include one or more computer servers, which can enable distributed computing, such as cloud computing. The network 130, in some cases with the aid of the computer system 101, can implement a peer-to-peer network, which may enable devices coupled to the computer system 101 to behave as a client or a server.

The CPU 105 can execute a sequence of machine-readable instructions, which can be embodied in a program or software. The instructions may be stored in a memory location, such as the memory 110. The instructions can be directed to the CPU 105, which can subsequently program or otherwise configure the CPU 105 to implement methods of the present disclosure. Examples of operations performed by the CPU 105 can include fetch, decode, execute, and writeback.

The CPU 105 can be part of a circuit, such as an integrated circuit. One or more other components of the system 101 can be included in the circuit. In some cases, the circuit is an application specific integrated circuit (ASIC).

The storage unit 115 can store files, such as drivers, libraries and saved programs. The storage unit 115 can store user data, e.g., user preferences and user programs. The computer system 101 in some cases can include one or more additional data storage units that are external to the computer system 101, such as located on a remote server that is in communication with the computer system 101 through an intranet or the Internet.

The computer system 101 can communicate with one or more remote computer systems through the network 130. For instance, the computer system 101 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 101 via the network 130.

Methods as described herein can be implemented by way of machine (e.g., computer processor) executable code stored on an electronic storage location of the computer system 101, such as, for example, on the memory 110 or electronic storage unit 115. The machine executable or machine-readable code can be provided in the form of software. During use, the code can be executed by the processor 105. In some cases, the code can be retrieved from the storage unit 115 and stored on the memory 110 for ready access by the processor 105. In some situations, the electronic storage unit 115 can be precluded, and machine-executable instructions are stored on memory 110.

The code can be pre-compiled and configured for use with a machine having a processor adapted to execute the code or can be compiled during runtime. The code can be supplied in a programming language that can be selected to enable the code to execute in a pre-compiled or as-compiled fashion.

Aspects of the systems and methods provided herein, such as the computer system 101, can be embodied in programming. Various aspects of the technology may be thought of as “products” or “articles of manufacture” typically in the form of machine (or processor) executable code and/or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the databases, etc. shown in the drawings. Volatile storage media include dynamic memory, such as main memory of such a computer platform. Tangible transmission media include coaxial cables; copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code and/or data. Many of these forms of computer readable media may be involved in carrying one or more sequences of one or more instructions to a processor for execution.

The computer system 101 can include or be in communication with an electronic display 135 that comprises a user interface (UI) 140. Examples of UI's include, without limitation, a graphical user interface (GUI) and web-based user interface.

Methods and systems of the present disclosure can be implemented by way of one or more algorithms. An algorithm can be implemented by way of software upon execution by the central processing unit 105. The algorithm can, for example, implement methods for performing a non-classical computation described herein.

### Certain Definitions and Additional Considerations

Unless otherwise defined, all technical terms used herein have the same meaning as commonly understood by one of ordinary skill in the art to which this invention belongs. As used in this specification and the appended claims, the singular forms “a.” “an.” and “the” include plural references unless the context clearly dictates otherwise. Any reference to “or” herein is intended to encompass “and/or” unless otherwise stated.

Whenever the term “at least,” “greater than.” or “greater than or equal to” precedes the first numerical value in a series of two or more numerical values, the term “at least,” “greater than” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” “less than or equal to,” or “at most” precedes the first numerical value in a series of two or more numerical values, the term “no more than,” “less than,” “less than or equal to,” or “at most” applies to each of the numerical values in that series of numerical values. For example, less than or equal to 3, 2, or 1 is equivalent to less than or equal to 3, less than or equal to 2, or less than or equal to 1.

As used herein, the term “substantially” in reference to a given parameter, property, or characteristic means and includes to a degree that one of ordinary skill in the art would understand that the given parameter, property, or characteristic is met with a degree of variance, such as within acceptable manufacturing tolerances, acceptable alignment tolerances, an acceptably high extinction ratio, etc. By way of example, depending on the particular parameter, property, or characteristic that is substantially met, the parameter, property, or characteristic may be at least 90.0% met, at least 95.0% met, at least 99.0% met, or even at least 99.9% met.

Where values are described as ranges, it will be understood that such disclosure includes the disclosure of all possible sub-ranges within such ranges, as well as specific numerical values that fall within such ranges irrespective of whether a specific numerical value or specific sub-range is expressly stated.

As used herein, like characters refer to like elements.

As used herein, the terms “non-classical computation,” “non-classical procedure,” “non-classical operation,” any “non-classical computer” generally refer to any method or system for performing computational procedures outside of the paradigm of classical computing. A non-classical computation, non-classical procedure, non-classical operation, or non-classical computer may comprise a quantum computation, quantum procedure, quantum operation, or quantum computer.

As used herein, the terms “quantum computation,” “quantum procedure,” “quantum operation,” and “quantum computer” generally refer to any method or system for performing computations using quantum mechanical operations (such as unitary transformations or completely positive trace-preserving (CPTP) maps on quantum channels) on a Hilbert space represented by a quantum device. As such, quantum and classical (or digital) computation may be similar in the following aspect: both computations may comprise sequences of instructions performed on input information to then provide an output. Various paradigms of quantum computation may break the quantum operations down into sequences of basic quantum operations that affect a subset of qubits of the quantum device simultaneously. The quantum operations may be selected based on, for instance, their locality or their ease of physical implementation. A quantum procedure or computation may then consist of a sequence of such instructions that in various applications may represent different quantum evolutions on the quantum device. For example, procedures to compute or simulate quantum chemistry may represent the quantum states and the annihilation and creation operators of electron spin-orbitals by using qubits (such as two-level quantum systems) and a universal quantum gate set (such as the Hadamard, controlled-not (CNOT), and rotations) through the so-called Jordan-Wigner transformation or Bravyi-Kitaev transformation.

Additional examples of quantum procedures or computations may include procedures for optimization such as quantum approximate optimization algorithm (QAOA) or quantum minimum finding. QAOA may comprise performing rotations of single qubits and entangling gates of multiple qubits. In quantum adiabatic computation, the instructions may carry stochastic or non-stochastic paths of evolution of an initial quantum system to a final one.

Quantum-inspired procedures may include simulated annealing, parallel tempering, master equation solver, Monte Carlo procedures and the like. Quantum-classical or hybrid algorithms or procedures may comprise such procedures as variational quantum eigensolver (VQE) and the variational and adiabatically navigated quantum eigensolver (VanQver).

A quantum computer may comprise one or more adiabatic quantum computers, quantum gate arrays, one-way quantum computers, topological quantum computers, quantum Turing machines, quantum annealers, Ising solvers, or gate models of quantum computing.

As used herein, the term “adiabatic” refers to any process performed on a quantum mechanical system in which the parameters of the Hamiltonian are changed slowly in comparison to the natural timescale of evolution of the system.

As used herein, the term “non-adiabatic” refers to any process performed quantum mechanical system in which the parameters of the Hamiltonian are changed quickly in comparison to the natural timescale of evolution of the system or on a similar timescale as the natural timescale of evolution of the system.

While preferred embodiments of the present invention have been shown and described herein, it will be obvious to those skilled in the art that such embodiments are provided by way of example only. Numerous variations, changes, and substitutions will now occur to those skilled in the art without departing from the invention. It should be understood that various alternatives to the embodiments of the invention described herein may be employed in practicing the invention. It is intended that the following claims define the scope of the invention and that methods and structures within the scope of these claims and their equivalents be covered thereby.

1.-65. (canceled)

66. A system, comprising:
a first axicon; and
a second axicon in optical communication with said first axicon,
wherein said first axicon is configured to accept light from a light source and output said light with a beam profile having a substantially dark central region, and
wherein said second axicon is configured to accept said light from said first axicon and output a substantially annular beam.

67. The system of claim 66, wherein said first axicon is a transmissive, diffractive axicon.

68. The system of claim 66, wherein said first axicon is a reflective axicon.

69. The system of claim 68, wherein said reflective axicon is a reflective, diffractive axicon.

70. The system of claim 68, wherein said reflective axicon comprises a non-transmitting portion substantially centered in said reflective axicon.

71. The system of claim 66, wherein said substantially annular beam comprises a substantially dark central region.

72. The system of claim 71, wherein an extinction ratio from said substantially dark central region of said substantially annular beam to a light region of said substantially annular beam is about 1 to 100.

73. The system of claim 66, wherein said beam profile with said substantially dark central region comprises an extinction ratio from said substantially dark central region to a light region of said light beam is about 1 to 100.

74. The system of claim 66, wherein said substantially annular beam comprises a transmission through said first axicon and said second axicon of at least about 80%.

75. The system of claim 66, further comprising:
said light source configured to provide said light, wherein said light beam is substantially collimated and is substantially Gaussian.

76. The system of claim 66, further comprising:
a beam combiner, wherein said substantially annular beam and a second light are combined at said beam combiner.

77. A method, the method comprising:
(a) directing light towards a first axicon, wherein said light exits said first axicon with a beam profile having a substantially dark central region; and
(b) subsequent to (a), directing said light to a second axicon, wherein said light exits said second axicon to form a substantially annular beam.

78. The method of claim 77, wherein said second axicon comprises a refractive axicon.

79. The method of claim 77, wherein said second axicon comprises a diffractive axicon.

80. The method of claim 77, wherein said second axicon comprises a reflective axicon.

81. The method of claim 77, wherein said first axicon is a transmissive, diffractive axicon.

82. The method of claim 77, wherein said first axicon is a reflective axicon.

83. The method of claim 82, wherein said reflective axicon is a reflective, diffractive axicon.

84. The method of claim 82, wherein said reflective axicon comprises a non-transmitting portion substantially centered in said reflective axicon.

85. The method of claim 77, wherein said substantially annular beam comprises a substantially dark central region.

86. The method of claim 77, wherein said light with a beam profile having a substantially dark central region comprises an extinction ratio from said substantially dark central region to a light region of said light is about 1 to 100.

87. The method of claim 77, further comprising: combining said substantially annular beam and a second light with a beam combiner.

88. The method of claim 87, further comprising: directing said substantially annular beam and said second light toward a plurality of spatially distinct optical traps; and cooling a plurality of atoms within said plurality of spatially distinct optical trap with said substantially annular beam and said second light.
